(19) United States
(12) Patent Application Publication
(10) Pub. No.: US 2010/0328254 A1
(43) Pub. Date: Dec. 30, 2010

(54) CAPACITANCE TYPE INPUT DEVICE

(75) Inventors: Yasuhiro NIGA, Kyoto-shi (JP); Yasushi Kasajima, Kyoto-shi (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 12/786,015

(22) Filed: May 24, 2010

(30) Foreign Application Priority Data
Jun. 5, 2009 (JP) 2009-135717
Oct. 5, 2009 (JP) 2009-231357
May 6, 2010 (JP) 2010-106676

(51) Int. Cl. G06F 3/045

(52) U.S. Cl. 345/174

(57) ABSTRACT

A capacitance type input device is configured to detect the access position of a conductor such as a finger, and includes a plurality of electrodes and an IC chip. The plurality of electrodes are spaced apart from each other in direction Y, and each of the electrodes has an elongated form extending in direction X. The IC chip detects the access position of the finger in direction Y, based on a change in capacitance generated between the finger and the respective electrodes. The plurality of electrodes include a high-sensitivity electrode, and a low-sensitivity electrode which has a greater surface area than that of the high-sensitivity electrode. When compared by the same size, the low-sensitivity electrode has a lower sensitivity than the high-sensitivity electrode.

### BACKGROUND OF THE INVENTION

1. Field of the Invention

The present invention relates to a capacitance type input device.

2. Description of the Related Art

Various conventional capacitance type input devices have been proposed (see, for instance JP-A-No. 2008-33777 and JP-A-No. 2008-269297). FIG. 45 is a schematic cross-sectional drawing illustrating an example of a conventional input device. FIG. 46 is a schematic plan-view diagram of the input device viewed from above in FIG. 45. An input device 9A illustrated in the figures is stacked on a liquid crystal display panel 9B to constitute thereby a so-called touch panel. This touch panel is used, for instance, as a display and an operation means of a cell phone 9C. The cell phone 9C has a transparent cover c1 that constitutes part of a housing. The input device 9A is joined to the transparent cover c1 by way of a transparent adhesive c2. A liquid crystal display panel 9B is disposed under the input device 9A as viewed in FIG. 45.

The input device 9A comprises transparent substrates 91, 92, a plurality of transparent strip-like electrodes 93, 94, wirings 95, 96, flexible boards 97, 98, and an IC chip 99. The transparent substrates 91, 92 are disposed parallel to each other. The transparent strip-like electrodes 93 are formed on the transparent substrate 91. The transparent strip-like electrodes 93 extend in direction X, and have lozenge-like expanded shapes that are disposed alternating with narrow portions, along direction X. The wirings 95 are formed on the transparent substrate 91. The transparent strip-like electrodes 94 are formed on the transparent substrate 92. The transparent strip-like electrodes 94 extend in direction Y, and have lozenge-like expanded shapes that are disposed alternating with narrow portions, along direction Y. The wirings 96 are formed on the transparent substrate 92. The IC chip 99 is connected to the transparent strip-like electrodes 93 by way of the flexible board 97 and the wirings 95. The IC chip 99 is connected to the transparent strip-like electrodes 94 by way of the flexible board 98 and the wirings 96.

The input device 9A detects the access position of a finger Fg in the XY plane as described below.

When the user of the cell phone 9C operates the latter, a finger Fg, which is of a size relatively larger than that of the lozenge shapes of the transparent strip-like electrodes 93, 94, approaches or touches the transparent cover c1. Capacitance is generated thereupon between the finger Fg and the plurality of transparent strip-like electrodes 93, and between the finger Fg and the plurality of transparent strip-like electrodes 94. By way of the wirings 95 and the wirings 96, the IC chip 99 measures, for instance, a voltage value (hereafter, detection value) that changes in accordance with the capacitance that is generated between the finger Fg and the transparent strip-like electrodes 93, 94. Next, the IC chip 99 calculates the weighted average of the detection values corresponding to the respective transparent strip-like electrodes 93. The IC chip 99 detects the access position of the finger Fg in direction Y on the basis of this calculation. Next, the IC chip 99 detects the access position in direction X in the same way as it detects the access position of the finger Fg in direction Y. The input device 9A detects thus the access position of a finger Fg in the XY plane in accordance with the above procedure.

The sensitivity of the transparent strip-like electrodes 93 or the sensitivity of the transparent strip-like electrodes 94 denotes herein the magnitude of the detection value that is measured when a same conductor is brought near, in the same attitude, to the transparent strip-like electrodes 93 or the transparent strip-like electrodes 94. In the input device 9A, preferably, the sensitivity of each transparent strip-like electrodes 93 is uniform, with no variability, in order to detect more accurately the access position of the finger Fg for instance in direction Y.

In some cases, the sensitivity of the transparent strip-like electrodes 93 exhibits variability. The main causes of sensitivity variability among transparent strip-like electrodes 93 include differences in the parasitic capacitance that can be generated between the transparent strip-like electrodes 93, and between, the wirings 95 to which the transparent strip-like electrodes 93 are connected and other wirings, electrodes and the like. Also, sensitivity variability among transparent strip-like electrodes 93 may arise from differences in the resistance value of the transparent strip-like electrodes 93 themselves, and in the resistance value of the wirings 95 that are connected to the transparent strip-like electrodes 93. When the sensitivity of the plurality of transparent strip-like electrodes 93 is non-uniform, the detection value, measured by the IC chip 99 when a finger Fg approaches a given transparent strip-like electrode 93, will be different among the transparent strip-like electrodes 93 even if the finger Fg approaches in the same attitude. Thus, the weighting of detection values may be inadequate for calculating the weighted average of the detection values for the respective transparent strip-like electrodes 93. This may preclude detecting accurately the access position of the finger Fg in direction Y.

FIG. 47 is a plan-view diagram for explaining another conventional input device. An input device 900A illustrated in FIG. 47 comprises strip-like electrodes 920, wirings 980 and an IC chip 970. The input device 900A is used in so-called capacitance type touch panels.

The strip-like electrodes 920 extend in direction v and are arranged side by side in direction u. The strip-like electrodes 920 comprise detection electrodes 921, 922. The detection electrodes 921, 922 are shaped as right triangles elongated in direction v. The detection electrodes 921 and the detection electrodes 922 are disposed alternately in direction u. The wirings 980 are individually connected to respective detection electrodes 921, 922. The IC chip 970 is connected to the wirings 980.

A conductor in the form of a finger Fg approaches the strip-like electrodes 920. The IC chip 970 detects thereupon the access position of the finger Fg in direction u and direction v.

FIG. 48 is a histogram illustrating the capacitance values of each strip-like electrode 920. The capacitance values of the strip-like electrodes 920 disposed first, second, third . . . from the left in FIG. 47 correspond respectively to the first, second, third . . . capacitance values from the left in FIG. 48. FIG. 49 is a graph illustrating a summation ΣC1 of the capacitance values of all the detection electrodes 921, and a summation ΣC2 of the capacitance values of all the detection electrodes 922. The access position of the finger Fg in direction u is detected on the basis of the histogram illustrated in FIG. 48. The access position of the finger Fg in direction v is detected by determining the ratio ΣC1:ΣC2 between the summations of the capacitance values illustrated in FIG. 49. The access position of the finger Fg in directions u, v can be detected thus by the IC chip 970 in accordance with the above procedure.

The input device 900A, however, has the following problems. During use of the input device 900A, other fingers in addition to the finger Fg may accidentally touch the touch panel. In such cases, not only capacitance from the finger Fg, but also capacitance from another finger that has accidentally touched the touch panel, are generated at the detection electrodes 921 or the detection electrodes 922. In the input device 900A, as described above, ΣC1 denotes the summation of capacitance values in all the detection electrodes 921, and ΣC2 denotes the summation of the capacitance values in all the detection electrodes 922. As a result, to the values of ΣC1 and ΣC2 there is added the capacitance value between the detection electrodes 921 and the detection electrodes 922 for a finger that has accidentally touched the touch panel. This is undesirable in that the access position of the finger Fg in direction v may fail to be accurately worked out as a result.

### SUMMARY OF THE INVENTION

In the light of the above, it is a first object of the present invention to provide a capacitance type input device that allows detecting more accurately the access position of a conductor. A second object of the present invention is to provide a capacitance type input device that allows detecting accurately the access position of one or more conductors when a plurality of conductors approach the device.

According to a first aspect of the present invention, there is provided a capacitance type input device that comprises: a plurality of first-direction detection electrodes arranged side by side in a first direction, each extending in a second direction different from the first direction; and a controller for detecting an access position of a conductor in the first direction, the detecting being based on a change in capacitance generated between the conductor and the respective first-direction detection electrodes. The plurality of first-direction detection electrodes include at least one low-sensitivity electrode and at least one high-sensitivity electrode, the low-sensitivity electrode having a surface area greater than a surface area of the high-sensitivity electrode. When compared by a same size, the low-sensitivity electrode has a lower sensitivity than the high-sensitivity electrode.

Preferably, the input device of the present invention may further comprise: a substrate on which the plurality of first-direction detection electrodes are formed; and a plurality of wirings formed on the substrate and extending from an end of the substrate to be connected to the plurality of first-direction detection electrodes, respectively. The plurality of wirings formed on the substrate include a first wiring connected to the low-sensitivity electrode and a second wiring connected to the high-sensitivity electrode, the first wiring being greater in length than the second wiring.

Preferably, the input device of the present invention may further comprise a plurality of second-direction detection electrodes arranged side by side in the second direction and each extending in the first direction. Each of the first-direction detection electrodes includes a plurality of first electrode elements arranged along the second direction, and each of the second-direction detection electrodes includes a plurality of second electrode elements arranged along the first direction.

Preferably, one of the first electrode elements included in the low-sensitivity electrode has a greater surface area than a surface area of any one of the first electrode elements included in the high-sensitivity electrode.

Preferably, the input device of the present invention may further comprise: a plurality of second-direction detection electrodes arranged side by side in the second direction and each extending in the first direction; and a substrate including a flat first face on which both the plurality of first-direction detection electrodes and the plurality of second-direction detection electrodes are formed.

Preferably, each of the first-direction detection electrodes includes a plurality of first electrode elements arranged along the second direction, and each of the second-direction detection electrodes includes a plurality of second electrode elements arranged along the first direction.

Preferably, the input device of the present invention may further comprise a plurality of link wirings each of which is electrically connected to one of the plurality of first electrode elements and formed in a gap flanked by adjacent first and second electrode elements.

Preferably, each of the link wirings extends to a non-detection region of the substrate outside a detection region for detecting access of the conductor.

Preferably, the plurality of link wirings include a first link wiring and a second link wiring that extend from two first electrode elements, respectively, that are spaced from each other in the first direction, the first link wiring extending toward one side of the first direction, the second link wiring extending toward an opposite side of the first direction.

Preferably, wherein each of the first and the second link wirings connected to one of the two first electrode elements spaced in the first direction extends from said one of the two first electrode elements in a direction going away from the other of the two first electrode elements.

Preferably, the input device of the present invention may further comprise a first connection wiring that connects to two first electrode elements adjacent in the second direction among the plurality of first electrode elements, the first connection wiring being formed in a gap flanked by the two first electrode elements. One of the plurality of link wirings is connected to the two first electrode elements or the first connection wiring.

Preferably, the input device of the present invention may further comprise a second connection wiring that connects to two first electrode elements that flank the first connection wiring among the plurality of first electrode elements. The second connection wiring is disposed so as to surround a first electrode element at one end of first electrode elements to which the first connection wiring is connected.

Preferably, the two first electrode elements spaced apart from each other along the first direction are mutually adjacent, and one of the two first electrode elements is included in one first-direction detection electrode disposed at one end in the first direction among the plurality of first-direction detection electrodes.

Preferably, part of the link wirings constitutes a multilayer substrate, and the link wirings are connected to one another at the multilayer substrate.

Preferably, the input device of the present invention may further comprise: a light-transmitting layer formed in a gap flanked by adjacent first and second electrode elements; and a coating layer that covers the plurality of first electrode elements, the plurality of second electrode elements and the light-transmitting layer.

Preferably, a refractive index of a material that makes up the light-transmitting layer is different from a refractive index of a material that makes up the coating layer.

Preferably, a material that makes up the light-transmitting layer is identical to a material that makes up the first electrode elements or the second electrode elements.

Preferably, the light-transmitting layer comprises a plurality of line elements spaced apart from each other.

Preferably, the light-transmitting layer is made of an insulating resin.

Preferably, each of the first-direction detection electrodes comprises: a first slider electrode that extends toward one side of the second direction in such a manner that the size thereof in the first direction decreases toward the one side of the second direction; and a second slider electrode that extends toward the other side of the second direction in such a manner that the size thereof in the first direction decreases toward the other side of the second direction. The controller detects an access position of the conductor in the second direction, based on a relationship between capacitance between the conductor and the first slider electrodes and capacitance between the conductor and the second slider electrodes.

According to a second aspect of the present invention, there is provided a capacitance type input device that comprises: a plurality of strip-like electrodes arranged side by side in a first direction and each extending in a second direction different from the first direction; and a controller. Each of the strip-like electrodes comprises a first detection electrode and a second detection electrode, where the first detection electrode extends in the second direction in a manner such that the size thereof in the first direction decreases as proceeding in the second direction, while the second detection electrode extends in an opposite direction to the second direction in a manner such that the size thereof in the first direction decreases as proceeding in the opposite direction to the second direction. The controller is configured to: specify a first electrode group to which only some of the plurality of strip-like electrodes belong, and to which strip-like electrodes which a first conductor approaches belong; and detect an access position of the first conductor in the second direction, based on a relationship between capacitance between the first conductor and the first detection electrodes belonging to the first electrode group and capacitance between the first conductor and the second detection electrodes belonging to the first electrode group.

Preferably, only one strip-like electrode of the plurality of strip-like electrodes belongs to the first electrode group.

Preferably, at least two mutually adjacent strip-like electrodes belong to the first electrode group.

Preferably, the controller calculates a weighted average using, as weighting, a change in capacitance between the first conductor and each of at least two mutually adjacent strip-like electrodes, and detects an access position of the first conductor in the first direction.

Preferably, the controller is configured to: specify a second electrode group to which only some of the plurality of strip-like electrodes belongs, and to which strip-like electrodes which a second conductor different from the first conductor approaches belong; and detect an access position of the second conductor in the second direction, based on a relationship between capacitance between the second conductor and the first detection electrodes belonging to the second electrode group and capacitance between the second conductor and the second detection electrodes belonging to the second electrode group.

Preferably, only one strip-like electrode of the plurality of strip-like electrodes belongs to the second electrode group.

Preferably, at least two mutually adjacent strip-like electrodes belong to the second electrode group.

Preferably, the controller calculates a weighted average using, as weighting, a change in capacitance between the second conductor and each of at least two mutually adjacent strip-like electrodes, and detects an access position of the second conductor in the first direction.

Preferably, the plurality of first detection electrodes and the plurality of second detection electrodes are wedge-shaped, each of the first detection electrodes is flanked by two of the plurality of second detection electrodes, and each of the second detection electrodes is flanked by two of the plurality of first detection electrodes.

Preferably, each of the first detection electrodes comprises a plurality of first wedge-shaped electrodes; each of the second detection electrodes comprises a plurality of second wedge-shaped electrodes; and each of the first wedge-shaped electrodes is flanked by two of the plurality of second wedge-shaped electrodes, and each of the second wedge-shaped electrodes is flanked by two of the plurality of first wedge-shaped electrodes.

Preferably, one of the plurality of strip-like electrodes further comprises: a first connection electrode disposed on a side opposite to the second direction with respect to the first wedge-shaped electrodes and connected to each of the first wedge-shaped electrodes; and a second connection electrode disposed on a side of the second direction with respect to the second wedge-shaped electrodes and connected to each of the second wedge-shaped electrodes.

Preferably, the input device according to the second aspect of the present invention may further comprise: a substrate on which the plurality of strip-like electrodes are formed; a first lead-around wiring formed on the substrate and electrically connected to one of the plurality of first detection electrodes; and a second lead-around wiring formed on the substrate and electrically connected to one of the plurality of second detection electrodes. The first and second lead-around wirings are formed on a same side in the second direction with respect to the plurality of strip-like electrodes.

Preferably, the plurality of strip-like electrodes, the first lead-around wiring and the second lead-around wiring are made of a same material.

Other features and advantages of the present invention will become apparent from the detailed description set forth below with reference to accompanying drawings.

### BRIEF DESCRIPTION OF THE DRAWINGS

FIG. 1 is a schematic cross-sectional view of an input device according to a first embodiment of the present invention;

FIG. 2 is a schematic plan-view diagram along line II-II of FIG. 1;

FIG. 3 is a schematic plan-view diagram illustrating the configuration of part of the input device illustrated in FIG. 2;

FIG. 4 is a schematic plan-view diagram illustrating the configuration of part of the input device illustrated in FIG. 2;

FIG. 5 is a graph plotting the area ratio for each electrode y in FIG. 2;

FIG. 6A is a graph illustrating sensitivity for each electrode y;

FIG. 6B is a graph illustrating sensitivity for each electrode x;

FIG. 7 is a table used for determining an area ratio P1 of electrodes in the input device according to the first embodiment;

FIG. 8 is a schematic cross-sectional view of an input device in which the present invention can be used;

FIG. 9 is a schematic plan-view diagram of the input device of FIG. 8 along line IX-IX;

FIG. 10 is a schematic cross-sectional view of FIG. 9 along line X-X;

FIG. 11 is a schematic plan-view diagram of an input device in which the present invention can be used;

FIG. 12 is a schematic plan-view diagram of an input device according to a second embodiment of the present invention;

FIG. 13 is a schematic plan-view diagram illustrating the configuration of part of the input device illustrated in FIG. 12;

FIG. 14 is a schematic plan-view diagram illustrating the configuration of part of the input device illustrated in FIG. 12;

FIG. 15 is a graph plotting the area ratio for each electrode y in FIG. 12;

FIG. 16A is a graph illustrating sensitivity for each electrode y;

FIG. 16B is a graph illustrating sensitivity for each electrode x;

FIG. 17 is a table used for determining an area ratio P2 of electrodes in the input device according to the second embodiment;

FIG. 18 is a schematic plan-view diagram of an input device in which the present invention can be used;

FIG. 19 is a schematic plan-view diagram of an input device in which the present invention can be used;

FIG. 20 is a schematic plan-view diagram of an input device in which the present invention can be used;

FIG. 21A is a partial enlarged diagram of region Ra in FIG. 20;

FIG. 21B is a partial enlarged diagram of region Rb in FIG. 20;

FIG. 22 is a schematic plan-view diagram of an input device in which the present invention can be used;

FIG. 23 is a schematic plan-view diagram of an input device in which the present invention can be used;

FIG. 24 is a schematic plan-view diagram of an input device in which the present invention can be used;

FIG. 25 is a schematic plan-view diagram of an input device in which the present invention can be used;

FIG. 26 is a schematic plan-view diagram of an input device according to a third embodiment of the present invention;

FIG. 27 is a graph plotting the area ratio for each electrode y in FIG. 26;

FIG. 28A illustrates detection values of electrodes y;

FIG. 28B illustrates detection values T1, T2;

FIG. 29 is a schematic plan-view diagram of an input device according to a fourth embodiment of the present invention;

FIG. 30 is a schematic plan-view diagram illustrating mainly the configuration of part of FIG. 29;

FIG. 31 is a schematic plan-view diagram illustrating mainly the configuration of part of FIG. 29;

FIG. 32 is a partial enlarged diagram of region XXXII in FIG. 29;

FIG. 33 is a schematic cross-sectional view of FIG. 32 along line XXXIII;

FIG. 34 is a schematic cross-sectional view illustrating a modification of a light-transmitting layer;

FIG. 35 is a schematic cross-sectional view illustrating an example of an input device according to a fifth embodiment of the present invention;

FIG. 36 is a schematic plan-view diagram along line IIIVI-IIIVI of FIG. 35;

FIG. 37 is a histogram illustrating the capacitance values of strip-like electrodes in the input device according to the fifth embodiment;

FIG. 38 is a graph illustrating capacitance values relating to detection electrodes in the input device according to the fifth embodiment;

FIG. 39 is a graph illustrating capacitance values relating to detection electrodes in the input device according to the fifth embodiment;

FIG. 40 is a schematic plan-view diagram illustrating an example of an input device according to a sixth embodiment of the present invention;

FIG. 41 is an enlarged diagram of region XLI in FIG. 40;

FIG. 42 is a histogram illustrating the capacitance values of strip-like electrodes in the input device according to the sixth embodiment;

FIG. 43 is a graph illustrating capacitance values relating to detection electrodes in the input device according to the sixth embodiment;

FIG. 44 is a graph illustrating capacitance values relating to detection electrodes in the input device according to the sixth embodiment;

FIG. 45 is a schematic cross-sectional view illustrating an example of a conventional input device;

FIG. 46 is a schematic plan-view diagram of the input device illustrated in FIG. 45;

FIG. 47 is a plan-view diagram illustrating another example of a conventional input device;

FIG. 48 is a histogram illustrating capacitance values of strip-like electrodes in a conventional input device; and

FIG. 49 is a graph illustrating capacitance values relating to detection electrodes in a conventional input device.

### DETAILED DESCRIPTION OF THE PREFERRED EMBODIMENTS

Preferred embodiments of the present invention are explained in detail below with reference to accompanying drawings.

### First Embodiment

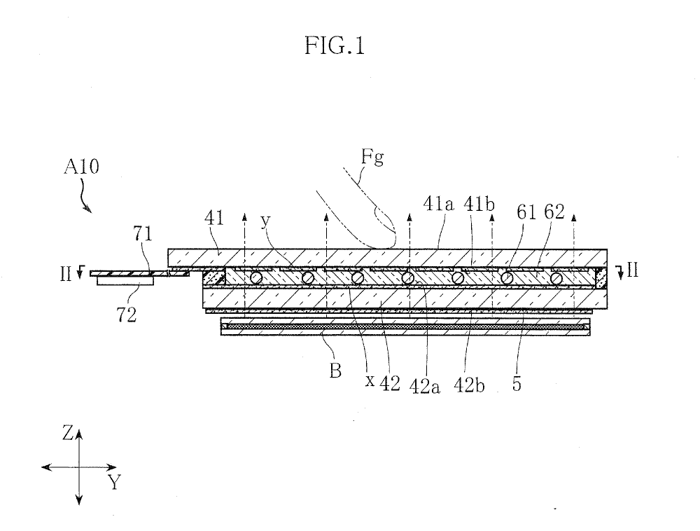

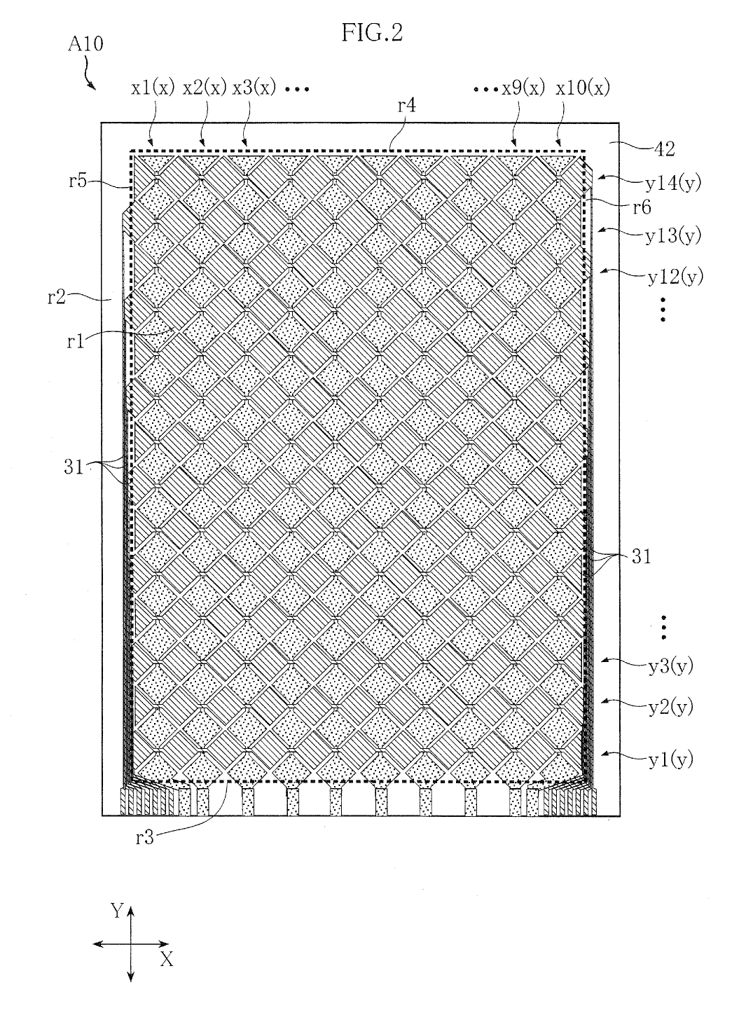

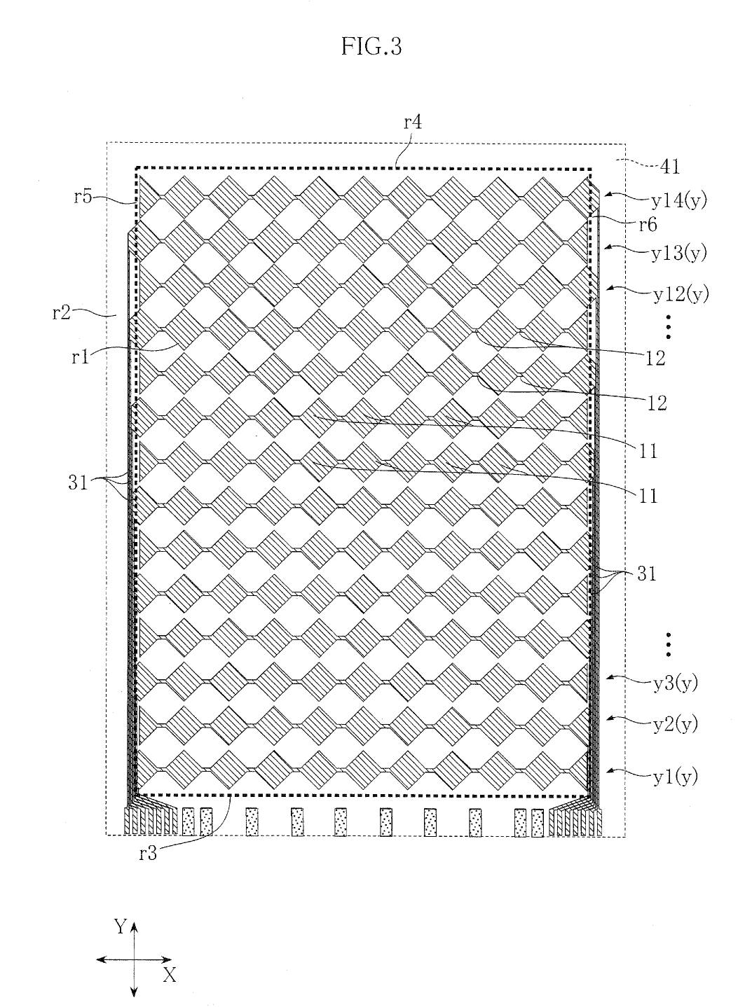

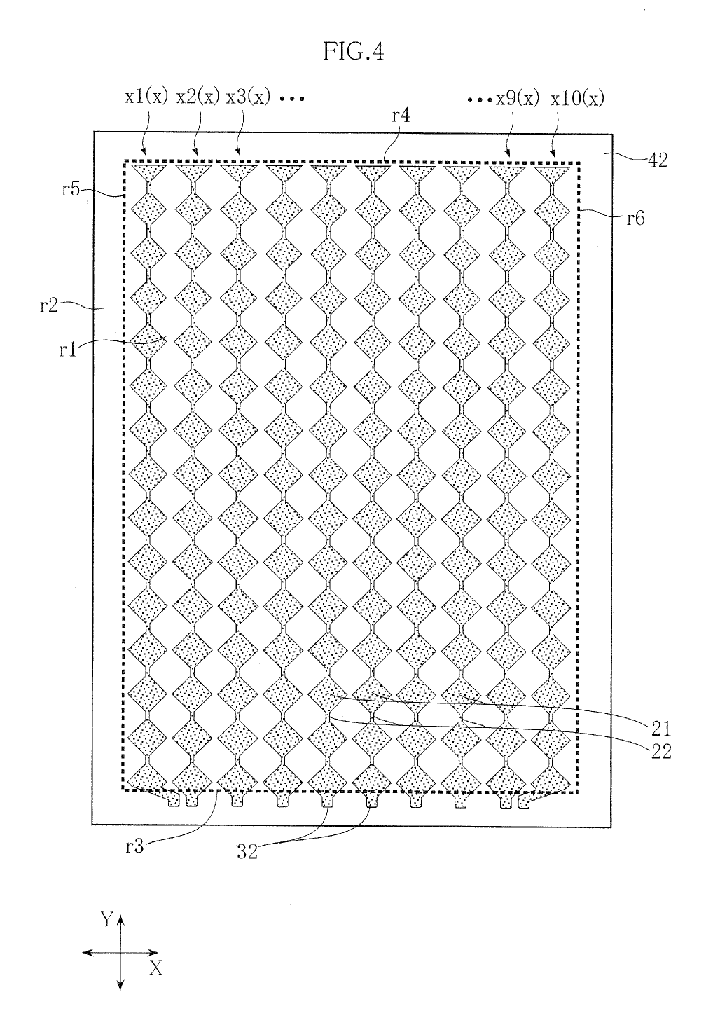

A first embodiment of the present invention will be explained with reference to FIG. 1 to FIG. 7. FIG. 1 is a schematic cross-sectional view of an input device according to the first embodiment. FIG. 2 is a schematic plan-view diagram along line II-II of FIG. 1. An input device A10 illustrated in the figures comprises a plurality of electrodes x, a plurality of electrodes y, a plurality of wirings 31, a plurality of wirings 32 (omitted in FIG. 1 and FIG. 2), transmitting plates 41, 42, a shield layer 5, spacers 61, a transparent insulating material 62, a flexible board 71 and an IC chip 72. In FIG. 2, the transmitting plate 41, the spacers 61, the transparent insulating material 62, the flexible board 71 and the IC chip 72 are omitted. FIG. 3 is a schematic plan-view diagram illustrating mainly the configuration of the electrodes y in FIG. 2. FIG. 4 is a schematic plan-view diagram illustrating mainly the configuration of the electrodes x in FIG. 2.

The input device A10 detects the proximity of a finger Fg, which is a conductor, through changes in capacitance. The input device A10 is stacked on a liquid crystal display panel B to constitute thereby a so-called capacitance type touch panel.

The region demarcated by a dotted line in FIG. 2 to FIG. 4 is a detection region r1. The detection region r1 is a region where there is detected the proximity of a finger Fg that comes near the input device A10. The frame-like region outside the detection region r1 in the transmitting plate 4 is a non-detection region r2. Ends r3, r4 and edges r5, r6 constitute the boundary between the detection region r1 and the non-detection region r2. Ends r3, r4 extend in direction X and are positioned at the top and bottom of FIG. 2. Edges r5, r6 extend in direction Y, and are positioned at the left and right in FIG. 2.

The transmitting plates 41, 42 are transparent plates. The transmitting plates 41, 42 comprise a single-layer resin body of a transparent resin such as polyethylene terephthalate (PET), polyethylene naphthalate (PEN), polycarbonate (PC) or the like, or a resin laminate comprising two materials selected from among transparent resins typified by the foregoing resins. Alternatively, the transmitting plates 41, 42 may comprise glass.

The transmitting plate 41 has a front face 41a and a rear face 41b. The front face 41a is a contact surface of the finger Fg. A coating layer, not shown, may for instance be formed on the front face 41a. The coating layer prevents reflection of external light to suppress loss of visibility, and has also the function of protecting the transmitting plate 41 against damage. The transmitting plate 42 has a front face 42a and a rear face 42b. The front face 42a opposes the rear face 41b of the transmitting plate 41.

The plurality of electrodes y is formed on the rear face 41b of the transmitting plate 41. The electrodes y are arranged as electrodes y1, y2 . . . from the bottom up in FIG. 2 and FIG. 3. The electrodes y extend in direction X, and are arrayed side by side in direction Y. The plurality of electrodes y is disposed in direction Y at a pitch of, for instance, 5 mm. Any number of electrodes y may be formed. In the present embodiment there are formed 14 electrodes y. The purpose of the electrodes y is to detect the access position of the finger Fg in direction Y. The electrodes y correspond to an example of the first-direction detection electrodes of the present invention. The electrodes y are obtained by patterning a thin film comprising a transparent conductive material such as ITO, IZO or the like.

As illustrated in FIG. 2 and FIG. 3, each electrode y comprises a plurality of electrode elements 11 arrayed along direction X, and wiring sections 12 that electrically connect the electrode elements 11. The bulging portions of the electrodes y are the electrode elements 11, while the narrowing portions of the electrodes y are the wiring sections 12. The electrode elements 11 are shaped substantially as lozenges. The shape of the electrode elements 11 is not particularly limited to a lozenge, and may be a rounded shape, a polygonal shape or some other shape.

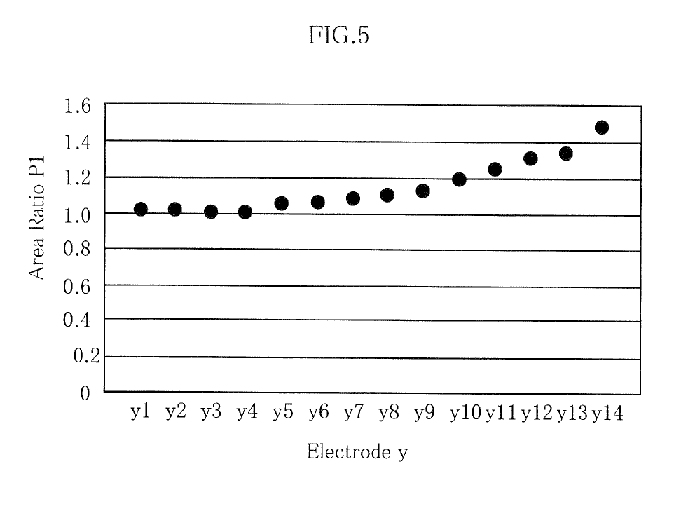

FIG. 5 illustrates an area ratio P1 of respective electrodes y. The figure shows the area ratio for each electrode y, taking as 1 the area of electrode y4. As illustrated in FIG. 5, the surface area of the electrodes y tends to increase as the electrodes are disposed further upwards in FIG. 2 and FIG. 3. The larger the surface area of the electrodes y is, the larger the electrode elements 11 become in each electrode y. Thus, the electrode elements 11 become larger toward the top of FIG. 3. A method for determining the surface area of the electrodes y is explained further on.

The plurality of wirings 31 is formed on the rear face 41b of the transmitting plate 41. The wirings 31 are individually connected to respective electrodes y. The wirings 31 extend from the electrodes y up to an end of the transmitting plate 41. The wirings 31 comprise a transparent insulating material, for instance ITO, IZO or the like. The width of the wirings 31 ranges for instance from 30 to 100 μm.

The plurality of electrodes x is formed on the front face 42a of the transmitting plate 42. The electrodes x are arranged as electrodes x1, x2 . . . from the left in FIG. 2 and FIG. 4. The electrodes x extend in direction Y, and are arrayed side by side in direction X. The plurality of electrodes x is disposed in direction X at a pitch of, for instance, 5 mm. Any number of electrodes x may be formed, but in the present embodiment there are formed 10 electrodes x. The purpose of the electrodes x is to detect the access position of the finger Fg in direction X. The electrodes x correspond to an example of the second-direction detection electrodes of the present invention. The electrodes x are obtained by patterning a thin film comprising a transparent conductive material such as ITO, IZO or the like.

Each electrode x comprises a plurality of electrode elements 21 arrayed along direction Y, and wiring sections 22 that electrically connect the electrode elements 21. The bulging portions of the electrodes x are the electrode elements 21, while the narrowing portions of the electrodes x are the wiring sections 22. The electrode elements 21 are shaped substantially as lozenges. The shape of the electrode elements 21 is not particularly limited to a lozenge, and may be a rounded shape, a polygonal shape or some other shape.

As illustrated in FIG. 2 to FIG. 4, the size of the electrode elements 11 increases toward the top of the figures, while the size of the electrode elements 21 decreases toward the top of the figures. The method for determining the size of the electrode elements 21 is explained further on. As illustrated in FIG. 2, the electrodes y and electrodes x are disposed in such a manner that the electrode elements 21 and electrode elements 11 do not overlap each other.

The plurality of wirings 32 is formed on the front face 42a of the transmitting plate 42. The wirings 32 are individually connected to respective electrodes x. The wirings 32 comprise a transparent insulating material, for instance ITO, IZO or the like.

As illustrated in FIG. 1, a plurality of spacers 61 is disposed in the space sandwiched by the transmitting plate 41 and the transmitting plate 42. The spacers 61 are in contact with both transmitting plates 41, 42. The spacers 61 comprise silica or an acrylic resin (for instance, Micropearl series, by Sekisui Chemical). A transparent insulating material 62 fills the above space sandwiched between the transmitting plate 41 and the transmitting plate 42. As the transparent insulating material 62 there may be used a material having good light transmissivity and that can insulate the electrodes y and the electrodes x from each other.

The shield layer 5 is formed on the rear face 42b of the transmitting plate 42. The shield layer. 5 comprises a transparent conductive material, for instance ITO, IZO or the like. The shield layer 5 is covered by a rear protective layer (not shown). The shield layer 5 has the function of blocking external noise. The shield layer 5 need not necessarily be formed.

The flexible board 71 is provided at an end of the transmitting plate 41. The IC chip 72 is mounted on the flexible board 71. The IC chip 72 is connected to the electrodes y by way of the flexible board 71 and the wirings 31. The IC chip 72 is connected to the electrodes x by way of, for instance, the flexible board 71 and the wirings 32. The IC chip 72 can calculate the detection value for each electrode y, independently and at all times. Likewise, the IC chip 72 can calculate the detection value for each electrode x, independently and at all times. In COG (Chip On Glass), the IC chip 72 is mounted on the transmitting plate 41.

The liquid crystal panel B comprises, for instance, a transparent substrate and a TFT substrate opposing each other, with a liquid crystal layer sandwiched in between. The liquid crystal panel B has the function of displaying, for instance, operation menu screens or images for operating a cell phone. The images displayed on the liquid crystal panel B can be viewed through the input device A10. The display surface of the liquid crystal panel B is disposed so as to overlap the electrodes x, y as viewed from direction Z.

The input device A10 and the liquid crystal panel B are assembled in a cell phone or the like and are used for instance as described below.

On, the liquid crystal panel B there is displayed an operation menu screen that comprises icons as imitation buttons for launching the various functions of, for instance, a cell phone. When no operation is being performed by the user, there exists virtually no capacitance between the electrodes x, y and the finger Fg. The user brings then the finger Fg close to the front face 41a of the transmitting plate 41, with the intent of touching the icon that corresponds to the function that the user wishes to select, whereupon the distance between electrodes x, y and the finger Fg becomes shorter. This generates capacitance between the finger Fg and the electrodes x, y. The capacitance is greater for the electrode whose distance to the finger Fg is shorter, from among the plurality of electrodes x, y. The IC chip 72 measures these changes in capacitance as the detection values of the electrodes x, y. Next, the IC chip 72 calculates the weighted average of the detection values corresponding to the respective plurality of electrodes y. The IC chip 72 detects the access position of the finger Fg in direction Y on the basis of this calculation. Likewise, the IC chip 72 calculates the weighted average of the detection values corresponding to the respective plurality of electrodes x. The IC chip 72 detects the access position of the finger Fg in direction X on the basis of this calculation. The above procedure allows detecting the access position of the finger Fg in the XY plane, and detecting the icon that the user wants to touch. The cell phone launches then the function that corresponds to that icon.

An example of the method for determining the size of the electrodes y and the electrodes x is explained below. The size of the electrodes y, and that of the electrodes x as well, is determined in the following manner. Supposing that the electrodes y are equal in surface area, there may be an electrode y (low-sensitivity electrode) which has a relatively low sensitivity and another electrode y (high-sensitivity electrode) which has a relatively high sensitivity. In this situation, the electrode size is determined so that the surface area of the low-sensitivity electrode is greater than the surface area of the high-sensitivity electrode.

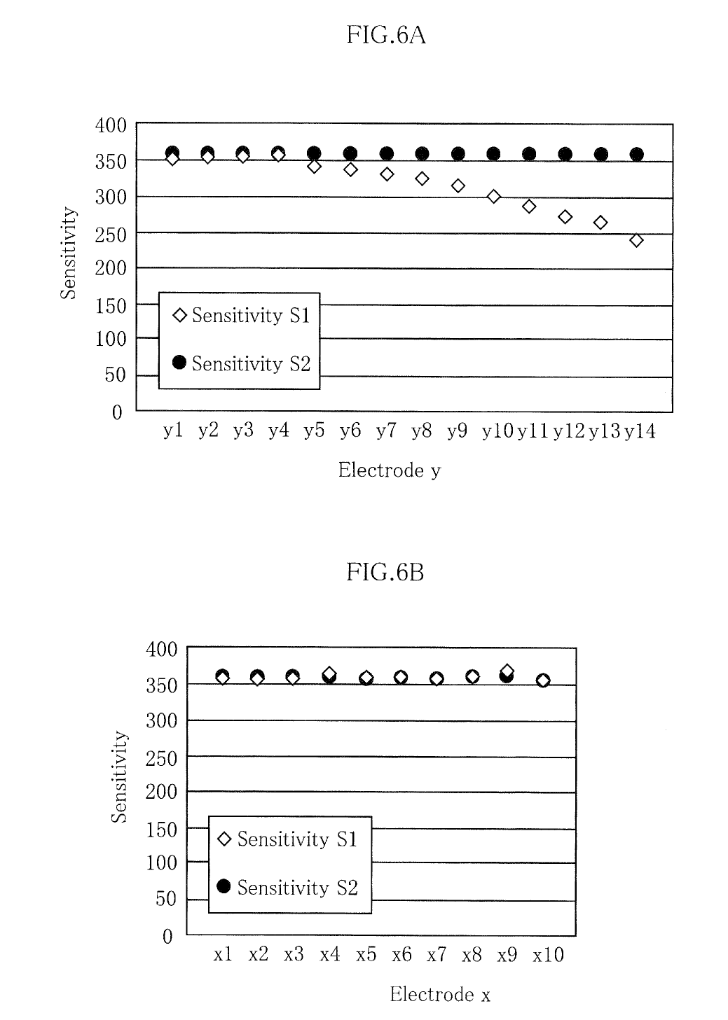

Specifically, the sensitivities of the respective electrodes y are calculated or measured for a given surface area of the electrodes y. Such calculation or measurement may be carried out by a simulation or by making a prototype of the input device provided with a plurality of electrodes y of the same surface area. FIG. 6A illustrates an example of calculation results on the basis of a simulation for the sensitivity S1 of each electrode y in a case where the surface area of the electrodes y is identical. As illustrated in the figure, the sensitivity S1 of the electrodes y tends to decrease from electrodes y1 to y14.

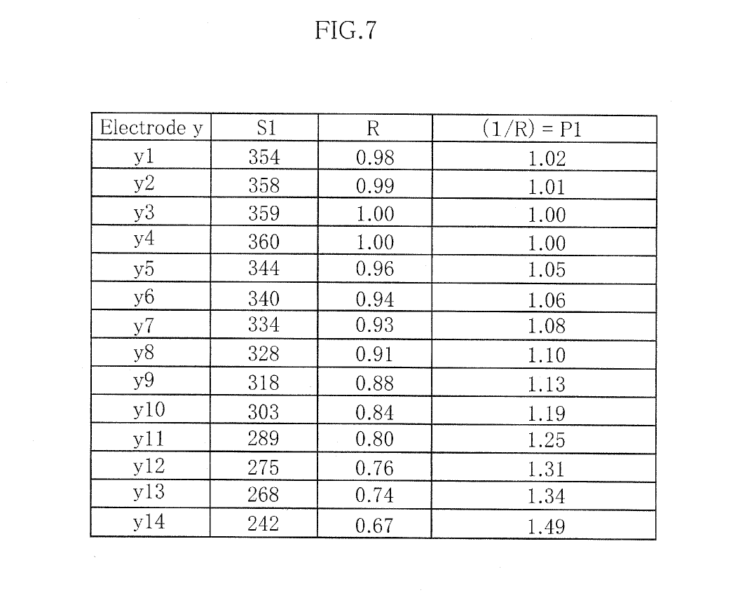

FIG. 7 illustrates the numerical values of the sensitivity S1 for the electrodes y illustrated in FIG. 6A, as well as the sensitivity ratio R and the reciprocal (1/R) thereof.

As illustrated in FIG. 7, there is worked out the sensitivity ratio R with respect to the largest sensitivity value among the sensitivities of the electrodes y, for each electrode y (in the present embodiment, ratio with respect to the sensitivity of electrode y4). The reciprocal (1/R) of the sensitivity ratio R is worked out next. The reciprocal (1/R) is the area ratio P1 for each electrode y in the input device A10. The area ratio P1 of each electrode y illustrated in FIG. 5 can be determined in accordance with the above procedure. The surface area of the actual electrodes y is then determined as the value resulting from multiplying the reciprocal (1/R) by the given surface area that is supposed to be common to the electrodes y. Once the surface area of the electrodes y is determined, there can be determined the surface area of the electrode elements 11 in each electrode y. For instance, the surface areas of the electrode elements 11 comprised in the same electrode y may be identical, except for the electrode elements 11 disposed at both ends of the electrode y, as illustrated in FIG. 2 and FIG. 3.

Next, an appropriate surface area of the electrode elements 21 is determined in such a manner that the electrode elements 21 do not overlap the electrode elements 11. The surface area of the electrode elements 11 increases toward the top of FIG. 2, and hence the surface area of the electrode elements 21 decreases accordingly toward the top of FIG. 2.

The surface area of the electrodes y and the electrodes x can be determined thus in accordance with the above procedure.

The advantages of the input device A10 are explained below.

In the input device A10, the surface area of, for instance, electrode y12 and electrode y13 in FIG. 6A, having a relatively low sensitivity, is greater than the surface area of, for instance, electrode y1 and electrode y2 having a relatively high sensitivity, as illustrated in FIG. 5. As a result, the capacitance between a given conductor and electrode y12 or electrode y13 is greater than the capacitance between the conductor and electrode y1 or electrode y2, when the conductor is positioned at the same distance, and in the same attitude. Accordingly, the detection values of the electrodes y having a greater capacitance take on a greater value. This allows reducing the sensitivity variability in the electrodes y. FIG. 6A illustrates the calculation results on the sensitivity S2 of the electrodes y in the input device A10, based on simulations. The figure shows that the sensitivity S2 of the electrodes y is more uniform than the sensitivity S1. The access position of the finger Fg in direction Y can be detected as a result more accurately in the input device A10.

Although the surface area of the electrode elements 21 in the input device A10 decreases toward the top of FIG. 2 and FIG. 4, the area ratio between electrodes x need not vary on that account. Therefore, the detection precision of the access position of the finger Fg in direction X can be preserved even when the sizes of the electrodes y is dissimilar as described above. FIG. 6B is a graph illustrating the sensitivities of the electrodes x. As illustrated in the figure, the sensitivity S1 of the electrodes x in a case where the electrodes y are of identical size does not vary substantially vis-à-vis the sensitivity S2 of the electrodes x in a case where the sizes of the electrodes y are dissimilar.

Ordinarily, the sensitivity of the electrodes y decreases as the resistance value of the wirings 31 connected to the electrodes y becomes greater. The greater the length of the wirings 31, the greater the resistance value of the wirings 31 is. Therefore, the sensitivity of the electrodes y decreases as the length of the wirings 31 connected to the electrodes y becomes greater. In the present embodiment, the wirings 31 extend from the lower end of the transmitting plate 41 in FIG. 3 toward the electrodes y. Therefore, the wirings 31 connected to the electrodes y disposed at the top in FIG. 3 are longer than the wirings 31 connected to the electrodes y disposed at the bottom in FIG. 3. Accordingly, the configuration of the present embodiment is appropriate for reducing the difference between the sensitivity of electrodes y having a relatively low sensitivity and the sensitivity of electrodes y having a relatively high sensitivity. That is, the configuration of the present embodiment is appropriate for reducing the sensitivity variability in the electrodes y.

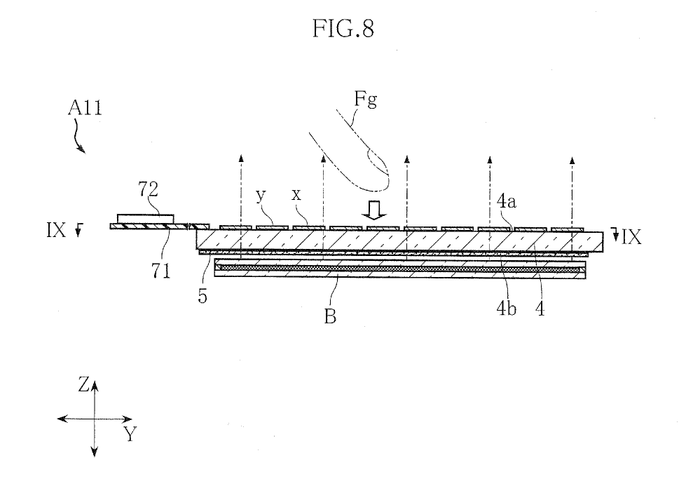

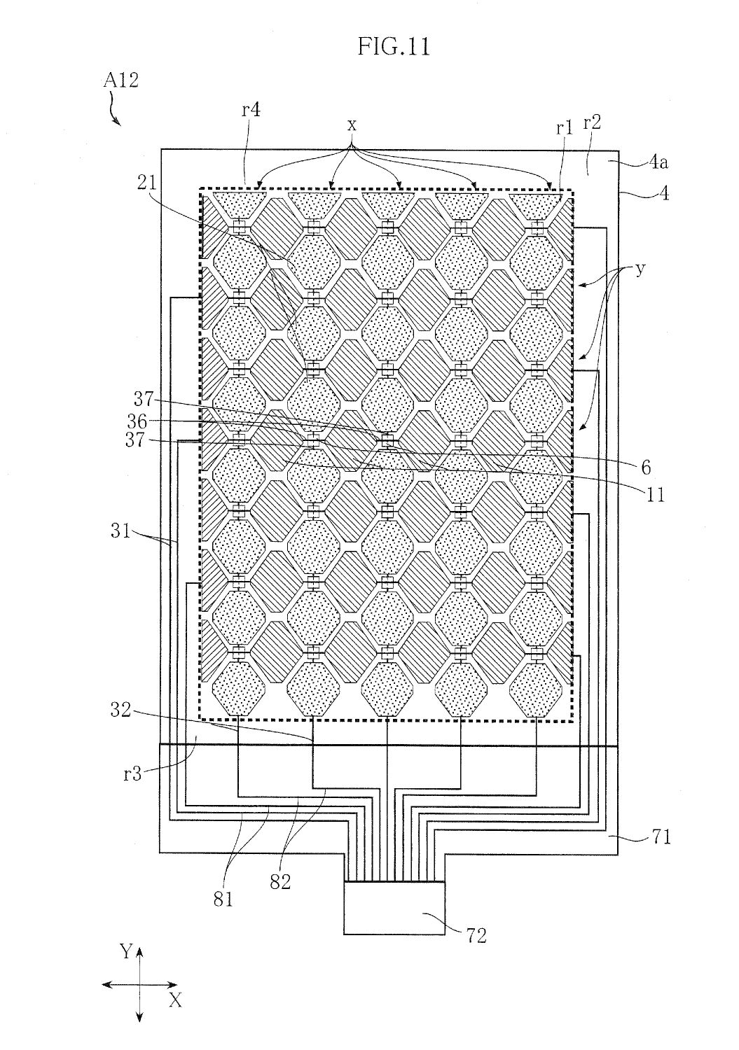

The above-described method for determining the size of the electrodes y in the first embodiment can be used for the input device A11 illustrated in FIG. 8 to FIG. 10 and the input device A12 illustrated in FIG. 11. The input devices A11, A12 differ from the above-described input device A10 mainly in that now both the electrodes y and the electrodes x are formed on the front face 4a of a same transmitting plate 4. In the figures, elements identical or similar to those of the above embodiment are denoted with the same reference numerals as in the above embodiment.

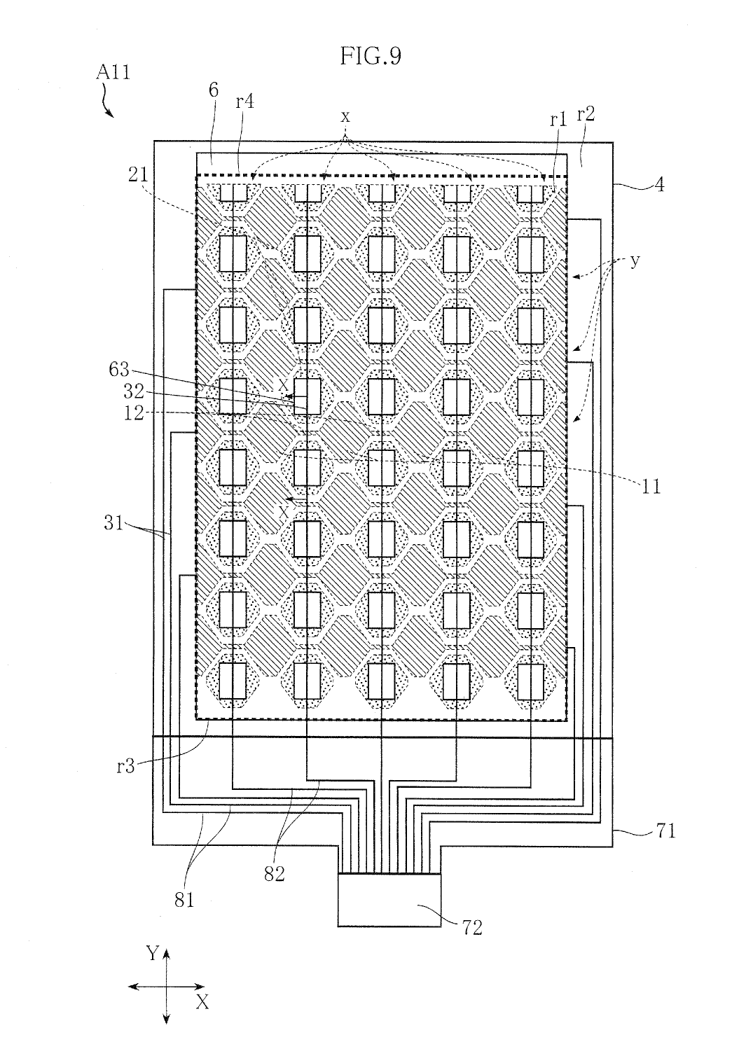

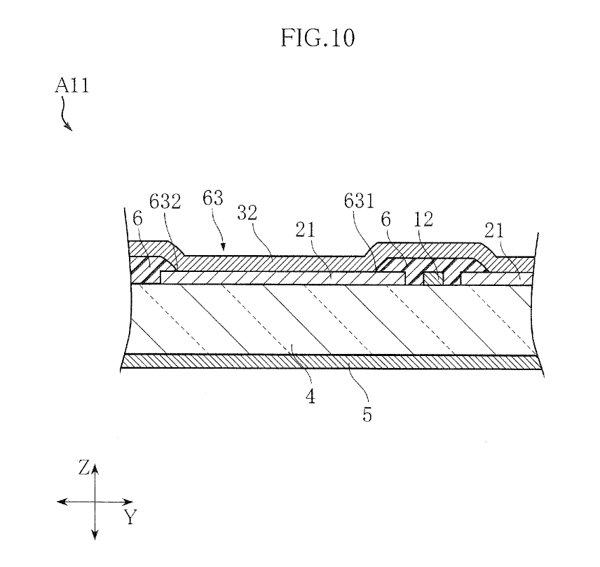

FIG. 8 is a schematic cross-sectional view of the input device A11. FIG. 9 is a schematic plan-view diagram along line IX-IX of FIG. 8. FIG. 10 is a schematic cross-sectional view of FIG. 9 along line X-X. FIG. 11 is a schematic plan-view diagram of the input device A12.

The input device A11 is explained below.

As illustrated in FIG. 8 and FIG. 9, the input device A11 comprises a plurality of electrodes x, y, a plurality of wirings 31, 32, 81, 82, a transmitting plate 4, a shield layer 5, an insulating layer 6, a flexible board 71 and an IC chip 72. For easier comprehension, the wirings 31, 32, 81, 82 and the insulating layer 6 have been omitted in FIG. 8.

The plurality of electrodes y is formed on a front face 4a of the transmitting plate 4. As described above, each electrode y comprises a plurality of electrode elements 11 arrayed along direction X, and wiring sections 12 that electrically connect the electrode elements 11. The plurality of electrodes x are formed on the front face 4a of the transmitting plate 4. The electrodes x comprise each a plurality of electrodes elements 21 arrayed along direction Y. The wiring sections 22 of the input device A10 are not formed in the input device A11.

As illustrated in FIG. 9 and FIG. 10, the insulating layer 6 is stacked on top of the electrodes x, y. The insulating layer 6 comprises, for instance, SiO₂. Rectangular openings 63 are formed in the insulating layer 6. All the openings 63 are formed in regions that overlap the electrode elements 21, so that part of the surface of the electrode elements 21 is exposed. The insulating layer 6 covers the entire detection region r1 except at the regions where the openings 63 are formed.

As illustrated in FIG. 10, the wirings 32 are formed on the insulating layer 6 and on the surface of the electrode elements 21 that is exposed by the openings 63. The wirings 32 extend from the vicinity of end r4, beyond end r3, up to the lower edge of the transmitting plate 4 of FIG. 9. The wirings 32 are connected to the electrode elements 21. As a result, the wirings 32 electrically connect to one another respective electrode elements 21 comprised in the same electrode x. The connection portions of the wirings 32 to the electrode elements 21 are formed in the openings 63, spanning from one end 631 to the other end 632 in direction Y. The wirings 32 comprise, for instance, a metal such as Ag or Al, or a transparent organic conductive material.

A plurality of wirings 81, 82 is formed on the flexible board 71. The wirings 81 are electrically connected to the wirings 31. The wirings 82 are electrically connected to the wirings 32. The wirings 81, 82 are connected to the IC chip 72.

Sensitivity variability among the electrodes y can be reduced in the input device A11 by making dissimilar the size of the electrodes y in accordance with the same method in the first embodiment. The access position of the finger Fg in direction Y can be detected more accurately as a result.

The size of the connection portions of the wirings 32 connected to the electrode elements 21 can be increased in the input device A11. The wirings 32 and the electrode elements 21 can be fixed to one another more solidly as a result, so that the wirings 32 and the electrode elements 21 become less likely to break apart from one another.

The electrodes y are entirely covered by the insulating layer 6. As a result, contact between the wirings 32 and the electrodes y is no longer a concern. The yield of the input device A11 can potentially be enhanced as a result.

An input device A12 is explained below.

The input device A12 illustrated in FIG. 11 comprises a plurality of electrodes x, y, a plurality of wirings 31, 32, 36, 37, 81, 82, a transmitting plate 4, an insulating layer 6, a flexible board 71 and an IC chip 72. The input device A12 differs from the input device A11 in that in the input device A12, the electrode elements 11 are connected to one another by way of the wirings 36, the electrode elements 21 are connected to one another by way of the wirings 37, and the wirings 36, 37 are insulated by the insulating layer 6.

As illustrated in FIG. 11, the plurality of electrodes y and x are formed on the front face 4a of the transmitting plate 4, as in the above-described input device A11. The electrodes y comprise a plurality of electrode elements 11 disposed along direction X. The electrodes x comprise each a plurality of electrodes elements 21 disposed along direction Y.

The plurality of wirings 37 is formed on the front face 4a of the transmitting plate 4. The wirings 37 electrically connect to one another the electrode elements 21 that make up one same electrode x. The wirings 37 are formed in a region flanked by two adjacent electrode elements 21. The wirings 37 comprise, for instance, a metal such as Al, Ag, or Au. The wirings 37 are formed, for instance, by printing after formation of the electrodes x, y on the transmitting plate 4.

The insulating layer 6 is stacked on the wirings 37. The insulating layer 6 comprises, for instance, SiO₂.

The plurality of wirings 36 is stacked on the insulating layer 6. The wirings 36 electrically connect to one another the electrode elements 11 that make up one same electrode y. The wirings 36 are formed in a region flanked by two adjacent electrode elements 11, and connect to each other these electrode elements 11. The wirings 36 comprise, for instance, a metal such as Al, Ag or Au.

Part of the electrodes x, y and the wirings 31, 32, 36, 37 is covered by a coating layer (not shown). The coating layer prevents reflection of external light to suppress loss of visibility. The coating layer has also the function of protecting the electrodes x, y and the wirings 31, 32, 36, 37 against damage.

Sensitivity variability among the electrodes y can be reduced in the input device A12 by making dissimilar the size of the electrodes y in accordance with the same method in the first embodiment. The access position of the finger Fg in direction Y can be detected more accurately as a result.

The wirings 36, 37 comprise a metal. The resistivity variability of the wirings 36, 37 can be reduced as a result, which in turn allows increasing the sensitivity of the electrodes y. The wirings 36, 37 can be made narrower when preserving the resistance of the wirings 36, 37. The overlapping surface area between the wirings 36, 37 can be reduced as a result. This makes it possible to reduce parasitic capacitance in the wirings 36, 37, which in turn allows increasing the sensitivity of the electrodes y.

Since the wirings 36, 37 can be made narrower, the visibility of detection region r1 is not affected even when the wirings 36, 37 are formed of metal.

### Second Embodiment

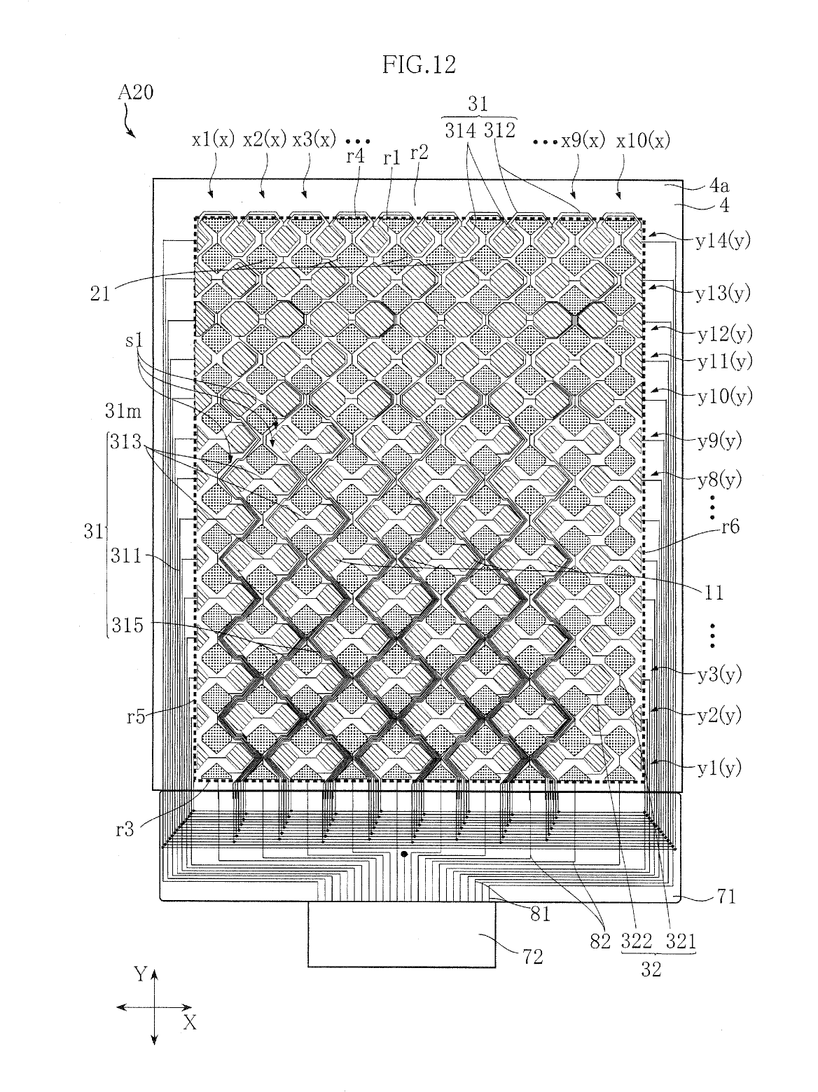

A second embodiment of the present invention will be explained with reference to FIG. 12 to FIG. 17. In the figures, elements identical or similar to those of the above embodiment are denoted with the same reference numerals as in the above embodiment. FIG. 12 is a schematic plan-view diagram of an input device according to the present embodiment. The input device A20 illustrated in the figures differs essentially from the above-described input devices A11, A12 in that herein the wirings 31, 32 that connect the electrode elements 11 to one another and the electrode elements 21 to one another are formed in gaps flanked by the electrode elements 11, 21.

As in the case of the above-described input devices, the input device A20 comprises a plurality of electrodes x, a plurality of electrodes y, a plurality of wirings 31, 32, 81, 82, a transmitting plate 4, a flexible board 71 and an IC chip 72.

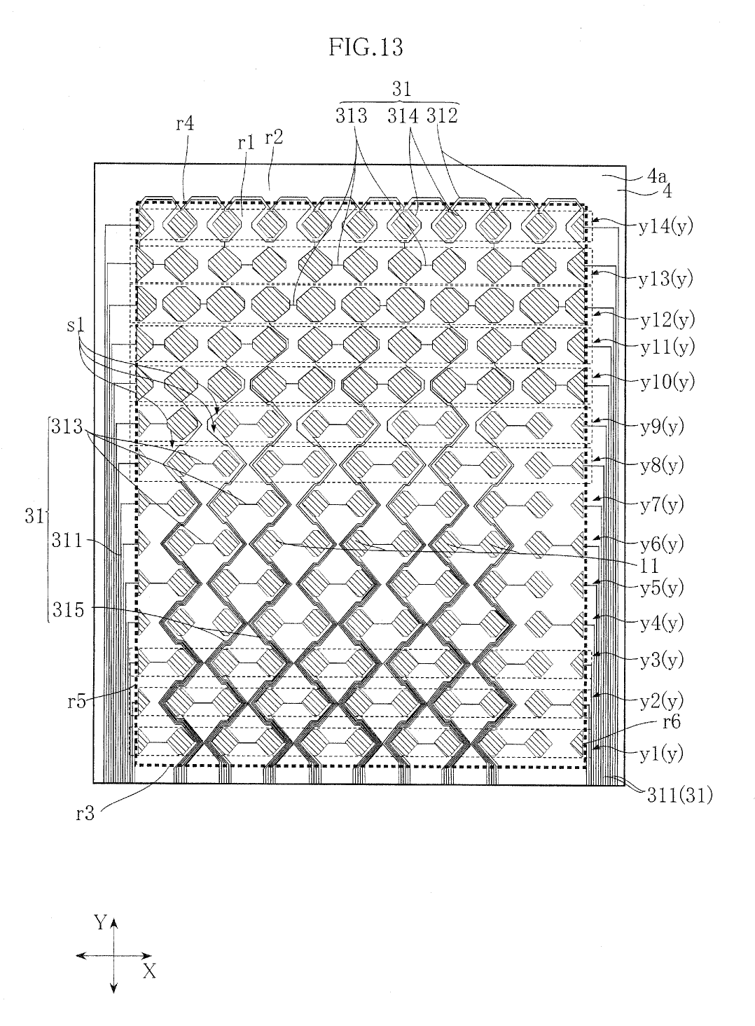

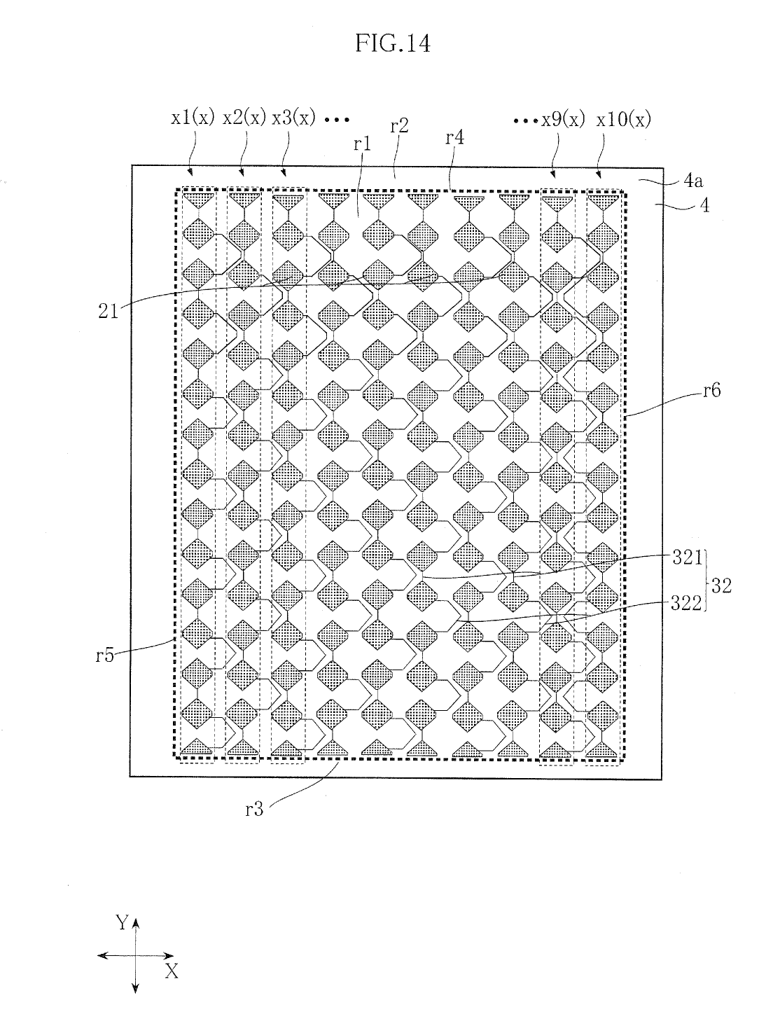

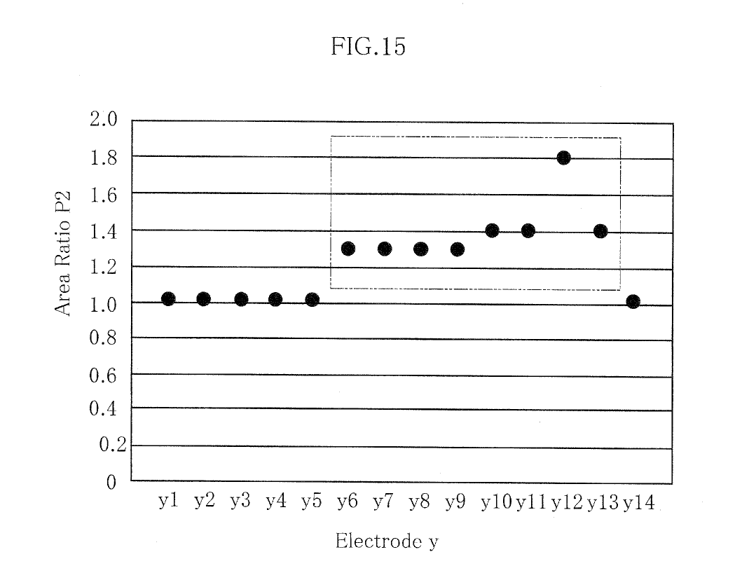

FIG. 13 is a schematic plan-view diagram illustrating mainly the plurality of electrodes y. FIG. 14 is a schematic plan-view diagram illustrating mainly the plurality of electrodes x. The plurality of electrodes y and plurality of electrodes x are formed on the front face 4a of the transmitting plate 4, as in the case of the above-described input devices A11, A12. As illustrated in FIG. 13, the electrodes y are arranged side by side in direction Y. The electrodes y comprise a plurality of substantially lozenge-shaped electrode elements 11 disposed along direction X. FIG. 15 illustrates an area ratio P2 of respective electrodes y. As illustrated in the figure, the surface area of the electrodes y is greater for electrodes y6 to electrode y13 than for other electrodes y. The method for determining the surface area of the electrodes y will be explained below although it is substantially identical to that of the first embodiment.

As illustrated in FIG. 14, the electrodes x are arranged side by side in direction X. The electrodes x comprise a plurality of substantially lozenge-shaped electrode elements 21 disposed along direction Y. As illustrated in FIG. 12, gaps s1 flanked by the electrode elements 11 and the electrode elements 21 are formed on the front face 4a of the transmitting plate 4.

As illustrated in FIG. 12 and FIG. 13, the plurality of wirings 31 is formed on the front face 4a of the transmitting plate 4. All the wirings 31 are connected to the electrode elements 11. The wirings 31 comprise wirings 311 to 315.

The wirings 311 are connected to the electrode elements 11 disposed on the leftmost or rightmost side of FIG. 13. The wirings 311 connected to the electrode elements 11 disposed on the leftmost side extend all toward edge r5 from the connected electrode elements 11, and extend downwards in the figure in direction Y. The wirings 311 connected to the electrode elements 11 disposed on the rightmost side extend all toward edge r6 from the connected electrode elements 11, and extend downwards in the figure in direction Y.

The wirings 312 are connected to the electrode elements 11 in electrode y14 that is disposed topmost in FIG. 13. The wirings 312 extend from two adjacent electrode elements 11 in direction X toward end r4, up to the non-detection region r2. As a result, electrode elements 11 comprised in electrode y14 are electrically connected to one another.

The wirings 313 electrically connect, to each other, two electrode elements 11 adjacent in direction X, from among the electrode elements 11 comprised in electrodes y1 to y13. The wirings 313 are formed in the gaps flanked between the two electrode elements 11. The wirings 313 correspond to an example of the first connection wiring of the present invention.

The wirings 314 are connected to the electrode elements 11 comprised in electrode y13 that is disposed second from the top of FIG. 13. Each wiring 314 is connected to the electrode elements 11 disposed on the left, from among the two electrode elements 11 that are connected to the wirings 313. The wirings 314 extend from the electrode elements 11 toward end r4, up to the non-detection region r2. The wirings 314 are disposed so as to surround the electrode elements 11 comprised in electrode y14, and have no intersections with the wirings 312. As a result, electrode elements 11 comprised in electrode y13 are electrically connected to one another by the wirings 313 and the wirings 314.

The wirings 315 are connected to the electrode elements 11 comprised in electrodes y1 to y12. The wirings 315 as well are connected to the electrode elements 11 disposed on the left, from among the two electrode elements 11 connected to the wirings 313. The wirings 315 extend from the electrode elements 11 downwards in the figure, threading a way through the gaps s1 flanked by the electrode elements 11 and the electrode elements 21, cross over end r3, and reach the non-detection region r2.

As illustrated in FIG. 12, the plurality of wirings 81 is formed on the flexible board 71. The wirings 81 are connected to respective wirings 31. In the flexible board 71, wirings 81 electrically connected to electrode elements 11 comprised in a same electrode y are connected to one another. The intersections between wirings 81 are denoted with black circles in FIG. 12. Thus, electrode elements 11 comprised in a same electrode y (limited to electrodes y1 to y12) are electrically connected to one another.

The wirings 314, wirings 315 and the series of wirings made up through connection of the wirings 315 and the wirings 81 correspond to an example of the link wirings according to the present invention.

As illustrated in FIG. 12 and FIG. 14, the wirings 32 are formed on the front face 4a of the transmitting plate 4, as is the case in the wirings 31. All the wirings 32 are electrically connected to the electrode elements 21. The wirings 32 have wirings 321 and wirings 322. The wirings 321 electrically connect, to each other, two electrode elements 21 adjacent in direction Y. The wirings 321 are formed in the gaps flanked between the two electrode elements 21. The wirings 322 electrically connect, to each other, two electrode elements 21 adjacent in direction Y. In order to avoid intersecting the wirings 313, the wirings 322 are disposed so as to surround one of the two electrode elements 11 that are connected to the wirings 313. Electrode elements 21 comprised in a same electrode x are electrically connected to one another through connection to the wirings 321 and the wirings 322. The wirings 322 correspond to an example of the second connection wiring of the present invention.

The plurality of wirings 82 is formed on the flexible board 71. The wirings 82 are connected to respective wirings 32.

The IC chip 72 is connected to the wirings 81, 82. The IC chip 72 is connected to the electrodes y by way of the wirings 81, the wirings 31 and so forth. The IC chip 72 is connected to the electrodes x by way of the wirings 82, the wirings 32 and so forth.

In the present embodiment, the IC chip 72 can detect the access position of a finger Fg by carrying out the same process as in the first embodiment.

Next, an example of the method for determining the size of the electrodes y and the electrodes x is explained.

In this embodiment again, the size of the electrodes y, and that of the electrodes x as well, is determined so that that surface area of an electrode y having a relatively low sensitivity (low-sensitivity electrode y) is greater than the surface area of an electrode y having a relatively high sensitivity (high-sensitivity electrode).

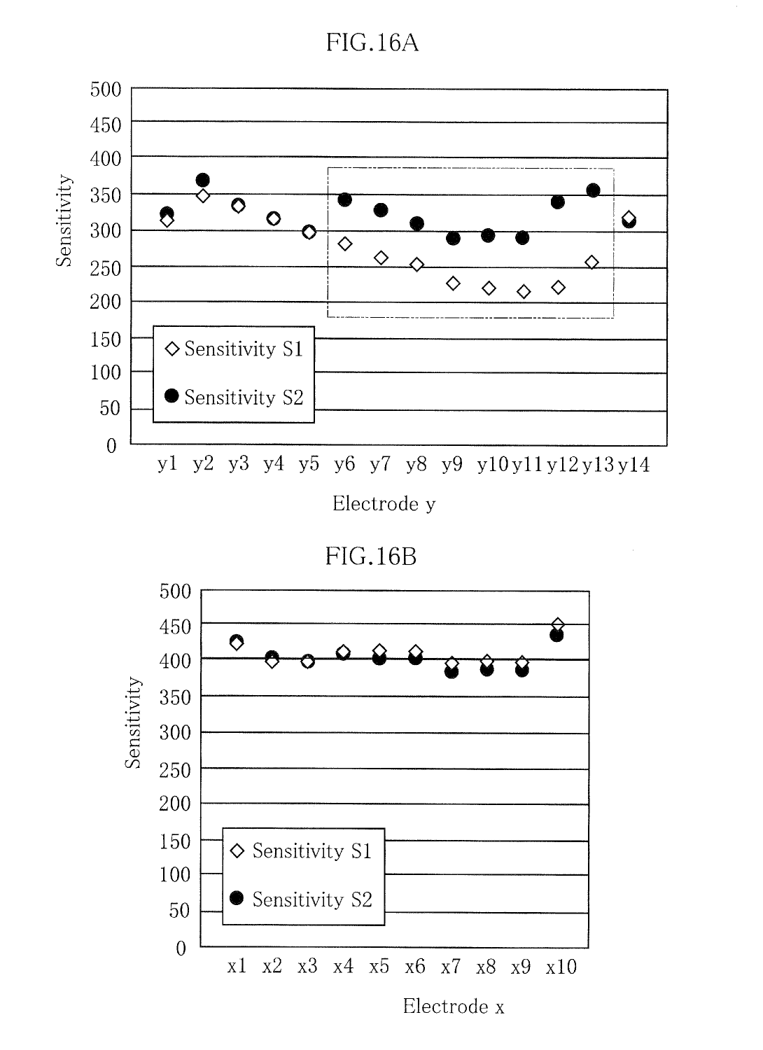

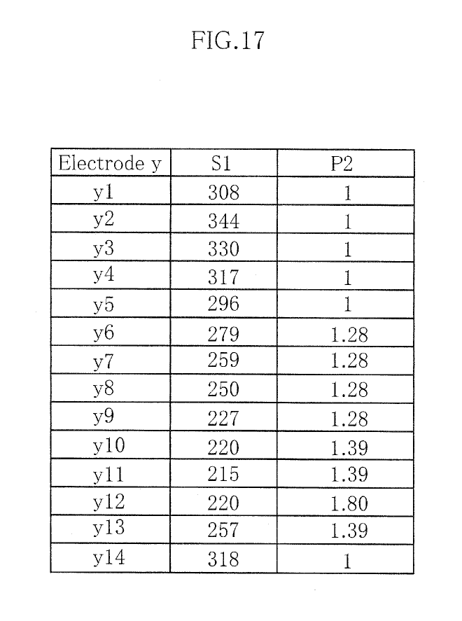

Specifically, the sensitivities of the respective electrodes y are calculated or measured for a given surface area of the electrodes y. Such calculation or measurement may be carried out by a simulation or by making a prototype of the input device provided with a plurality of electrodes y of the same surface area. The sensitivity of the electrodes y is affected by the resistance of the wirings 31, 81 that lead from the IC chip 72 to the electrodes y, and by the parasitic capacitance between the wirings 31, 81 and other wirings. FIG. 16A illustrates an example of calculation results on the basis of a simulation of the sensitivity S1 of each electrode y in a case where the surface area of the plurality of electrodes y is identical. As illustrated in the figure, the sensitivity S1 of the electrodes y tends to be smaller for electrode y10, y11, and neighboring electrodes y, than for other electrodes y. FIG. 17 sets forth numerical values of the sensitivity S1 illustrated in FIG. 16A.

After obtaining the numerical values for sensitivity S1, some electrodes y around electrodes y10, y11 are selected, for instance electrodes y6 to y13. An appropriate value of the area ratio P2 of each electrode y is then determined in such a manner that the surface area of electrodes y6 to y13 is greater than that of other electrodes y, as illustrated in FIG. 17. The area ratio P2 of each electrode y illustrated in FIG. 15 can be determined thus in accordance with the above procedure. The surface area of the electrode elements 11 is determined in accordance with the determined surface area of each electrode y. The surface area of the electrode elements 21 should be determined in such a manner that the electrode elements 21 do not overlap the electrode elements 11.

The advantages of the input device A20 are explained below.

As illustrated in FIG. 15, in the input device A20, the surface area of, for instance, electrode y10 or electrode y11, having relatively low sensitivity in FIG. 16A, is greater than the surface area of, for instance, electrode y1 or electrode y2 having a relatively high sensitivity in FIG. 16A. As a result, the capacitance generated between electrode y10 or electrode y11, having a relatively low sensitivity, and a conductor is greater than the capacitance generated between electrode y1 or electrode y2 and the conductor, when the conductor is positioned in the same attitude and at the same distance. Such being the case, the detection value is greater for electrode y10 and electrode y11. This allows reducing the sensitivity variability in the electrodes y. FIG. 16A illustrates the sensitivity S2 of each electrode y in the input device A20 where the sizes of the electrodes y are dissimilar. The figure shows that the sensitivity S2 of the electrodes is more uniform than the sensitivity S1. The access position of the finger Fg in direction Y can be detected as a result more accurately in the input device A20.

A large number of wirings 315, extending from electrode elements 11 comprised in the electrodes y that are disposed above electrodes y1, y2, is formed around electrode elements 11 comprised in electrodes y1, y2 and so forth that are disposed at the bottom in FIG. 12. By contrast, few wirings 315 are formed around the electrode elements 11 in the vicinity of electrode y10 and electrode y11. The space around the electrode elements 11 increases as there decreases the number of wirings. 315 formed around the electrode elements 11. Therefore, there is no need for reducing the size of the plurality of electrode elements 21 even if the size of the electrode elements 11 comprised in, for instance, electrode y10 disposed at the top of the figure is set to be greater than the size of the electrode elements 11 comprised in, for instance, electrode y1 disposed at the bottom of the figure. Therefore, the detection precision of the access position of the finger Fg in direction X can be preserved even when the surface area of each electrodes y is dissimilar. As illustrated in FIG. 16B, the sensitivity S2 of the electrodes x when the surface area of the electrodes y is dissimilar exhibits virtually no change vis-à-vis the sensitivity S1 of the electrodes x when the surface area of the electrodes y is identical.

In the input device A20, as illustrated in FIG. 13, two electrode elements 11 adjacent in direction X are connected to each other by way of the wirings 313. Therefore, electrode elements 11 comprised in a same electrode y can be electrically connected to one another simply by connecting the wirings 31 that lead up to the non-detection region r2 to one of the two electrode elements. The number of wirings 31 that lead up from the electrode elements 11 to the non-detection region r2 can be reduced thereby. Reducing the number of wirings 31 that lead up to the non-detection region r2 allows reducing in turn the number of intersections between the wirings 81, 82 on the flexible board 71, and makes it possible to reduce parasitic capacitance between the wirings 81, 82. The sensitivity of the electrodes y and the electrodes x can be enhanced as a result.

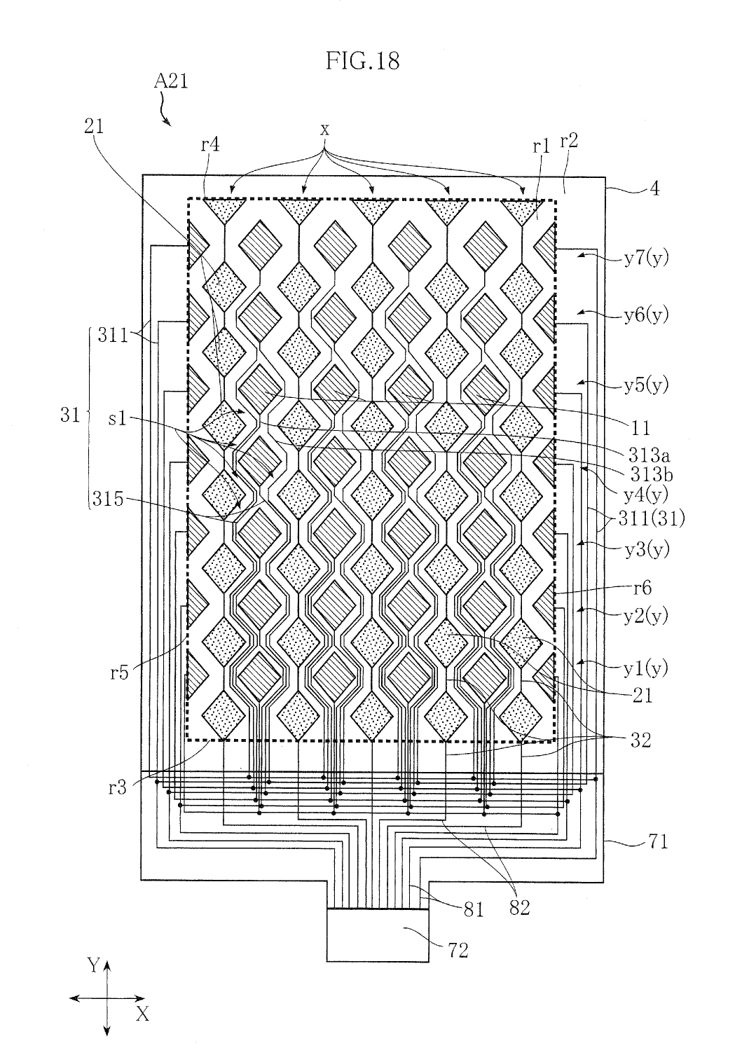

The method for determining the size of electrodes y as explained in the second embodiment can be used also for the input devices A21 to A27 illustrated in FIG. 18 to FIG. 25. In the figures, elements identical or similar to those of the above embodiment are denoted with the same reference numerals as in the above embodiment.

An input device A21 is explained below with reference to FIG. 18.

FIG. 18 is a schematic plan-view diagram of the input device A21. The input device A21 illustrated in the figure differs from the above-described input device A20 in that herein the wirings 31 do not comprise the wirings 312 to 314, and in that the wirings 32 do not comprise the wirings 322. In the input device A21 as well, variability in the sensitivity among electrodes y can be reduced by setting dissimilar sizes for the respective electrode elements 11, in accordance with the same method as described above. The access position of the finger Fg in direction Y can be detected more accurately as a result. For instance, there may be increased the size of the electrode elements 11 comprised in electrodes y4 to y7.

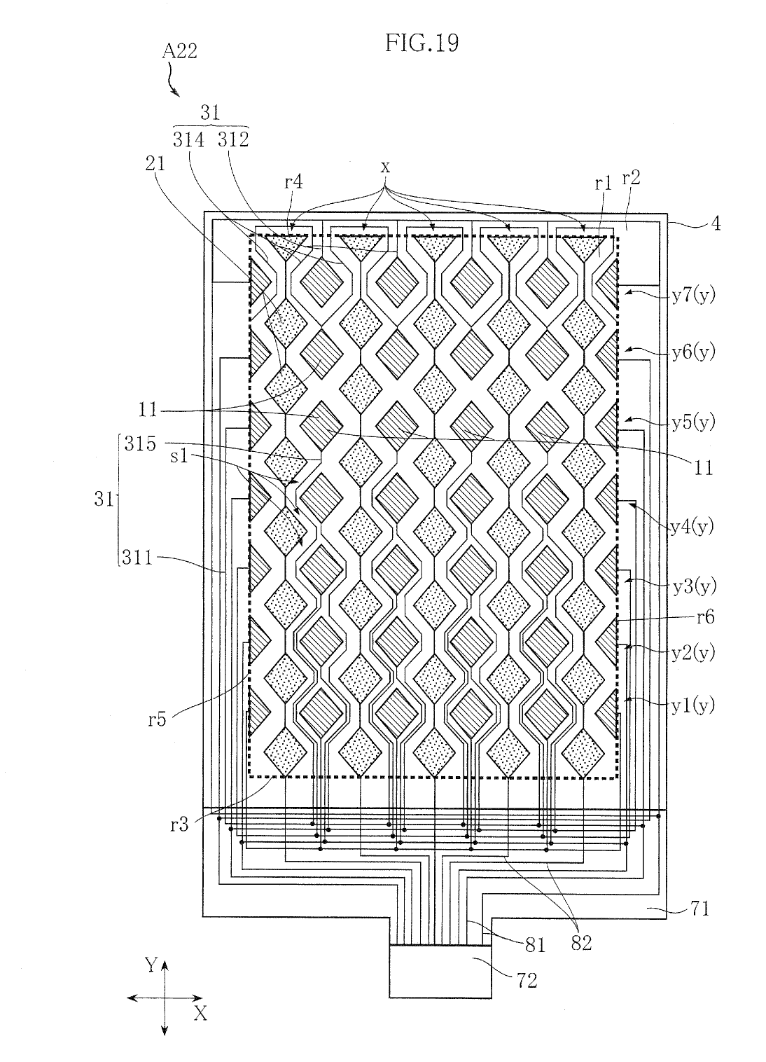

An input device A22 is explained below with reference to FIG. 19.

FIG. 19 is a schematic plan-view diagram of the input device A22. The input device A22 illustrated in the figure differs from the above-described input device A20 in that herein the device does not comprise the wirings 313, and in that the wirings 32 do not comprise the wirings 322. In the input device A22 as well, variability in the sensitivity among electrodes y can be reduced by setting dissimilar sizes for the respective electrode elements 11, in accordance with the same method as described above. The access position of the finger Fg in direction Y can be detected more accurately as a result. For instance, there may be increased the size of the electrode elements 11 comprised in electrodes y4 to y6.

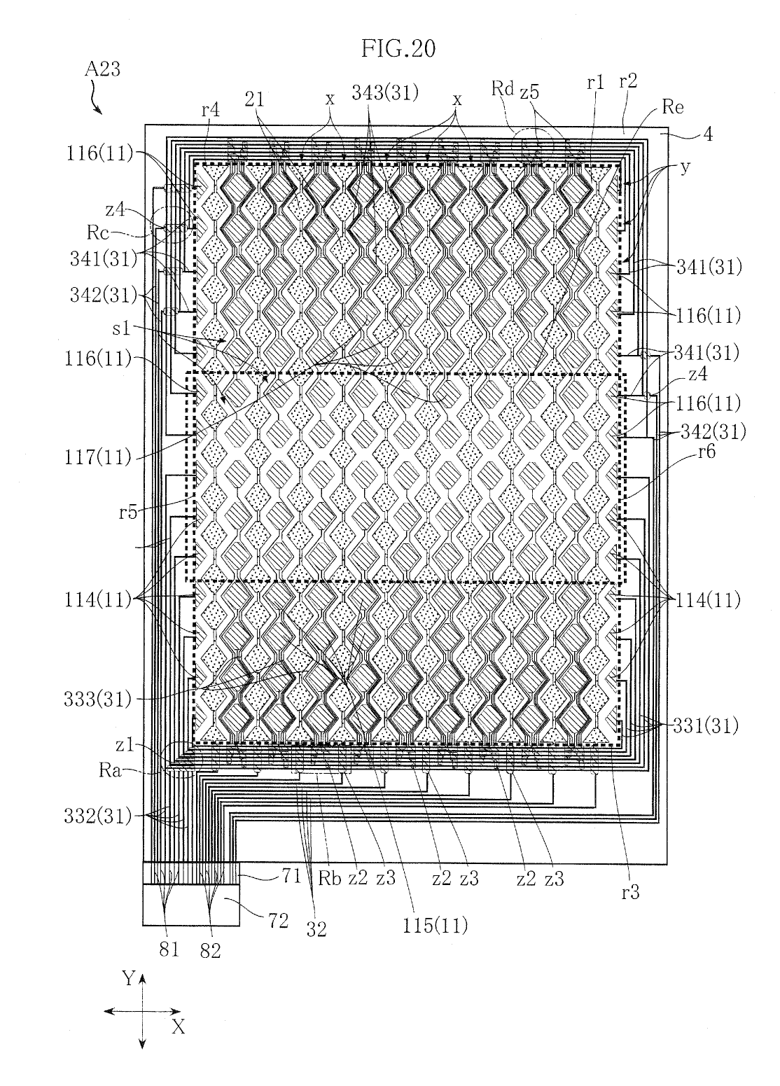

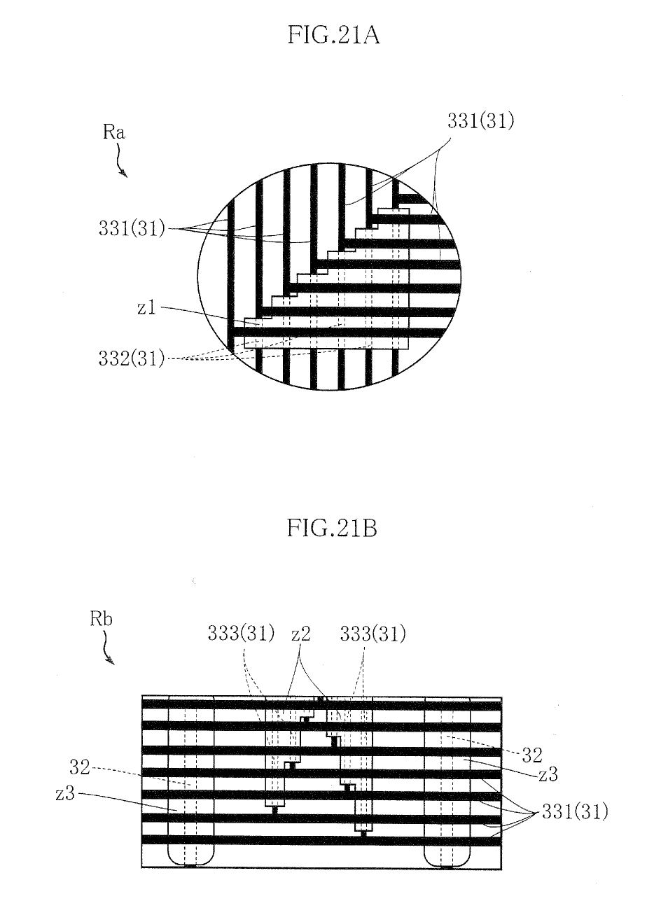

An input device A23 is explained below with reference to FIG. 20 and FIG. 21.

FIG. 20 is a schematic plan-view diagram of the input device A23. FIG. 21 is a partial enlarged diagram of regions Ra, Rb in FIG. 20.

The input device A23 illustrated in FIG. 20 differs from the above-described input device A20 in that herein the wirings 31 connected to the electrode elements 11 disposed at the lower half of the figure extend downwards in the figure from the electrode elements 11, whereas the wirings 31 connected to electrode elements 11 disposed at the upper half of the figure extend upwards in the figure from the electrode elements 11. The input device A23 differs from the input device A20 also in that herein the wirings 31 are connected to one another not on the flexible board 71 but at the non-detection region r2.

In the figure, electrode elements 114, 115 denote electrode elements 11 that are disposed at the bottom half of the figure. The electrode elements 114 are disposed at both ends in direction X. The electrode elements 115 are electrode elements disposed at the bottom half of the figure other than the electrode elements 114. Similarly, electrode elements 116, 117 denote electrode elements 11 that are disposed at the top half of the figure. The electrode elements 116 are disposed at both ends in direction X. The electrode elements 117 are electrode elements disposed at the top half of the figure other than the electrode elements 116.

The wirings 31 comprise wirings 331, 332, 333, 341, 342, 343. The wirings 331, 332, 333, 341, 342, 343 comprise, for instance, a transparent conductive material such as ITO, IZO or the like, or a metal such as Al, Ag or Au.

The wirings 331 connect the electrode elements 114 disposed at both ends of the figure. The wirings 331 extend, in the non-detection region r2, from the electrode elements 114 disposed at the right end of the figure, downwards in the figure along edge r6, and then leftwards in the figure along end r3. The wirings 331 are bent at the lower left of the figure (see region Ra), extend upwards in the figure along edge r5, and are linked to the electrode elements 114 disposed at the left edge in the figure.

The wirings 332 are linked to the wirings 331 at the portion where the wirings 331 are bent, upwards in the figure. The wirings 332 extend downwards in the figure and are connected to respective wirings 81 that are formed on the flexible board 71.

The wirings 333 are connected to respective electrode elements 115. The wirings 333 extend downwards in the figure, from the electrode elements 115, along direction Y. The wirings 333 are linked to the wirings 331 at the non-detection region r2 (for instance at region Rb). Thereby, the electrode elements 11 comprised in one same electrode y disposed at the bottom half of the figure are connected to one another.

As clearly illustrated in FIG. 21A, a plurality of wirings 331 and a plurality of wirings 332 intersect each other at region Ra. The wirings 331 and the wirings 332 that electrically connect different electrodes y are stacked in region Ra with an insulating layer z1 interposed in between. This prevents conduction between wirings 331 and wirings 332 that electrically connect different electrodes y.

Similarly, as clearly illustrated in FIG. 21B, a plurality of wirings 331 and a plurality of wirings 333 intersect each other at region Rb. The wirings 331 and the wirings 333 that are electrically connected to different electrodes y are stacked in region Rb with an insulating layer z2 interposed in between. This prevents conduction between wirings 331, 333 that are electrically connected to different electrodes y. Also, each wiring 32 and a plurality of wirings 331 intersect each other at region Rb. The plurality of wirings 331 and the wiring 32 are stacked in region Rb with an insulating layer z3 interposed in between. This prevents conduction between the plurality of wirings 331 and the wiring 32. Obviously, the insulating layers z2, z3 are also formed outside region Rb, at intersections between the wirings 333 and the wirings 331 that electrically connect different electrodes y, and at intersections between the wirings 331 and the wirings 32.

As illustrated in FIG. 20, the wirings 341 are linked to electrode elements 116 disposed at both ends in direction X. The wirings 341 extend from the electrode elements 116 disposed at the right end of the figure, upwards in the figure along edge r6, in the non-detection region r2. The wirings 341 extend leftwards in the figure along end r4, in the non-detection region r2. The wirings 341 extend downwards in the figure along edge r5, and are bent rightwards in the figure (see region Rc, for instance). The wirings 341 are linked to the electrode elements 116 disposed at the left end of the figure.

The wirings 342 are linked to the wirings 341 at the region where the wirings 341 are bent rightwards in the figure. The wirings 342 extend up to the flexible board 71 along edge r5 or edge r6. The wirings 342 are connected to respective wirings 81 that are formed on the flexible board 71.

The wirings 343 are connected to respective electrode elements 117. The wirings 343 extend from the electrode elements 117 upwards in the figure, up to end r4. The wirings 343 are linked to the wirings 341 at the non-detection region r2 (see region Rd, for instance). Thereby, the electrode elements 11 comprised in one same electrode y disposed at the top half of the figure are connected to one another.

The wirings 342 and the wirings 341 that are electrically connected to different electrodes y intersect at region Rc, as is the case in region Ra and region Rb. The wirings 341 and the wirings 342 that are electrically connected to different electrodes y are stacked in region Rc with an insulating layer z4 interposed in between. This prevents conduction between wirings 341, 342 that are electrically connected to different electrodes y. The wirings 343 and the wirings 341 that are electrically connected to different electrodes y intersect at region Rd. The wirings 343 and the wirings 341 that are electrically connected to different electrodes y are stacked in region Rd with an insulating layer z5 interposed in between. This prevents conduction between wirings 341, 343 that are electrically connected to different electrodes y. Obviously, the insulating layers z4, z5 are also formed outside regions Rc, Rd, at intersections between the wirings 342 and the wirings 341 that are electrically connected to different electrodes y, and at intersections between the wirings 341 and the wirings 343.

In such an input device A23 as well, variability in the sensitivity among electrodes y can be reduced by setting dissimilar sizes for the respective electrode elements 11, in accordance with the same method as described above. The access position of the finger Fg in direction Y can be detected more accurately as a result. For instance, there may be increased the surface area of the electrode elements 11 disposed in region Re.

The visibility of the detection region r1 in the input device A23 can be preserved when the wirings 333, 343, which are formed mainly at the detection region r1, comprise a transparent conductive material that is the same material as the material of the electrodes x, y. Also, the electrodes x, y can be formed simultaneously with the wirings 333, 343 when the electrodes x, y and the wirings 333, 343 comprise the same material. This allows simplifying the manufacturing process of the input device A23.

The manufacturing process of the input device A23 can also be simplified when the wirings 331, 332, 341, 342, formed mainly in the non-detection region r2, comprise a transparent conductive material that is the same material as the material of the electrodes x, y.

The resistance of the wirings 331, 332, 341, 342 can be reduced when these comprise a metal such as Al, Ag or Au. In this case, moreover, the visibility of the detection region r1 is not affected, since the wirings 331, 332, 341, 342 are formed mainly at the non-detection region r2.

Those wirings from among the wirings 31, 32 that are provided on the side of the transmitting plate 4 (i.e. on the lower layer side) may comprise a transparent conductive material at the portions where the wirings 31 and the wirings 32 are stacked at regions Ra, Rb, Rc, Rd. Those wirings from among the wirings 31, 32 that are provided on the opposing side of the transmitting plate 4 (i.e. on the upper layer side) with respect to any of insulating layers z1 to z5 may comprise a metal. This way, those wirings from among the wirings 31, 32 that are close to the transmitting plate 4 can be formed simultaneously with the electrodes x, y. Also, resistance can be reduced in those wirings from among the wirings 31, 32 that are provided on the opposing side of the transmitting plate 4 with respect to any of the insulating layers z1 to z5.

The wirings 333 are linked to the electrode elements 115, and the wirings 343 are linked to the electrode elements 117. This means that the wirings 31 extend from the electrode elements 11 toward the end r3 or r4 that is closer to the electrode elements 11. This allows shortening the length of the wirings 31 in the detection region r1, and allows reducing the resistance of the wirings 31. The sensitivity of the electrodes y can be expected to be enhanced as a result.

The insulating layers z1 to z5 formed at regions Ra, Rb, Rc, Rd and so forth are formed in the non-detection region r2, and not in the detection region r1. Hence, the optical transmittance and refractive index of the detection region r1 is not affected by the formation of the insulating layers z1 to z5. This allows preserving a good visibility of the detection region r1. Also, the fine processing involved in forming the insulating layers z1 to z5 in the non-detection region r2 is rendered unnecessary. This allows simplifying the manufacturing process of the input device A23.

The wirings 331, 332, 333 are connected to one another, and the wirings 341, 342, 343 are connected to one another, at the non-detection region r2. Therefore, neither the wirings 31 need to be connected to one another, nor the wirings 32 need to be connected one another, on the flexible board 71. This allows reducing the number of wirings 81 that must be formed on the flexible board 71. The flexible board 71 can thus be made smaller, which in turn allows reducing the manufacturing costs of the input device A23.

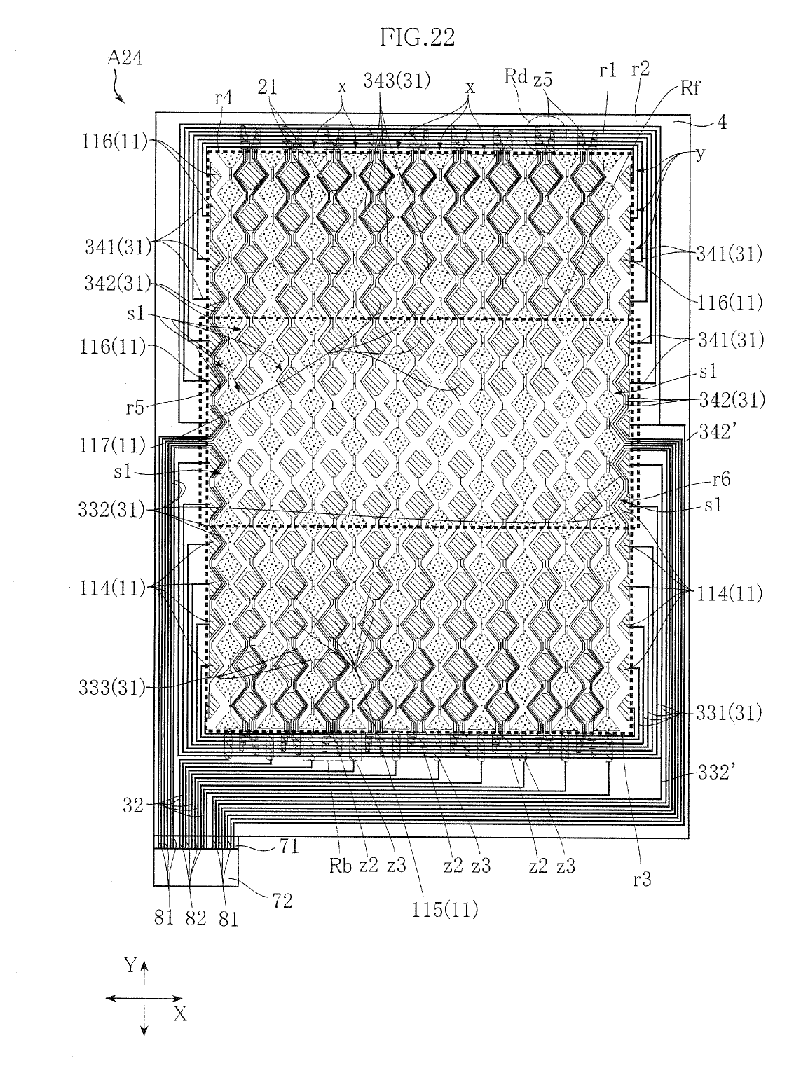

An input device A24 is explained below with reference to FIG. 22.

FIG. 22 is a schematic plan-view diagram of the input device A24. The input device A24 illustrated in the figure differs from the input device A23 above in that now the wirings 332 (except wiring 332′) are not directly linked to the wirings 331 but to the electrode elements 114, and in that the wirings 332 are disposed in the gaps s1 formed between the electrode elements 114 and the electrode elements 21 adjacent to the electrode elements 114. The input device A24 differs also from the input device A23 in that now the wirings 342 (except wiring 342′) are not directly linked to the wirings 341 but to the electrode elements 116, and in that the wirings 342 are disposed in the gaps s1 formed between the electrode elements 116 and the electrode elements 21 adjacent to the electrode elements 116.

The wirings 332 extend from the electrode elements 114 upwards in the figure, substantially along edge r5 or edge r6, within the detection region r1. The wirings 332 cross over edge r5 or edge r6 at the central portion in direction Y. The wirings 332 extend along edge r5 or edge r6, within the non-detection region r2, up to the flexible board 71.

The wiring 332′ is linked to the wirings 331 in the non-detection region r2, at the bottom right in the figure. The wiring 332′ leads also up to the flexible board 71.

The wirings 342 extend from the electrode elements 116, downwards in the figure, substantially along edge r5 or edge r6, within the detection region r1. The wirings 342 cross over edge r5 or edge r6 at the central portion in direction Y. The wirings 342 extend along edge r5 or edge r6, within the non-detection region r2, up to the flexible board 71.

The wiring 342′ is linked to the wirings 341 at the central portion in direction X, within the non-detection region r2. The wiring 342′ leads also up to the flexible board 71.

In such an input device A24 as well, variability in the sensitivity among electrodes y can be reduced by setting dissimilar sizes for the respective electrode elements 11, in accordance with the same method as described above. The access position of the finger Fg in direction Y can be detected more accurately as a result. For instance, there may be increased the surface area of the electrode elements 11 disposed in region Rf.

In the input device A24, the wirings 331 and the wirings 332 are not stacked on each other. That is, the intersections of the wirings 331 and the wirings 332 in region Ra of the input device A23 illustrated in FIG. 20 are not formed in the input device A24. This allows reducing the parasitic capacitance between the wirings 331 and the wirings 332. The detection sensitivity of the electrodes y can be expected to improve thereby.

In the input device A24, the wirings 341 and the wirings 342 are not stacked on each other. This allows reducing the parasitic capacitance between the wirings 341 and the wirings 342. The detection sensitivity of the electrodes y can be expected to improve thereby. The input device A24 affords the same advantages as the input device A23.

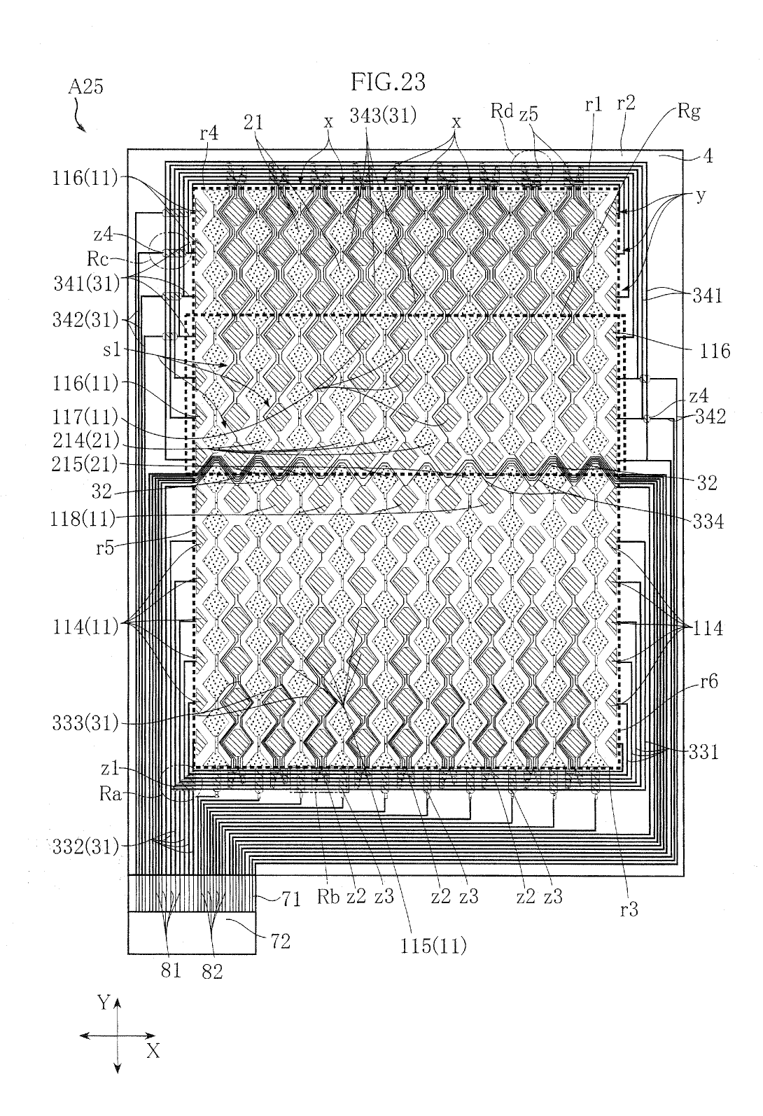

An input device A25 is explained with reference to FIG. 23.

FIG. 23 is a schematic plan-view diagram of the input device A25. The input device A25 illustrated in FIG. 8 differs from the input device A24 above in that herein the wirings 334 that connect to one another those electrode elements 118 disposed in the center in direction Y, from among the electrode elements 11, are formed in gaps flanked by adjacent electrode elements 214, 215 in direction Y. The input device A25 differs also from the input device A24 in that herein the wirings 32 that are linked to respective electrode elements 214 extend alongside the wirings 334 toward edge r5 or edge r6. The wirings 32 extend along edge r5 or edge r6 downwards in the figure, within the non-detection region r2, and are connected to the wirings 82 formed on the flexible board 71.

In such an input device A25 as well, variability in the sensitivity among electrodes y can be reduced by setting dissimilar sizes for the respective electrode elements 11, in accordance with the same method as described above. The access position of the finger Fg in direction Y can be detected more accurately as a result. For instance, there may be increased the surface area of the electrode elements 11 disposed in region Rg.

In the input device A25, the electrode elements 118 are electrically connected to one another by way of the wirings 334. As a result, there is no need for forming wirings 331 in order to electrically connect the electrode elements 118 to one another. This allows reducing the number of intersections between wirings 31, 32 at, for instance, region Ra and region Rb. Parasitic capacitance among the wirings 31 or between the wirings 31 and the wirings 32 can be reduced as a result. The detection sensitivity of the electrodes y can be expected to improve thereby.

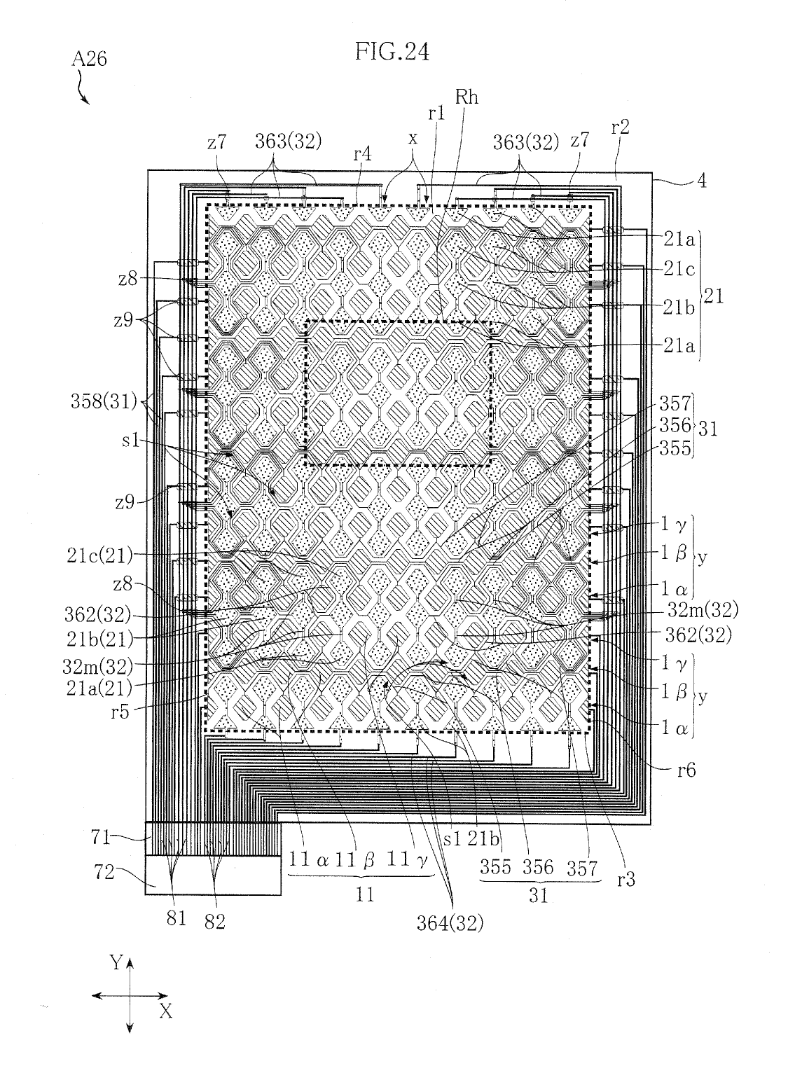

An input device A26 is explained below with reference to FIG. 24.

FIG. 24 is a schematic plan-view diagram of the input device A26. The arrangement of the wirings 31, 32 of an input device A26 illustrated in FIG. 24 differs from that of the input device A23 in the above embodiment. In the figure, the electrodes y are assigned reference numerals that yield electrodes 1α, 1β, 1γ, 1α, 1β, 1γ, sequentially from the bottom. The electrode elements 11 comprised in respective electrodes 1α, 1β, 1γ are denoted as electrode elements 11α, 11β, 11γ.

The wirings 31 comprise wirings 355, 356, 357, 358. The wirings 355 electrically connect electrode elements 11α to one another. The wirings 355 run along gaps s1 to the left, right and above the electrode elements 11α. The wirings 355 run also along gaps flanked by electrode elements 11β.

The wirings 356 electrically connect electrode elements 11β to one another. The wirings 356 are formed in gaps flanked by the electrode elements 11β. The wirings 356 extend in direction X.

The wirings 357 electrically connect electrode elements 11γ to one another. The wirings 357 run along gaps s1 to the left, right and below the electrode element 11γ. The wirings 357 run also along gaps flanked by electrode elements 11β.

The wirings 358 are connected to electrode elements 11α, 11β, 11γ disposed at one end in direction X. The wirings 358 extend from the electrode elements 11α, 11β, 11γ toward edge r5 or edge r6, and extend downwards in the figure within the non-detection region r2. The wirings 358 are connected to respective wirings 81 that are formed on the flexible board 71.

The electrode elements 21 comprise electrode elements 21a, 21b, 21c.

The wirings 32 comprise wirings 32m, 362, 363, 364. The wirings 32m link to one another electrode elements 21 that are adjacent in direction Y.

The wirings 32m link to one another electrode elements 21a, 21b, that are adjacent in direction Y, and electrode elements 21b, 21c that are adjacent in direction Y. The electrode elements 21a, 21b and 21c become electrically connected to one another thereby.

The wirings 362 are linked to respective electrode elements 21b. The wirings 362 extend from the electrode elements 21b toward edge r5 or edge r6. The wirings 362 extend toward the edge r5 or edge r6 that is closer to the electrode elements 21b to which the wirings 362 are connected. The wirings 362 are disposed in such a manner so as not to overlap any of the electrode elements 21 other than the electrode elements 21b to which the wirings 362 are connected to, the electrode elements 11, and the wirings 31, 32, and in such a manner so as to surround the electrode elements 21a or electrode elements 21c at an end, from among the electrode elements 21a, 21b, 21c.

The wirings 363 are linked to the electrode elements 21a disposed topmost in the figure. The wirings 363 extend, within the non-detection region r2, from the electrode elements 21a leftwards or rightwards in the figure, along end r4, and extend then downwards in the figure along edge r5 or edge r6. The wirings 363 are connected to respective wirings 82 that are formed on the flexible board 71. The wirings 363 are connected to one end of the wirings 362 at portions where the wirings 363 extend downwards in the figure along edge r5 or edge r6.

Above end r4, the wirings 363 intersect other wirings 363 that are connected to different electrode elements 21. The wirings 363 are stacked at these intersections with insulating layers z7 interposed in between. This prevents conduction between wirings 363 that are electrically connected to different electrodes x. Likewise, the wirings 363 intersect the wirings 362 at portions where the wirings 363 extend downwards in the figure along edge r5 or edge r6. The wirings 363 and the wirings 362 are stacked at these intersections with insulating layers z8 interposed in between. This prevents conduction between wirings 363 and wirings 362 that are electrically connected to different electrodes x. Also, the wirings 363 intersect the wirings 358 at portions where the wirings 363 extend downwards in the figure along edge r5 or edge r6. The wirings 363 and the wirings 358 are stacked at these intersections with insulating layers z9 interposed in between. This prevents conduction between the wirings 363 and the wirings 358.

The wirings 364 are linked to the electrode elements 21b disposed lowermost in the figure. The wirings 364 are also linked to the wirings 82.

In such an input device A26 as well, variability in the sensitivity among electrodes y can be reduced by setting dissimilar sizes for the respective electrode elements 11, in accordance with the same method as described above. The access position of the finger Fg in direction Y can be detected more accurately as a result. For instance, there may be increased the surface area of the electrode elements 11 disposed in region Rh.

In the present embodiment, the wirings 32m electrically connect the electrode elements 21a, 21b, 21c to one another. As a result, electrode elements 21 comprised in one same electrode x can be electrically connected to one another by simply connecting the wirings 32 that lead up to the non-detection region r2 to the electrode elements 21b. That is, the wirings 32 leading up to the non-detection region r2 need not be connected to the electrode elements 21a, 21c. This allows reducing, as a result, the number of wirings 32 that lead up to the non-detection region r2. In turn, this allows reducing the number or intersections among wirings 31, 32 in the non-detection region r2. Parasitic capacitance between the wirings 31, 32 can be reduced as a result. The flexible board 71 can also be made smaller, since the number of wirings 32 that lead up to the non-detection region r2 can be reduced.

The wirings 362 linked to the electrode elements 21b disposed in the left half of the figure extend leftwards in the figure. The wirings 362 linked to the electrode elements 21b disposed in the right half of the figure extend rightwards in the figure. The wirings 362 extend toward the edge r5 or edge r6 that is closer to the electrode elements 21b to which the wirings 362 are connected. This allows shortening the length of the wirings 362 in the detection region r1, and allows reducing the resistance of the wirings 362. The sensitivity of the electrodes y can be expected to be enhanced as a result.

Among the wirings 362, those connected to adjacent electrode elements 21b in direction X are disposed so as to surround the electrode elements 21a, while the other wirings 362 are disposed so as to surround the electrode elements 21c. The wirings 362 are not disposed in the same gap s1. This allows narrowing the gap s1. The surface area occupied by the electrodes x, y in the detection region r1 can be increased as a result, which in turn can be expected to allow increasing the sensitivity of the electrodes x, y.

The length of ends r3, r4 along direction X is shorter than the length of edges r5, r6 along direction Y. Accordingly, forming the wirings 362 along direction X is appropriate for shortening the length of the wirings 362.

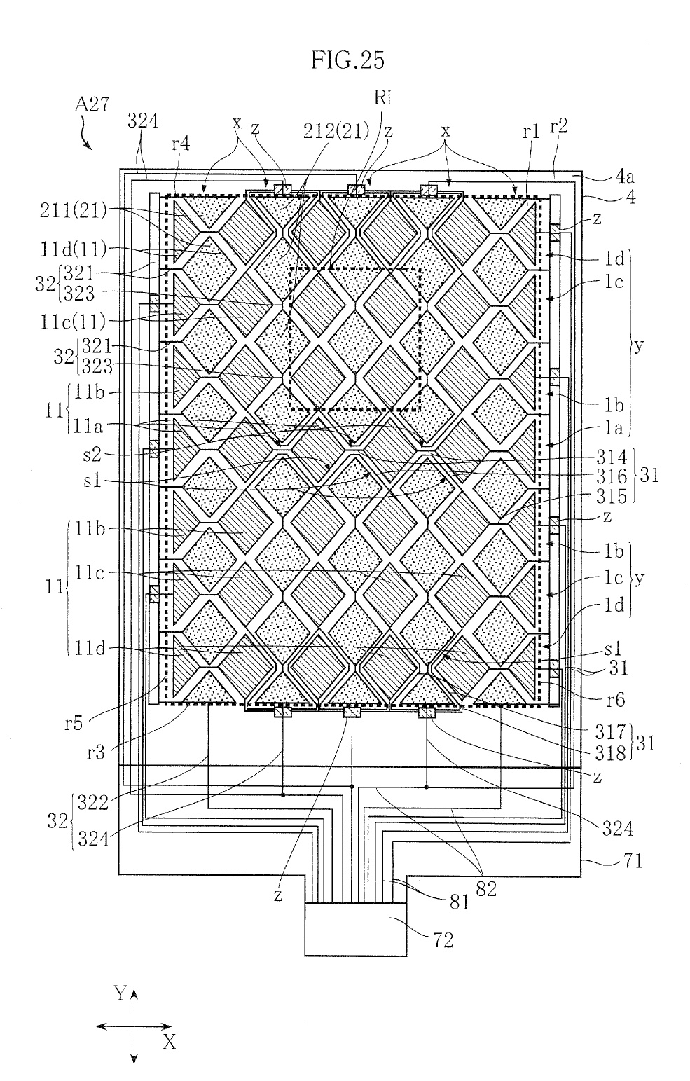

An input device A27 is explained below with reference to FIG. 25.

FIG. 25 is a schematic plan-view diagram of the input device A27. The electrodes y include electrode 1a disposed at the center in direction Y, and electrodes 1b, 1c and 1d disposed away from the center. Electrode elements 11a, 11b, 11c, 11d denote the electrode elements 11 comprised in electrodes 1a, 1b, 1c, 1d, respectively. The electrode la traverses the detection region r1, extending in direction X.

Electrode elements 211 are those electrode elements 21 that are disposed at both ends in direction X. Electrode elements 212 are those electrode elements 21 other than the electrode elements 211.

Gaps s2, flanked by electrode elements 212, are formed at the central portion in direction Y in FIG. 25. The gaps s2 are also flanked by the electrode elements 11a. The gaps s2 are disposed as a plurality thereof along direction X. In the input device A27 there are formed three gaps s2.

As is the case in the above embodiments, the wirings 32 are formed on the front face 4a of the transmitting plate 4. Wirings 321 and wirings. 322 denote those wirings, from among the wirings 32, that are connected to the electrode elements 211. Wirings 323 and wirings 324 denote those wirings, from among the wirings 32, that are connected to the electrode elements 212.

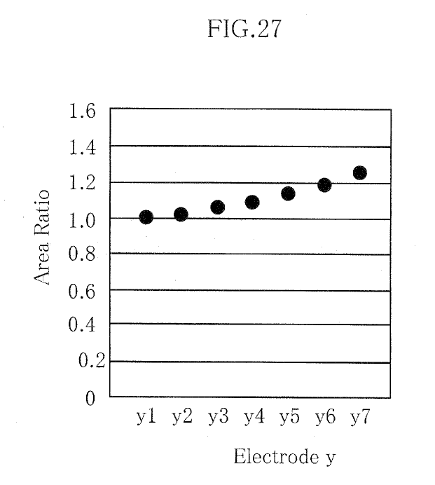

The wirings 321 extend from the electrode elements 211 toward edges r5, r6 along direction X. The wirings 321 are connected to one another at the non-detection region r2. The portions of the wirings 321 formed in the non-detection region r2 comprise a metal such as Ag or Al. The portions comprising such a metal are depicted in grey in FIG. 27. The wirings 322 extend downwards in the figure from the electrode elements 211 disposed lowermost in the figure. The wirings 323 are formed in gaps flanked by the electrode elements 212, and connect the electrode elements 212 to one another. However, no wirings 323 are formed in the gaps s2. The wirings 324 extend upwards in the figure from the electrode elements 212 disposed topmost in the figure, and extend downwards in the figure from the electrode elements 212 disposed lowermost in the figure. The wirings 324 intersect the wirings 317, 318 for instance at the non-detection region r2 next to ends r3, r4. An insulating layer z is formed so as to prevent conduction between the wirings 324 and the wirings 317, 318.

The wirings 31 are formed on the front face 4a of the transmitting plate 4. The wirings 31 comprise wirings 314, 315, 316, 317, 318. The wirings 314 are formed in the gaps s2. The wirings 314 electrically connect the electrode elements 11a to one another. The wirings 315 extend toward the interior of detection region r1, from those electrode elements, among electrode elements 11b, 11c, 11d, that are disposed in the vicinity of edges r5, r6. The wirings 316 electrically connect the electrode elements 11b to one another. The wirings 316 extend from the electrode elements 11b into the detection region r1, and are formed in the gaps s2 and in the gaps s1 adjacent to the electrode elements 11a. The wirings 317 electrically connect the electrode elements 11c to one another. The wirings 317 extend from the electrode elements 11c toward ends r3, r4, and are formed in the gaps s1 adjacent to the electrode elements 11d. The wirings 318 electrically connect the electrode elements 11d to one another. The wirings 318 extend from the electrode elements 11d toward ends r3, r4.

The wirings 82 are connected to respective wirings 322, 324. The wirings 82 connected to the wirings 324 are connected to one another on the flexible board 71. The electrode elements 212, flanking the gaps s2 from above and below in the figure, are connected to one another as a result.

The wirings 81 are connected to respective wirings 31 that extend from the electrode elements 11 disposed at one end in direction X.

In such an input device A27 as well, variability in the sensitivity among electrodes y can be reduced by setting dissimilar sizes for the respective electrode elements 11, in accordance with the same method as described above. The access position of the finger Fg in direction Y can be detected more accurately as a result. For instance, there may be increased the surface area of the electrode elements 11 disposed in region Ri.

The electrode elements 11b can be connected to one another through formation of the wirings 316 in the gaps s1, s2. As a result, no wirings 31 need be formed, in the non-detection region r2 and so forth, in order to connect the electrode elements 11b to one another. This is suitable for shortening the wirings 316, and for reducing the resistance of the wirings 31. Moreover, it is possible to reduce the number of intersections between the wirings 31 and the wirings 32 at the non-detection region r2. This results in fewer insulating layers required to insulate the wirings 31 and the wirings 32 at the non-detection region r2.

The wirings 321 have portions extending in direction X to edge r5 or r6. Thus, it is possible to form wirings 31 that link adjacent electrode elements 11 in the gaps flanked by adjacent electrode elements 211. This is suitable for shortening the wirings 31, and for reducing the resistance of the wirings 31.

The wirings 318 extend from the electrode elements 11d toward the non-detection region r2, but not into the interior of the detection region r1. Accordingly, no wirings 318 need be formed in the gaps s1. This allows reducing the number of wirings 31 that must be formed in the gaps s1. The size of the gaps s1 can be reduced as a result. The above configuration is suitable for increasing the surface area occupied by the electrodes x, y in the detection region r1, and for enhancing the sensitivity of the electrodes x, y.

### Third Embodiment

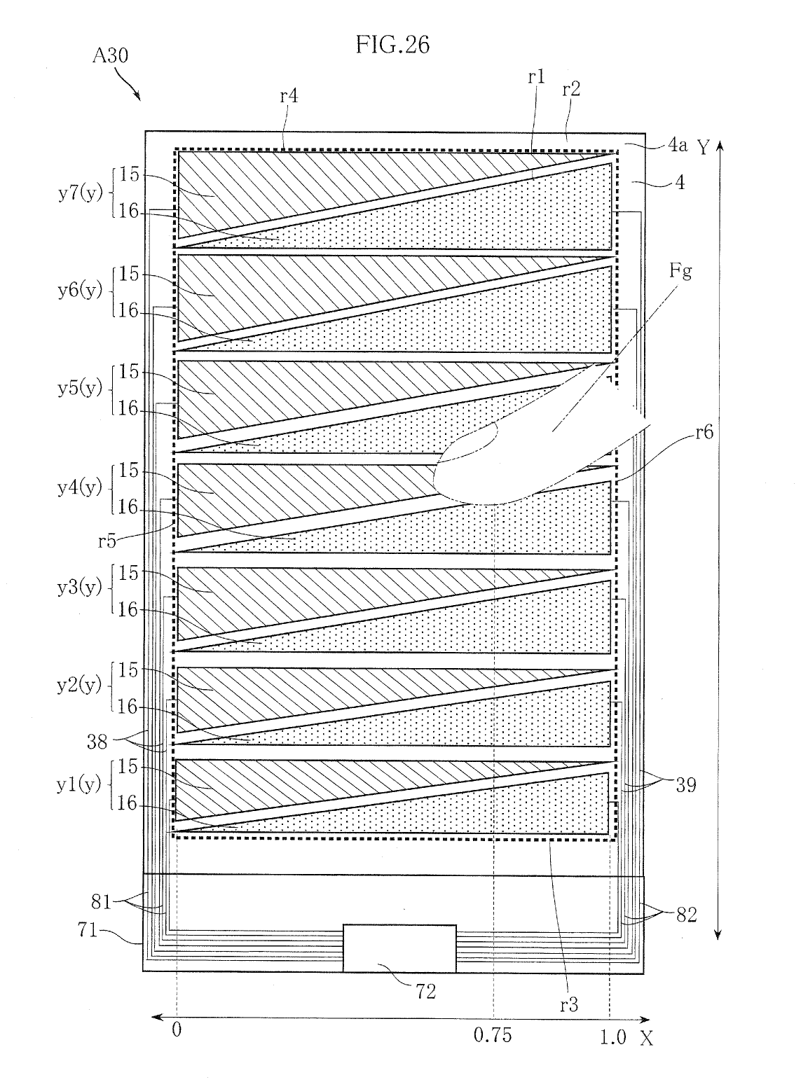

A third embodiment of the present invention will be explained with reference to FIG. 26 to FIG. 28. In the figures, elements identical or similar to those of the above embodiment are denoted with the same reference numerals as in the above embodiment. FIG. 26 is a schematic plan-view diagram of an input device according to the present embodiment. The input device A30 illustrated in the figures is a so-called slider-type input device. The method for detecting the finger Fg in direction X is different from that of the above-described input devices.

The input device A30 comprises a plurality of electrodes y, wirings 38, 39, 81, 82, a transmitting plate 4, a flexible board 71 and an IC chip 72.

The plurality of electrodes y is formed on a front face 4a of the transmitting plate 4. The electrodes y extend in direction X and are arranged side by side in direction Y. Each electrode y comprises slider electrodes 15, 16. FIG. 27 illustrates the surface area of each electrode y. The surface area of the electrodes y denotes herein the summation of the surface areas of the slider electrodes 15 and the slider electrodes 16.

As illustrated in FIG. 27, the surface area of the electrodes y increases in the order electrodes y1, y2 . . . . The surface area of each electrode y can be determined in accordance with the same method as in the first embodiment and the second embodiment described above.

The slider electrodes 15 are wedge-shaped, with the leading ends thereof pointing toward one side in direction X. That is, the slider electrodes 15 extend in such a manner that the size thereof in direction Y decreases toward the right of the figure. The slider electrodes 16 are wedge-shaped, with the leading ends thereof pointing toward the other side in direction X. That is, the slider electrodes extend in such a manner that the size thereof in direction Y decreases toward the left of the figure. The slider electrodes 15 and the slider electrodes 16 are alternately disposed along direction Y.

The wirings 38, 39 are formed on the front face 4a of the transmitting plate 4. The wirings 38, 39 are obtained by patterning a thin film comprising a transparent conductive material such as ITO, IZO or the like. The wirings 38 are connected to the slider electrodes 15. The wirings 39 are connected to the slider electrodes 16. All the wirings 38, 39 extend toward the lower end of the transmitting plate 4 in the figure, from the slider electrodes 15 or the slider electrodes 16.

The flexible board 71 is provided at an end of the transmitting plate 4 in direction Y. Wirings 81, 82 are formed on the flexible board 71. The wirings 81 are connected to respective wirings 38. The wirings 82 are connected to respective wirings 39. The IC chip 72 is mounted on the flexible board 71. The IC chip 72 is connected to the slider electrodes 15 by way of the wirings 81, 38. The IC chip 72 is connected to the slider electrodes 16 by way of the wirings 82, 39. In the present embodiment, the IC chip 72 can calculate the detection values of the slider electrodes 15 and of the slider electrodes 16, independently and at all times.

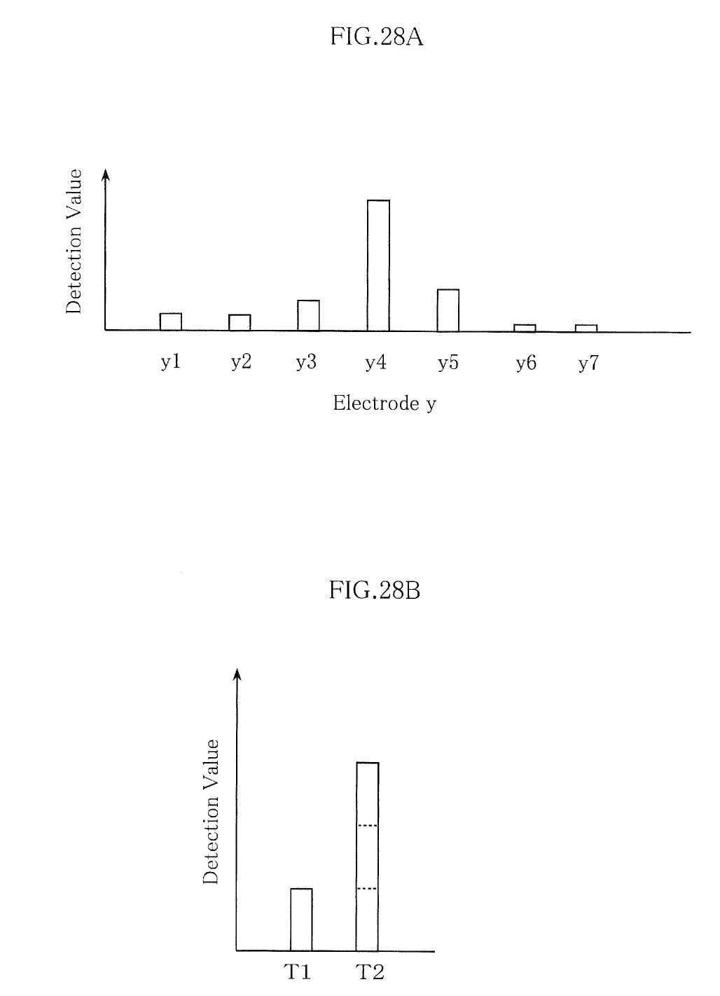

An explanation follows next, with reference to FIG. 26 and FIG. 28, on an example of a method for detecting the access position of a finger Fg using the input device A30. FIG. 28A is a histogram illustrating the detection value of each electrode y.

When no operation is being performed by the user, there exists virtually no capacitance between the electrodes y and the finger Fg. The user brings then the finger Fg close to the front face 4a of the transmitting plate 4, as illustrated in FIG. 26, whereupon the distance between electrodes y and the finger Fg becomes shorter. This generates capacitance between the finger Fg and the electrodes y. The detection value is greater for the electrode whose distance to the finger Fg is shorter, from among the electrodes y. In FIG. 28A the detection value of electrode y4 is greatest among the electrodes y.

Next, the IC chip 72 calculates the weighted average of the detection values of two electrodes, i.e. electrode y3 and electrode y5, adjacent to electrode y4. The access position of the finger Fg in direction Y can be detected more accurately as a result.

Next, the IC chip 72 detects the position of the finger Fg in direction X on the basis of a sum T1 of the detection values of all the slider electrodes 15 and a sum T2 of the detection values of all the slider electrodes 16. FIG. 28B lists the values of T1 and T2. As illustrated in the figure, the ratio of the sum T1 of the detection values of the slider electrodes 15 to the sum T2 of the detection values of the slider electrodes 16 is 1:3. As a result, the position of the finger Fg in direction X can be determined to be 0.75.

The IC chip 72 in the input device A30 can detect thus the access position of the finger Fg in direction Y and direction X.

In the input device A30 as well, the sizes of each electrode y can be made dissimilar, as illustrated in FIG. 27, in accordance with the same method as in the first embodiment and the second embodiment. This allows reducing the sensitivity variability in the electrodes y. The access position of the finger Fg in direction Y can be detected more accurately as a result.

### Fourth Embodiment

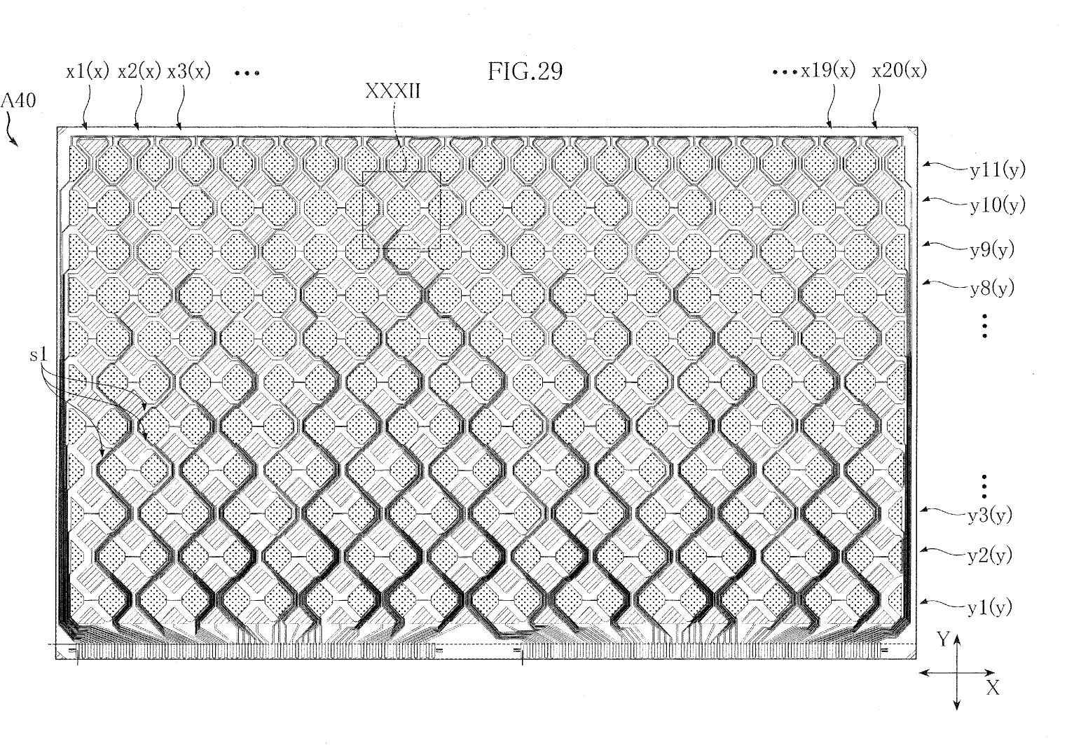

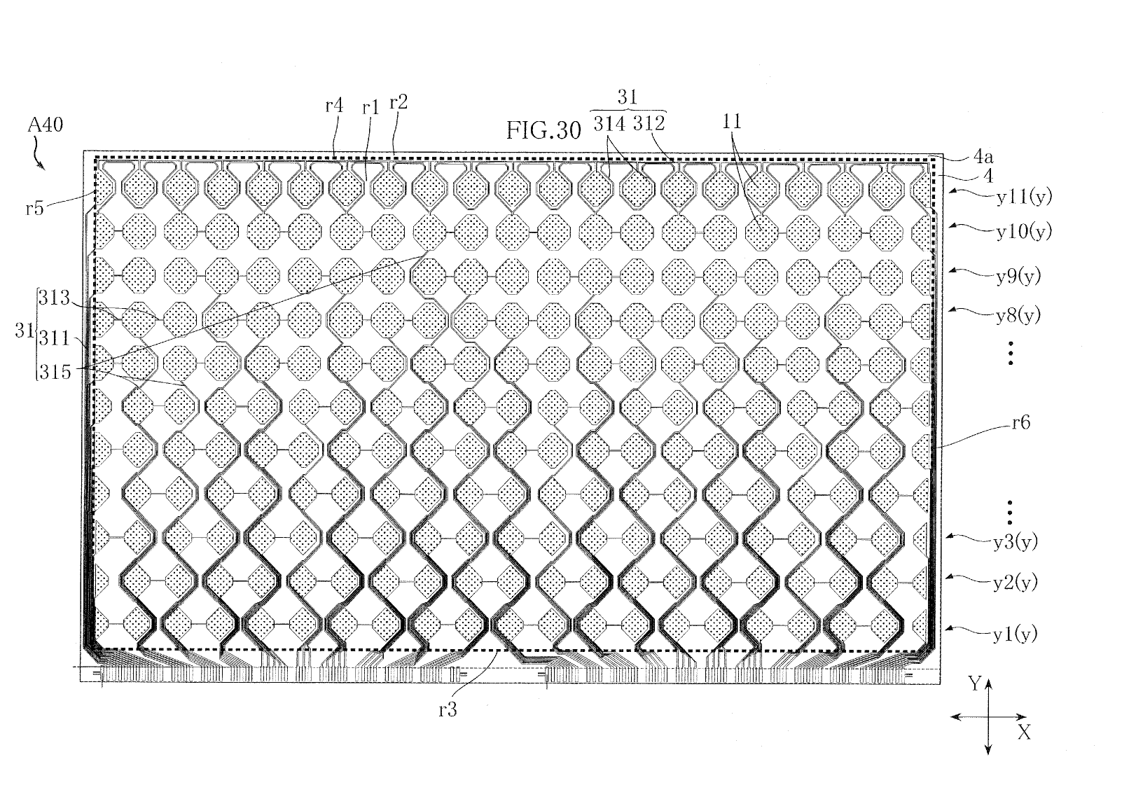

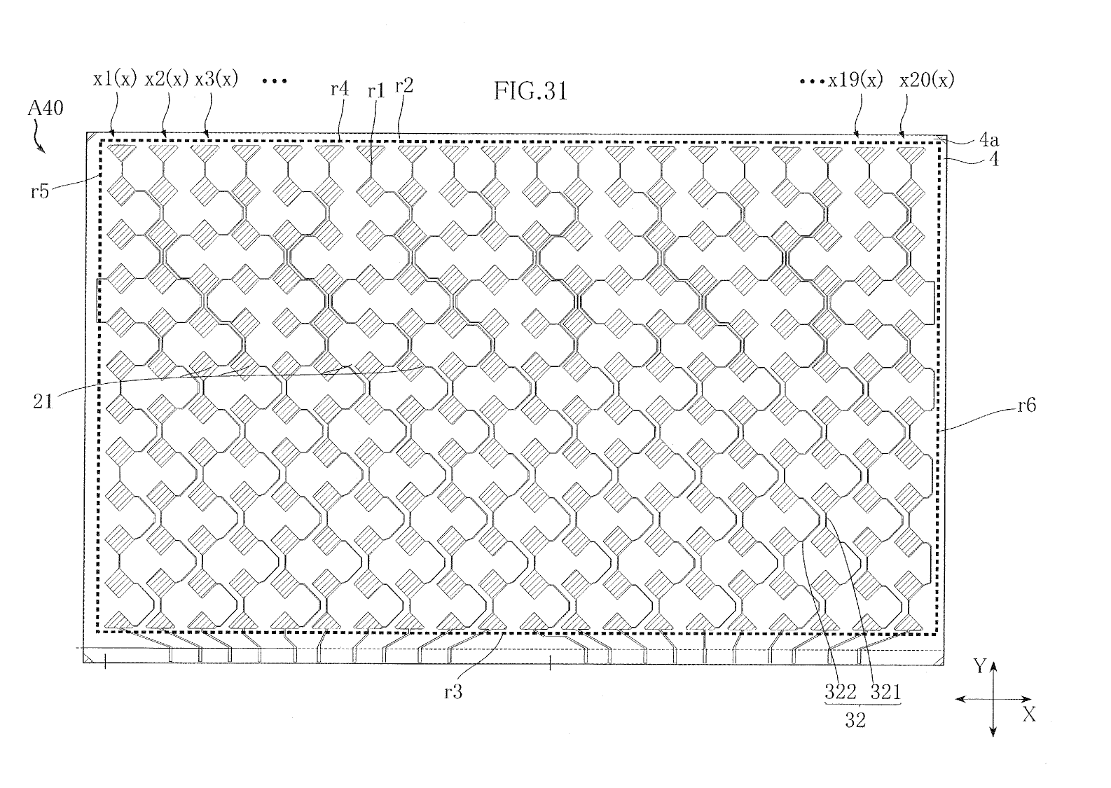

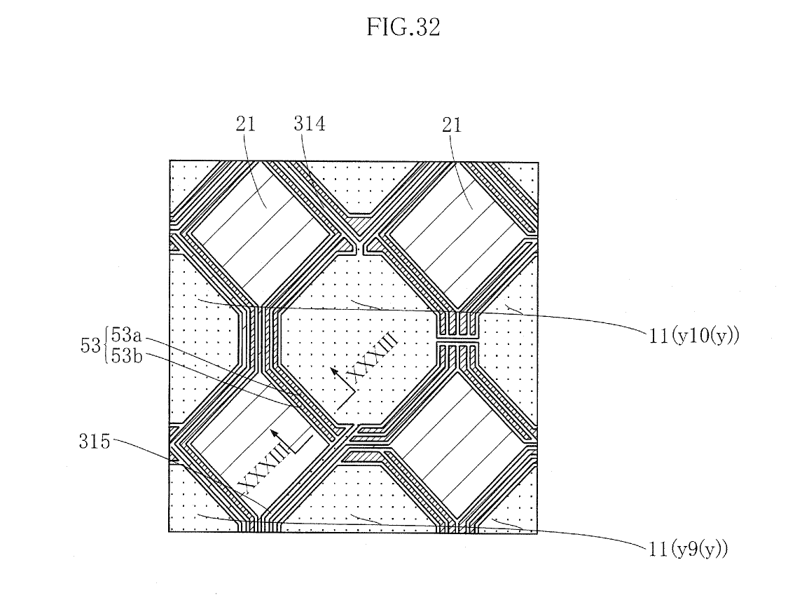

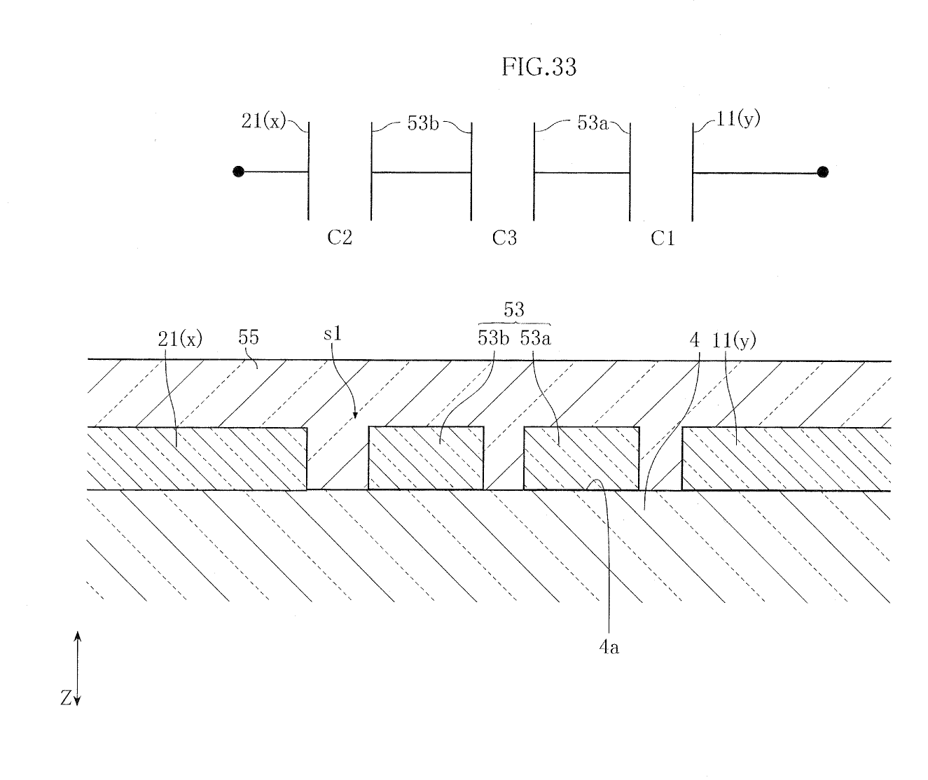

A fourth embodiment of the present invention will be explained with reference to FIG. 29 to FIG. 33. FIG. 29 is a schematic plan-view diagram of an input device according to the present embodiment. FIG. 30 is a schematic plan-view diagram illustrating mainly the configuration of the electrodes y in FIG. 29. FIG. 31 is a schematic plan-view diagram illustrating mainly the configuration of the electrodes x in FIG. 29. FIG. 32 is a partial enlarged diagram of region XXXII in FIG. 29. FIG. 33 is a schematic cross-sectional view of FIG. 32 along line XXXIII; In the figures, elements identical or similar to those of the above embodiment are denoted with the same reference numerals as in the above embodiment.

As compared with the input device A20, the dimensions of the input device A40 are now greater in direction X than in direction Y. Therefore, the number of electrodes x in the input device A40 is greater, and the number of electrodes y smaller, than in the input device A20. The input device A40 has 20 electrodes x, and 11 electrodes y.

The input device A40 comprises a plurality of electrodes x, a plurality of electrodes y, a plurality of wirings 31, 32, a light-transmitting layer 53 (see FIG. 32, FIG. 33, omitted in FIG. 29 to FIG. 31), a coating layer 55 (see FIG. 33, omitted in FIG. 29 to FIG. 32), a transmitting plate 4, a flexible board (see FIG. 12, not shown in the present embodiment), and an IC chip (see FIG. 12, not shown in the present embodiment).

The electrodes x, electrodes y, wirings 32 and transmitting plate 4 have the same basic configuration as those of the input device A20, and hence an explanation thereof will be omitted. In the present embodiment, the surface area of electrodes y7 to y10 is greater than that of other electrodes y.

As illustrated in FIG. 30, the wirings 31 comprise wirings 311 to 315, as in the case of the input device A20. The basic configuration of the wirings is identical to that of the input device A20, and hence a detailed explanation thereof will be omitted. In the present embodiment, unlike in the input device A20, the wirings 315 are also connected to the second electrode y from the top (electrode y10) in FIG. 30, from among the electrodes y. In the input device A20, the wirings 315 are not connected to the second electrode from the top (electrode y13) in FIG. 13, from among the plurality of electrodes y. The electrode elements 11 comprised in electrodes y8, y9 of FIG. 30 are connected, in sets of three electrode elements, to wirings 313.

As illustrated in FIG. 32 and FIG. 33, the light-transmitting layer 53 is formed on the front face 4a of the transmitting plate 4. The light-transmitting layer 53 is formed in gaps s1 that are flanked by the electrode elements 11 and the electrode elements 21. The light-transmitting layer 53 is provided with a view to enhancing visibility. Light that strikes the light-transmitting layer 53 from the transmitting plate 4 passes through the light-transmitting layer 53 and moves on to the coating layer 55. The refractive index of the material that makes up the light-transmitting layer 53 is different from the refractive index of the material that makes up the coating layer 55. The refractive index of the material that makes up the light-transmitting layer 53 is preferably comparable to the refractive index of the material that makes up the electrode elements 11, 21. In the present embodiment, the light-transmitting layer 53 comprises the same material (for instance, ITO, IZO) that makes up the electrode elements 11 and the electrode elements 21. Accordingly, the refractive indices of the light-transmitting layer 53 and the electrode elements 11, 21 are the same. In this case, the light-transmitting layer 53 is formed at the same time that the electrode elements 11, 21 are formed on the front face 4a of the transmitting plate 4. The light-transmitting layer 53 is thus found to comprise a conductive material in a case where the light-transmitting layer 53 uses a material identical to the constituent material of the electrode elements 11 and the electrode elements 21. If the light-transmitting layer 53 comprises a conductive material, the light-transmitting layer 53 must be electrically insulated from the electrode elements 11, 21 that are adjacent to the light-transmitting layer 53. Therefore, a gap is left between the light-transmitting layer 53 and the electrode elements 11, 21 that are adjacent thereto.

As illustrated in FIG. 32 and FIG. 33, the light-transmitting layer 53 of the present embodiment comprises a plurality of line elements 53a, 53b. The line elements 53a, 53b are shaped extending in a direction along the edge of the electrode elements 11 and the electrode elements 21, respectively. The plurality of line elements 53a, 53b are arrayed parallel to each other with a gap in between. The line elements 53a are disposed with a gap between the line elements 53a and the electrode elements 11. The line elements 53b are disposed with a gap between the line elements 53b and the electrode elements 21.

As illustrated in FIG. 32 and FIG. 33, the coating layer 55 covers the electrodes x, y and the light-transmitting layer 53. The coating layer prevents reflection of external light to suppress loss of visibility. The coating layer 55 has also the function of bonding to a transparent panel not shown. The coating layer 55 comprises a light-transmitting transparent insulating material. Examples thereof include, for instance, UV-curable resins. The refractive index of the coating layer 55 is, for instance, about 1.5. The refractive index of the material that makes up the electrodes x, y (electrode elements 11, 21) is, for instance, about 2.0. The refractive index of the material that makes up the transmitting plate 4 is, for instance, about 1.5.

The advantages of the input device A40 are explained below.

In the input device A40, as in the above-described embodiments, the size of the electrodes y is different for each electrode y. This allows reducing the sensitivity variability in the electrodes y. The access position of the finger Fg in direction Y can be detected more accurately as a result.

The input device A40 has an elongate shape with a greater dimension in direction X and a smaller dimension in direction Y. Accordingly, the length of the wirings 314, that electrically connect to one another the electrode elements 11 comprised in electrode y10 is relatively long. The resistance of the wirings 314 connected to the electrode elements 11 comprised in electrode y10 increases in this case. Wirings 315 are also connected to electrode y10 of the input device A40. This allows reducing the resistance, of the wirings that are connected to electrode y10. As a result, the sensitivity of electrode y10 in this input device A40 can be kept not too different from the sensitivity of electrodes y other than electrode y10. The input device A40 is therefore appropriate for suppressing sensitivity variability in the electrodes y.

The number of electrodes y in the landscape-shaped input device A40 is small. Hence, the number of wirings 315 formed in the gaps s1 flanked between the electrode elements 11 and electrode elements 21 at the lowermost part of FIG. 29 is accordingly small. There is no need, therefore, for widening the gaps s1 even if the wirings 315 are connected to the electrode elements 11 comprised in electrode y10. As a result, the wirings 315 can be connected to the electrode elements 11 comprised in electrode y10 without reducing the surface area of the electrode elements 11, 21.

In the input device A40, some of the light coming from the transmitting plate 4 toward the coating layer 55 is reflected at the boundary between the light-transmitting layer 53 and the coating layer 55. Thus, regarding the images to be displayed on the liquid crystal display B, the brightness of regions that are visible on account of light transmitted through the gaps s1 but not the electrode elements 11, 21 can be closer to the brightness of regions that are visible on account of light transmitted through the electrode elements 11, 21. As a result, it becomes less likely for dark and bright regions to occur in the images displayed on the liquid crystal display panel B. That is, the brightness of images can be made uniform upon viewing of images on the liquid crystal display panel B. The above configuration contributes to improving the visibility of the images that are displayed on the liquid crystal display panel B of the input device A40.

The light-transmitting layer 53 of the input device A40 comprises the same material as the material that makes up the electrode elements 11, 21. Accordingly, the refractive index of the material that makes up the light-transmitting layer 53 is identical to the refractive index of the material that makes up the electrode elements 11, 21. In the input device A40, as a result, the transmittance of light coming from the transmitting plate 4 toward the coating layer 55 can be rendered substantially identical both in the case that light passes through the light-transmitting layer 53 and in the case where light passes through the electrode elements 11, 21. As a result, it becomes even less likely for dark and bright regions to occur in the image or the like when viewing the image or the like displayed on the liquid crystal display panel B. That is, the brightness of images or the like can be made yet more uniform upon viewing of images or the like on the liquid crystal display panel B. The above configuration contributes to further improving the visibility of the images or the like that are displayed on the liquid crystal display panel B of the input device A40.

The light-transmitting layer 53 in the input device A40 comprises a plurality of line elements 53a, 53b that are mutually disposed with gaps in between. Such an input device A40 is suitable for reducing the parasitic capacitance between mutually adjacent electrode elements 11 and electrode elements 21. One conceivable reason underlying the above effect is outlined below.

The line elements 53a comprise a conductive material, and are disposed with gaps between them and the electrode elements 11. In the input device A40, therefore, a capacitor C1 (see FIG. 33) is found to be formed by the electrode pair made up by the electrode elements 11 and the line elements 53a. Similarly, the line elements 53b comprise a conductive material, and are disposed with gaps between them and the electrode elements 21. In the input device A40, therefore, a capacitor C2 (see FIG. 33) is found to be formed by the electrode pair made up by the electrode elements 21 and the line elements 53b. In the present embodiment, moreover, the line elements 53a, 53b are mutually disposed with gaps in between. In the input device A40, therefore, a capacitor C3 (see FIG. 33) is found to be formed by the electrode pair made up by the line elements 53a and the line elements 53b.

As illustrated in FIG. 33, the parasitic capacitance between mutually adjacent electrode elements 11 and electrode elements 21 is the combined capacitance of the capacitors C1, C2, C3 connected in series. In the present embodiment, thus, a capacitor C3 is found to be further connected in series between the capacitors C1, C2 that are connected in series. When, unlike the present embodiment, the light-transmitting layer 53 does not comprise line elements 53a, 53b mutually disposed with a gap in between, i.e. when the light-transmitting layer 53 is one single film-like member, the parasitic capacitance between mutually adjacent electrode elements 11 and electrode elements 21 is the combined capacitance of only the capacitors C1, C2 connected in series. In the present embodiment, therefore, the parasitic capacitance between the electrode elements 11 and the electrode elements 21 can be reduced by simply connecting the capacitor C3 in series, vis-à-vis the case where the light-transmitting layer 53 does not comprise the line elements 53a, 53b mutually disposed with a gap in between. This is suitable for reducing the parasitic capacitance between mutually adjacent electrode elements 11 and electrode elements 21 in the input device A40.

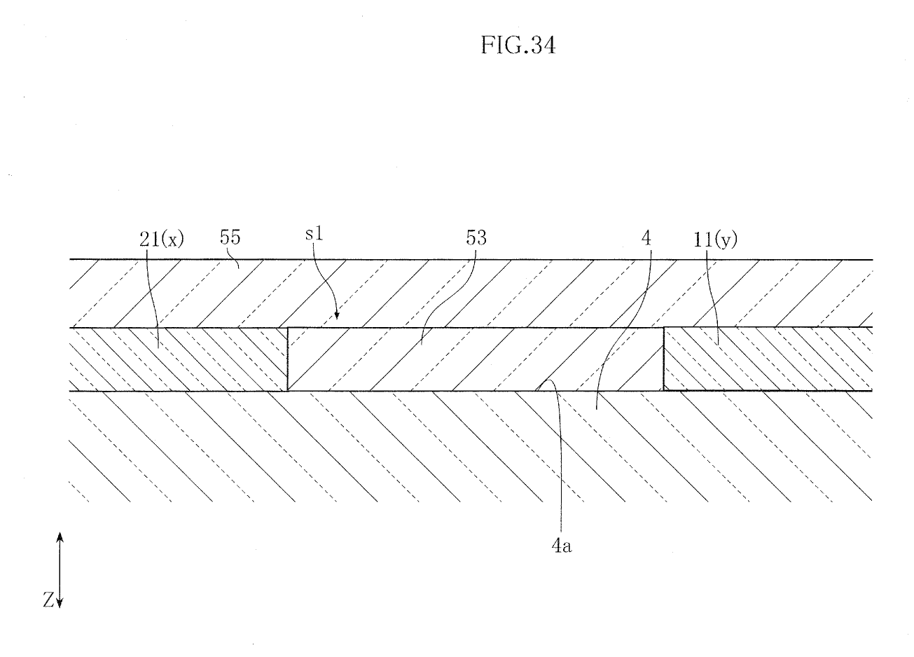

FIG. 34 illustrates a modification of the light-transmitting layer. In the present modification the light-transmitting layer 53 comprises not a conductive material but an insulating resin.

The light-transmitting layer 53 is formed so as to fill up the gaps s1 flanked by the electrode elements 11 and the electrode elements 21. The light-transmitting layer 53 is in contact with the electrode elements 11 and the electrode elements 21. The refractive index of the material that makes up the light-transmitting layer 53 is different from the refractive index of the material that makes up the coating layer 55. Preferably, the refractive index of the material that makes up the light-transmitting layer 53 is comparable to the refractive index of the material that makes up the electrode elements 11, 21. In terms of reducing parasitic capacitance between the electrode elements 11 and the electrode elements 21, the permittivity of the material that makes up the light-transmitting layer is preferably smaller than the permittivity of the material that makes up the coating layer 55.

Also in such a configuration, some of the light coming from the transmitting plate 4 toward the coating layer 55 is reflected at the boundary between the light-transmitting layer 53 and the coating layer 55. Thus, regarding the images to be displayed on the liquid crystal display panel B, the brightness of regions that are visible on account of light that is transmitted through the gaps s1 but not the electrode elements 11, 21 can be closer to the brightness of regions that are visible on account of light transmitted through the electrode elements 11, 21. As a result, it becomes less likely for dark and bright regions to appear in the images displayed on the liquid crystal display panel B. That is, the brightness of images can be made uniform upon viewing of images on the liquid crystal display panel B. The above configuration contributes to improving the visibility of the images or the like that are displayed on the liquid crystal display panel B.

The transmittance of light coming from the transmitting plate 4 toward the coating layer 55 can be rendered substantially the same both in the case that light passes through the light-transmitting layer 53 and in the case where light passes through the electrode elements 11, 21, if the refractive index of the material that makes up the light-transmitting layer 53 and the refractive index of the material that makes up the electrode elements 11, 21 are substantially identical. As a result, it becomes even less likely for dark and bright regions to occur in the image or the like when viewing the image or the like displayed on the liquid crystal display panel B. That is, the brightness of images or the like can be made yet more uniform upon viewing of images or the like on the liquid crystal display panel B. The above configuration contributes to further improving the visibility of the images or the like that are displayed on the liquid crystal display panel B.

The following considerations are found to apply to the first to the fourth embodiments.

(1) The input device need not be used together with the liquid crystal panel B. The electrodes x, y need not necessarily be transparent. The electrodes may comprise a non-transparent metal such as copper or the like.

(2) The input device is not limited to uses in cell phones. The input device may be used in other devices that employ touch panels, such as digital cameras, personal navigation devices, ATMs and the like.

### Fifth Embodiment

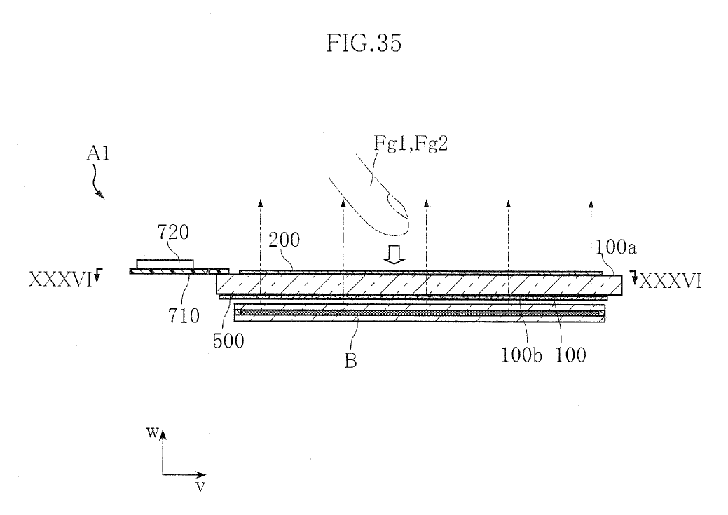

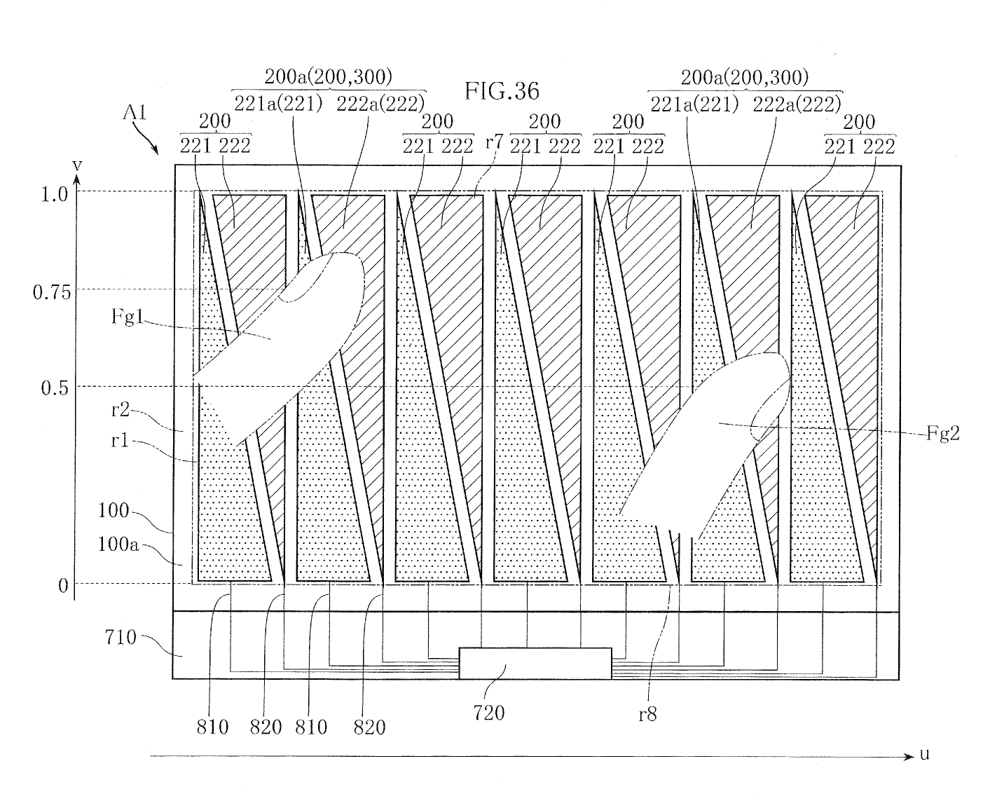

FIG. 35 is a schematic cross-sectional view illustrating an example of an input device according to a fifth embodiment of the present invention. FIG. 36 is a schematic plan-view diagram along line IIIVI-IIIVI of FIG. 35. The input device A1 illustrated in the figures comprises a transmitting plate 100, a plurality of strip-like electrodes 200, wirings 810, 820, a shield layer 500, a flexible board 710 and an IC chip 720. For easier comprehension, the wirings 810, 820 have been omitted in FIG. 35. The shield layer 500 has been omitted in FIG. 36. The input device A1 detects the proximity of fingers Fg1, Fg2, which are conductors, through changes in capacitance. As illustrated in FIG. 35, the input device A1 illustrated in the figures is stacked on a liquid crystal display panel B to constitute thereby a so-called touch panel.

The region demarcated by a double dotted-line rectangle in FIG. 36 corresponds to a detection region r1. The detection region r1 is a region where there is detected the proximity of fingers Fg1, Fg2 that come near the input device A1. The frame-like region outside the detection region r1 of the transmitting plate 100, as viewed from a uv plane, is a non-detection region r2. Ends r7, r8 constitute the boundary between the detection region r1 and the non-detection region r2. Both ends r7, r8 run along direction u.

The transmitting plate 100 is a transparent plate comprising glass, or a single-layer resin body of a transparent resin such as polyethylene terephthalate (PET), polyethylene naphthalate (PEN), polycarbonate (PC) or the like. The transmitting plate 100 has a front face 100a and a rear face 100b.

As illustrated in FIG. 35, the plurality of strip-like electrodes 200 is formed on the front face 100a of the transmitting plate 100. As illustrated in FIG. 36, the strip-like electrodes 200 extend in direction v and are arranged side by side in direction u. The strip-like electrodes 200 are obtained by patterning a thin film comprising a transparent conductive material such as ITO, IZO or the like. The strip-like electrodes 200 comprise detection electrodes 221, 222.

The detection electrodes 221 have a wedge-shaped end pointing in direction v. That is, the detection electrodes 221 extend in such a manner that the size thereof in direction u decreases as proceeding in direction v. The detection electrodes 222 have also a wedge-shaped end pointing in the opposite direction to direction v. That is, the detection electrodes 222 extend in such a manner that the size thereof in direction u decreases as proceeding in the opposite direction to direction v. The detection electrodes 221 and the detection electrodes 222 are disposed alternately in direction u. Thus, the detection electrodes 221 are flanked by the detection electrodes 222, except for the detection electrode 221 that is disposed at one end in direction u. The detection electrodes 222 are flanked by the detection electrodes 221, except for the detection electrode 222 that is disposed at one end in direction u.

As illustrated in FIG. 36, the wirings 810, 820 are formed on the front face 100a of the transmitting plate 100. The wirings 810, 820 are obtained by patterning a thin film comprising a transparent conductive material such as ITO, IZO or the like. The wirings 810, 820 may comprise the same material as that of the detection electrodes 221, 222. In this case, the wirings 810, 820 and the detection electrodes 221, 222 can be formed at the same time on the transmitting plate 100. This allows simplifying the manufacturing process of the input device A1. The wirings 810, 820 may comprise a low-resistance metal such as Cu, Al or the like. The wirings 810 are connected to the detection electrodes 221. The wirings 810 extend from the wide portions of the detection electrodes 221 in a direction opposite to direction v, and reach the non-detection region r2 on the side of end r8. The wirings 820 are connected to the leading ends of the detection electrodes 222. The wirings 820 extend from the leading ends of the detection electrodes 222 in a direction opposite to direction v. As in the case of the wirings 810, the wirings 820 reach the non-detection region r2 on the side of end r8.

The shield layer 500 is formed on the rear face 100b of the transmitting plate 100. The shield layer 500 comprises a transparent conductive material such as ITO, IZO or the like. The shield layer 500 is covered by a rear protective layer (not shown). The shield layer 500 is an effective countermeasure against noise from the liquid crystal panel B. The shield layer 500 may also be absent from the rear face 100b of the transmitting plate 100. The effects elicited when the shield layer 500 is present can also be obtained in this case, except for the effect against noise from the liquid crystal panel B.

The flexible board 710 is provided at an end of the transmitting plate 100 in direction v. The IC chip 720 is mounted on the flexible board 710. The IC chip 720 is connected to the detection electrodes 221, 222 by way of the wirings 810, 820 and the flexible board 710. The IC chip 720 is configured so as to be capable of detecting independently, at all times, changes in capacitance between the finger Fg1 or finger Fg2 and the detection electrodes 221 or detection electrodes 222. In COG (Chip On Glass), the IC chip 720 is mounted on the transmitting plate 100.

As illustrated in FIG. 35, the liquid crystal panel B comprises, for instance, a transparent substrate and a TFT substrate opposing each other, with a liquid crystal layer sandwiched in between. The liquid crystal panel B has the function of displaying, for instance, operation menu screens or images for operating a cell phone. The images displayed on the liquid crystal panel B can be viewed through the input device A1. The display surface of the liquid crystal panel B is configured so as to overlap the detection region r1, as viewed from direction w.

An explanation follows next, with reference to FIG. 35 to FIG. 38, on an example of a method for detecting the access position of the finger Fg1 and the finger Fg2 using the input device A1. FIG. 37 is a histogram illustrating capacitance values of the strip-like electrodes 200. The capacitance values of the strip-like electrodes 200 disposed first, second, third . . . from the left in FIG. 36 correspond respectively to the first, second, third . . . capacitance values from the left in FIG. 37.

Firstly, a mail creation screen, an internet content screen or the like of the cell phone is displayed on the cell liquid crystal display panel B. When no operation is being performed by the user, there exists virtually no capacitance between the strip-like electrodes 200 and the finger Fg1 or between the strip-like electrodes 200 and the finger Fg2. As illustrated in FIG. 35 and FIG. 36, the user brings then the finger Fg1 and finger Fg2 close to the front face 100a of the transmitting plate 100. The distance between the strip-like electrodes 200 and the fingers Fg1, Fg2 decreases accordingly. This generates capacitance between the finger Fg1 and the strip-like electrodes 200 and between the finger Fg2 and the strip-like electrodes 200. The capacitance is greater for the strip-like electrode whose distance to the finger Fg1 or finger Fg2 is shorter, from among the strip-like electrodes 200. In FIG. 36 a strip-like electrode 200a denotes a strip-like electrode 200 to which the finger Fg1 comes near. In FIG. 36 a strip-like electrode 200b denotes a strip-like electrode 200 to which the finger Fg2 comes near.

As illustrated in FIG. 37, the capacitance values of the strip-like electrodes 200a, 200b are the first and second greatest among the capacitance values of the strip-like electrodes 200. The IC chip 720 determines that the strip-like electrodes 200a, 200b are the strip-like electrodes 200 to which the finger Fg1 or the finger Fg2 comes near. Next there is calculated a weighted average of the capacitance value of the strip-like electrode 200a and of the two strip-like electrodes 200 that are adjacent to the strip-like electrode 200a. The access position of the finger Fg1 in direction u can be detected more accurately as a result. Likewise, there is calculated a weighted average of the capacitance value of the strip-like electrode 200b and of the two strip-like electrodes 200 that are adjacent to the strip-like electrode 200b. The access position of the finger Fg2 in direction u can be detected more accurately as a result. In the present embodiment, the strip-like electrode 200a is referred to as electrode group 300. The strip-like electrode 200b is referred to as electrode group 400.

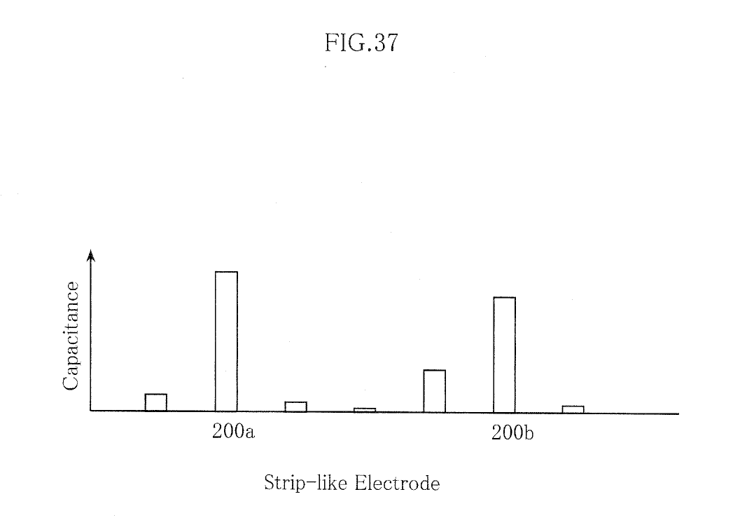

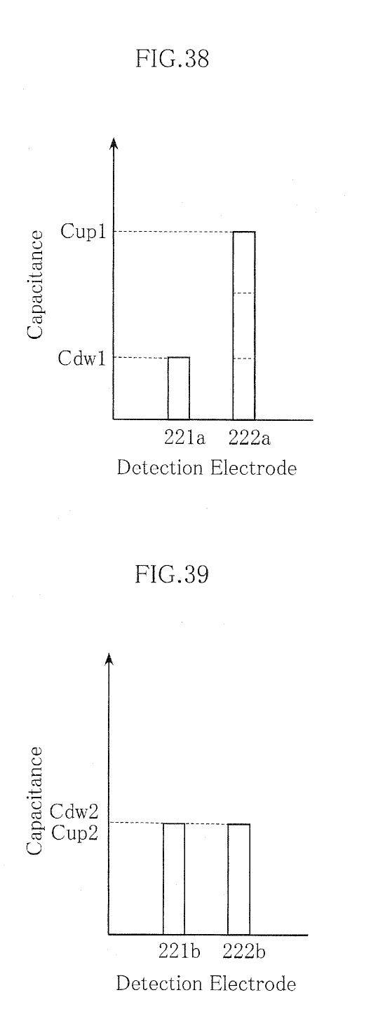

The position of the finger Fg1 in direction v is detected next using the detection electrodes 221, 222 comprised in the strip-like electrode 200a (i.e. the electrode group 300) to which the finger Fg1 comes near. In FIG. 36, detection electrodes 221a, 222a denote respectively the detection electrodes 221, 222 comprised in the strip-like electrode 200a. FIG. 38 illustrates the capacitance values of the detection electrodes 221a, 222a. As illustrated in FIG. 38, Cdw1 is the capacitance value of the detection electrode 221a, and Cup1 the capacitance value of the detection electrode 222a. Next, the IC chip 720 detects the position of the finger Fg1 in direction v by working out the ratio between Cdw1 and Cup1. In the present embodiment, Cdw1:Cup1=1:3, and hence the position of the finger Fg1 in direction v can be determined to be 0.75.

The position of the finger Fg2 in direction v is detected next using the detection electrodes 221, 222 comprised in the strip-like electrode 200b (i.e. the electrode group 400) to which the finger Fg2 comes near. The method for detecting the position of the finger Fg2 in direction v is the same as the above-described method for detecting the position of the finger Fg1 in direction v. In FIG. 36, detection electrodes 221b, 222b denote respectively the detection electrodes 221, 222 comprised in the strip-like electrode 200b. FIG. 39 illustrates the capacitance values of the detection electrodes 221b, 222b. As illustrated in FIG. 39, Cdw2 is the capacitance value of the detection electrode 221b, and Cup2 the capacitance value of the detection electrode 222b. In the present embodiment, Cdw2:Cup2=1:1, and hence the position of the finger Fg2 in direction v can be determined to be 0.5.

In the input device A1, thus, the IC chip 720 can detect the access position of the fingers Fg1, Fg2 in direction u and direction v as described above.

The advantages of the input device A1 of the present embodiment are explained below.

Among all the strip-like electrodes 200, only one electrode 200 belongs to the electrode group 300. Thus, as described above, in most cases, the strip-like electrodes 200 that the finger Fg2 is approaching are not included in the electrode group 300. On the other hand, in the input device A1, the detection electrodes 221, 222 used for detecting the access position of the finger Fg1 in direction v belong to the electrode group 300. Therefore, the IC chip 720 can detect the access position of the finger Fg1 in direction v while suppressing the influence exerted by the capacitance that can be generated between the finger Fg2 and the detection electrodes 221, 222. In this manner, the IC chip 720 can detect accurately the access position of the finger Fg1 in direction v, even when the finger Fg2, in addition to the finger Fg1, comes near the strip-like electrodes 200. At the same time, the input device A1 can detect accurately the access position of the finger Fg2 in direction v. Therefore, the input device A1 can accurately detect two points, i.e. the access positions of two fingers Fg1 and Fg2.

As noted above, only one strip-like electrode 200 (200a) belongs to the electrode group 300. Thus, as compared with a case in which a plurality of strip-like electrodes 200 belong to the electrode group 300, the finger Fg2 less often comes near a strip-like electrode 200 (200a) that belongs to the electrode group 300. Accordingly, it can be expected that the influence exerted by the capacitance generated between the finger Fg2 and the detection electrodes 221, 222 is further reduced in detecting the access position of the finger Fg1 in direction v. Likewise, it can be expected that the influence exerted by the capacitance generated between the finger Fg1 and the detection electrodes 221, 222 is further reduced in detecting the access position of the finger Fg2 in direction v.

To detect the access position of the fingers Fg1, Fg2 in direction u there is calculated not the weighted average of the capacitance of all the strip-like electrodes 200, but that of three strip-like electrodes 200. This is suitable for detecting accurately the access positions of two conductors in the form of fingers Fg1, Fg2.

The wirings 810, 820 extend from the detection electrodes 221, 222 toward the non-detection region r2, on the side of end r8. In the input device A1, therefore, there is no need for forming a lead-around wiring in the non-detection region r2 on the side of end r7. The active area of the transmitting plate 100 can be enlarged as a result.

### Sixth Embodiment

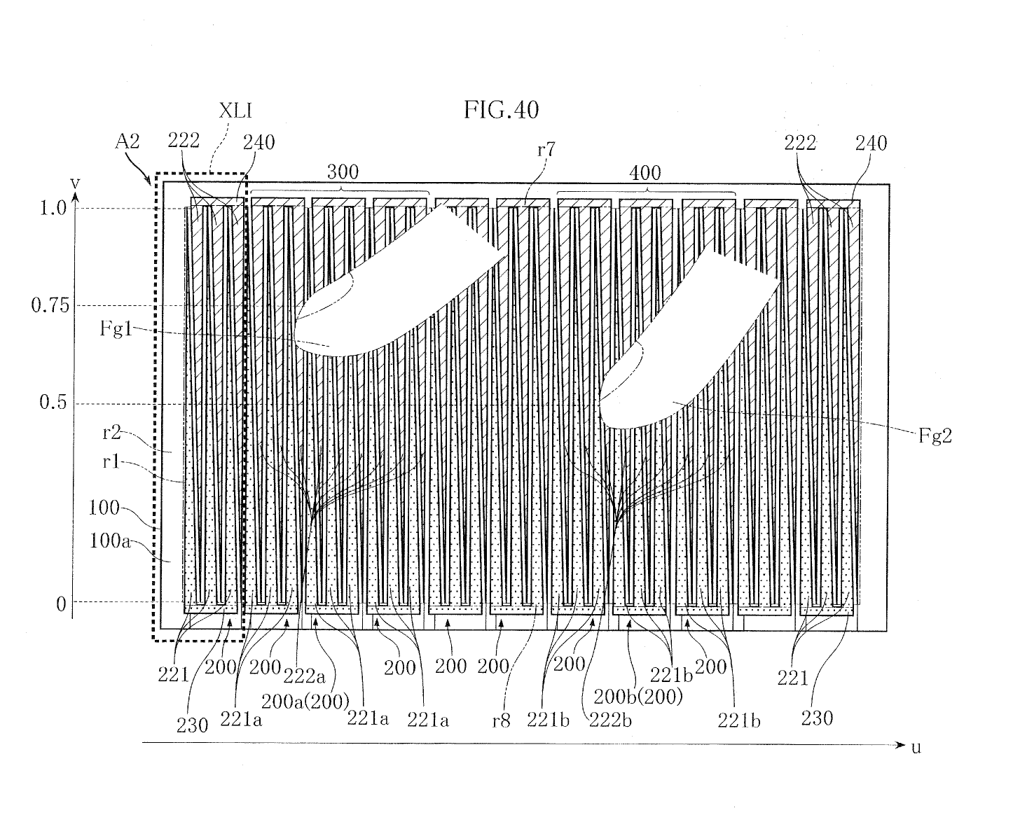

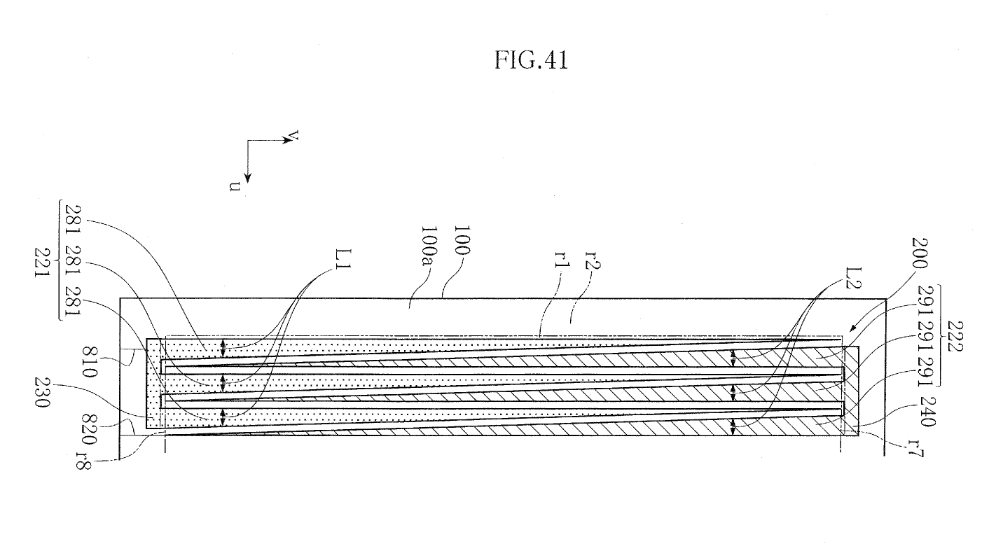

FIG. 40 to FIG. 44 illustrate a sixth embodiment of the present invention. In the figures, elements identical or similar to those of the fifth embodiment are denoted with the same reference numerals as in the fifth embodiment. FIG. 40 is a schematic plan-view diagram illustrating an example of an input device according to the present embodiment of the invention. FIG. 41 is an enlarged diagram of region XLI in FIG. 40. FIG. 41 illustrates one strip-like electrode 200. The input device A2 of the present embodiment differs from the input device A1 of the fifth embodiment in that now the strip-like electrodes 200 comprise comb-shaped electrodes that face each other, and in that a plurality of strip-like electrodes 200 belong to the electrode groups 300, 400. The above features are explained in detail below.

As illustrated in FIG. 40 and FIG. 41, each strip-like electrode 200 comprises detection electrodes 221, 222 and connection electrodes 230, 240. As illustrated in FIG. 41, each detection electrode 221 comprises three wedge-shaped electrodes 281. The respective wedge-shaped electrodes 281 extend in direction v in such a manner that the size L1 thereof in direction u decreases as proceeding in direction v. Hence, the detection electrode 221 extends in direction v in such a manner that the size thereof (summation of sizes L1) in direction u decreases as proceeding in direction v.

A connection electrode 230 connects to one another the wide portions of the wedge-shaped electrodes 281. The connection electrode 230 is formed in the non-detection region r2. A wiring 810 is connected to the connection electrode 230. The wirings 810 are formed in the non-detection region r2, on the side of end r8.

As illustrated in FIG. 41, each detection electrode 222 comprises three wedge-shaped electrodes 291. The respective wedge-shaped electrodes 291 extend in the direction opposite to direction v in such a manner that the size L2 thereof in direction u decreases as proceeding in the opposite direction. Hence, the detection electrode 222 extends in the direction opposite to direction v in such a manner that the size thereof (summation of sizes L2) in direction u decreases as proceeding in the opposite direction.

A connection electrode 240 connects to one another the wide portions of the wedge-shaped electrodes 291. The connection electrode 240 is formed in the non-detection region r2. A wiring 820 is connected to the leading end of a wedge-shaped electrode 291. Like the wirings 810, the wirings 820 are formed therefore in the non-detection region r2, on the side of end r8.

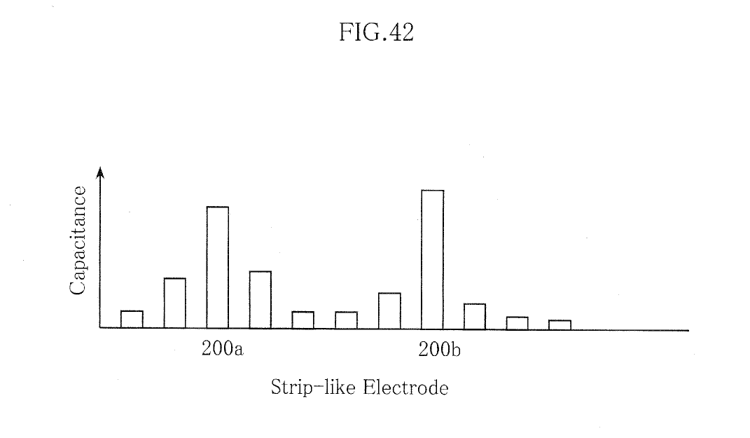

An explanation follows next, with reference to FIG. 40 and FIG. 42 to FIG. 44, on an example of a method for detecting the access position of fingers Fg1 and Fg2 using the input device A2. FIG. 42 is a histogram illustrating the capacitance values of each strip-like electrode 200. The capacitance values of the strip-like electrodes 200 disposed first, second, third . . . from the left in FIG. 40 correspond respectively to the first, second, third . . . capacitance values from the left in FIG. 42.

The access position of the fingers Fg1 and Fg2 in direction u is detected in the same way as in the fifth embodiment. Specifically, there is specified a strip-like electrode 200a close to the finger Fg1, and a strip-like electrode 200b close to the finger Fg2, on the basis of the histogram illustrated in FIG. 42. Then there is calculated the weighted average of the capacitance value of the strip-like electrode 200a or the strip-like electrode 200b, and of two strip-like electrodes 200 that surround the foregoing. The access position of the fingers Fg1, Fg2 in direction u is detected as a result.

An explanation follows next on the method for detecting the access position of the finger Fg1 in direction v.

In the present embodiment, an electrode group 300 denotes three strip-like electrodes 200, namely the strip-like electrode 200a and two strip-like electrodes 200 adjacent to the strip-like electrode 200a as illustrated in FIG. 40. Three detection electrodes 222 and three detection electrodes 221 belonging to the electrode group 300 are used for detecting the access position of the finger Fg1 in direction v.

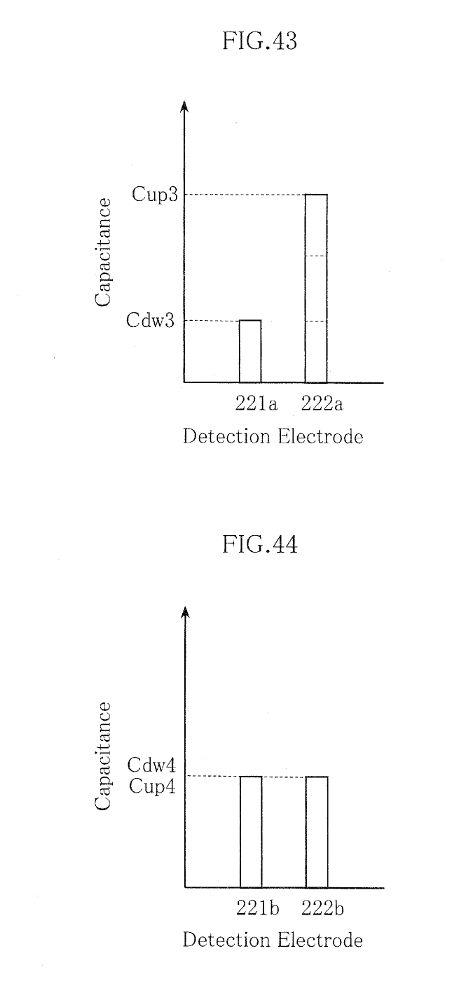

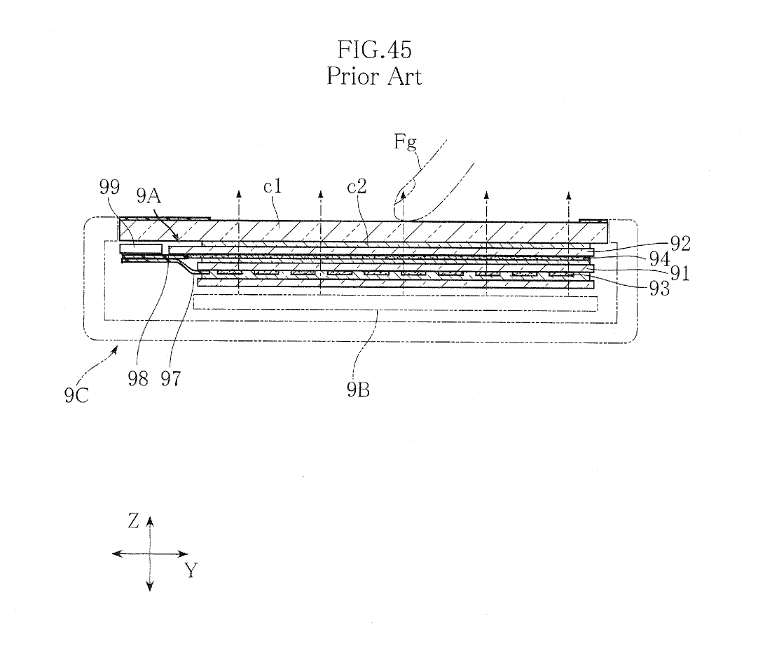

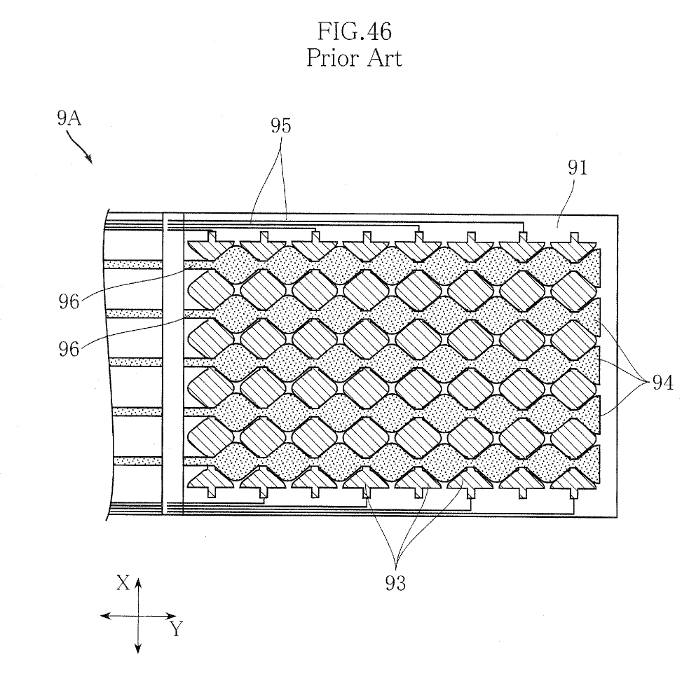

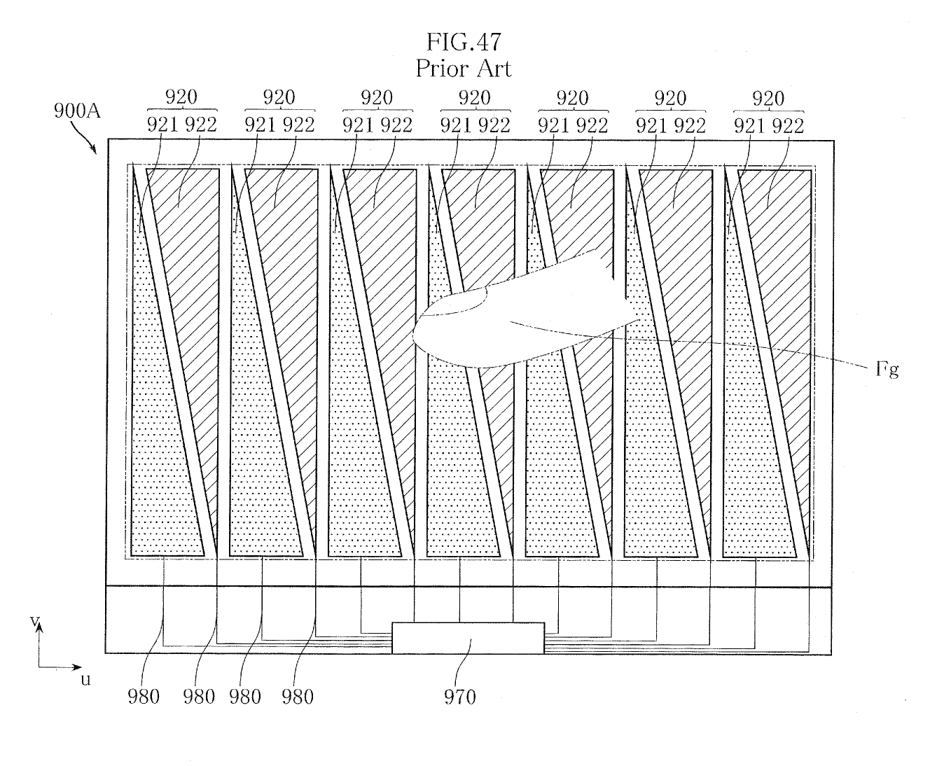

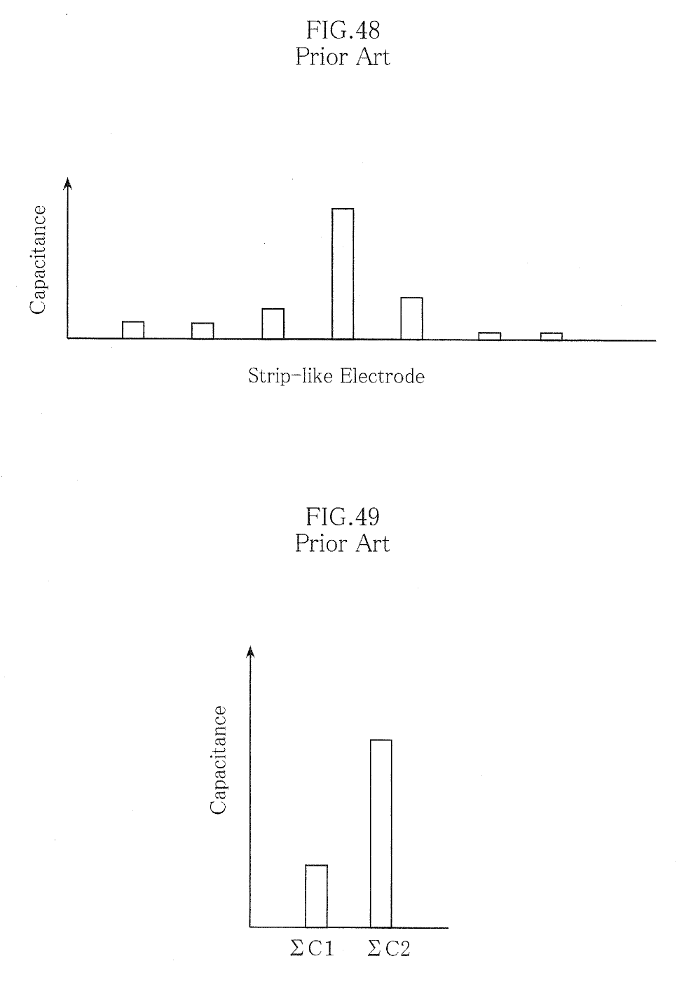

In FIG. 40, detection electrodes 221a, 222a denote detection electrodes 221, 222 comprised in the electrode group 300. FIG. 43 illustrates the capacitance values of the detection electrodes 221a, 222a. As illustrated in FIG. 43, Cdw3 is the summation of the capacitance values of the three detection electrodes 221a. Cup3 is the summation of the capacitance values of the three detection electrodes 222a. The IC chip 720 detects the position of the finger Fg1 in direction v by working out the ratio between Cdw3 and Cup3. In the present embodiment, Cdw3:Cup3=1:3, and hence the position of the finger Fg1 in direction v can be determined to be 0.75.

An explanation follows next on the method for detecting the access position of the finger Fg2 in direction v. This method is identical to the above-described method for detecting access position of the finger Fg1 in direction v.

In the present embodiment, an electrode group 400 denotes three strip-like electrodes 200, namely a strip-like electrode 200b and two strip-like electrodes 200 adjacent to the strip-like electrode 200b. Three detection electrodes 222 and three detection electrodes 221 belonging to the electrode group 400 are used for detecting the access position of the finger Fg2 in direction v.

In FIG. 40, detection electrodes 221b, 222b denote detection electrodes 221, 222 belonging to the strip-like electrode 200b. FIG. 44 illustrates the capacitance values of the detection electrodes 221b, 222b. As illustrated in FIG. 44, Cdw4 is the summation of the capacitance values of the three detection electrodes 221b. Cup4 is the summation of the capacitance values of the three detection electrodes 222b. In the present embodiment, Cdw4:Cup4=1:1, and hence the position of the finger Fg2 in direction v can be determined to be 0.5.

The advantages of the input device A2 of the present embodiment are explained below.

In the present embodiment, only three electrodes of all the strip-like electrodes 200 belong to the electrode group 300. Thus, as described above, in most cases, the strip-like electrodes 200 near the finger Fg2 are not included in the electrode group 300. In the input device A2, the detection electrodes 221a, 222a used for detecting the access position of the finger Fg1 in direction v belong to the electrode group 300. Therefore, the IC chip 720 can detect the access position of the finger Fg1 in direction v while suppressing the influence exerted by the capacitance that can be generated between the finger Fg2 and the detection electrodes 221a, 222a. Accordingly, the IC chip 720 can detect accurately the access position of the finger Fg1 in direction v even when not only the finger Fg1 but also the finger Fg2 come near the strip-like electrodes 200. Likewise, the input device A2 can detect accurately the access position of the finger Fg2 in direction v. As a result, the input device A2 allows detecting more accurately two detection points, i.e. the access positions of the fingers Fg1, Fg2.

In the input device A2, the pitch of the wedge-shaped electrodes 281, 291 in direction u can be modified by increasing or decreasing the number of wedge-shaped electrodes 281 comprised in one detection electrode 221 and the number of wedge-shaped electrode 291 comprised in one detection electrode 222, without increasing or decreasing the number of wirings 810, 820. The access position of the fingers Fg1 and Fg2 in direction v can be detected with the smallest possible error by reducing the pitch between the wedge-shaped electrodes 281, 291 in direction u, without increasing or decreasing the number of wirings 810, 820. As a result, the detection position of the finger Fg1 or the finger Fg2 can be prevented from following an undulating trajectory in direction v when the finger Fg1 or the finger Fg2 slides along direction u.

In the present embodiment, both wirings 810, 820 extend toward the non-detection region r2 on the side of end r8. As a result, there is no need for forming lead-around wirings, connected to the detection electrodes 221 or the detection electrodes 222, in the non-detection region r2, on the side of end r7. The active area of the transmitting plate 100 can be enlarged as a result.

The following considerations are found to apply to the fifth and the sixth embodiments.

(1) In the above embodiments, the electrode groups 300, 400 have been depicted based on examples in which each group comprises one or three strip-like electrodes 200, but needless to say the present invention is not limited thereto. The number of strip-like electrodes 200 comprised in the electrode group 300 and the number of strip-like electrodes 200 comprised in the electrode group 400 may be different.

(2) The above embodiments illustrate input devices used for two-point detection of fingers Fg1, Fg2, but the input devices may also be used as input devices for one-point detection.

(3) In the embodiments illustrated above, the wirings 820 are connected to the leading ends of the detection electrodes 222 (FIG. 36), and to the leading ends of the wedge-shaped electrodes 291 (FIG. 41). However, the wirings 820 may be connected to the detection electrodes 222 at a portion further to the interior of detection region r1 than the leading end.

(4) The input device according to the present invention need not be used together with the liquid crystal panel B. Also, the strip-like electrodes need not be necessarily transparent, and may comprise a non-transparent metal such as copper.

(5) The input devices are not limited to being used in cell phones, and may be used for instance in other devices that employ touch panels, such as digital cameras, personal navigation devices, ATMs and the like.

1. A capacitance type input device, comprising:
a plurality of first-direction detection electrodes arranged side by side in a first direction, each extending in a second direction different from the first direction; and
a controller for detecting an access position of a conductor in the first direction, the detecting being based on a change in capacitance generated between the conductor and the respective first-direction detection electrodes,
wherein the plurality of first-direction detection electrodes include at least one low-sensitivity electrode and at least one high-sensitivity electrode, the low-sensitivity electrode having a surface area greater than a surface area of the high-sensitivity electrode,
wherein when compared by a same size, the low-sensitivity electrode has a lower sensitivity than the high-sensitivity electrode.

2. The capacitance type input device according to claim 1, further comprising:
a substrate on which the plurality of first-direction detection electrodes are formed; and
a plurality of wirings formed on the substrate and extending from an end of the substrate to be connected to the plurality of first-direction detection electrodes, respectively,
wherein the plurality of wirings formed on the substrate include a first wiring connected to the low-sensitivity electrode and a second wiring connected to the high-sensitivity electrode, the first wiring being greater in length than the second wiring.

3. The capacitance type input device according to claim 1, further comprising a plurality of second-direction detection electrodes arranged side by side in the second direction and each extending in the first direction,
wherein each of the first-direction detection electrodes includes a plurality of first electrode elements arranged along the second direction,
wherein each of the second-direction detection electrodes includes a plurality of second electrode elements arranged along the first direction.

4. The capacitance type input device according to claim 3, wherein one of the first electrode elements included in the low-sensitivity electrode has a greater surface area than a surface area of any one of the first electrode elements included in the high-sensitivity electrode.

5. The capacitance type input device according to claim 1, further comprising:
a plurality of second-direction detection electrodes arranged side by side in the second direction and each extending in the first direction; and
a substrate including a flat first face on which both the plurality of first-direction detection electrodes and the plurality of second-direction detection electrodes are formed.

6. The capacitance type input device according to claim 5, wherein each of the first-direction detection electrodes includes a plurality of first electrode elements arranged along the second direction,
wherein each of the second-direction detection electrodes includes a plurality of second electrode elements arranged along the first direction.

7. The capacitance type input device according to claim 6, further comprising a plurality of link wirings each of which is electrically connected to one of the plurality of first electrode elements and formed in a gap flanked by adjacent first and second electrode elements.

8. The capacitance type input device according to claim 7, wherein each of the link wirings extends to a non-detection region of the substrate outside a detection region for detecting access of the conductor.

9. The capacitance type input device according to claim 8, wherein the plurality of link wirings include a first link wiring and a second link wiring that extend from two first electrode elements, respectively, that are spaced from each other in the first direction, the first link wiring extending toward one side of the first direction, the second link wiring extending toward an opposite side of the first direction.

10. The capacitance type input device according to claim 9, wherein each of the first and the second link wirings connected to one of the two first electrode elements spaced in the first direction extends from said one of the two first electrode elements in a direction going away from the other of the two first electrode elements.

11. The capacitance type input device according to claim 7, further comprising a first connection wiring that connects to two first electrode elements adjacent in the second direction among the plurality of first electrode elements, the first connection wiring being formed in a gap flanked by the two first electrode elements,
wherein one of the plurality of link wirings is connected to the two first electrode elements or the first connection wiring.

12. The capacitance type input device according to claim 11, further comprising a second connection wiring that connects to two first electrode elements that flank the first connection wiring among the plurality of first electrode elements,
wherein the second connection wiring is disposed so as to surround a first electrode element at one end of first electrode elements to which the first connection wiring is connected.

13. The capacitance type input device according to claim 11, wherein the two first electrode elements spaced apart from each other along the first direction are mutually adjacent, and one of the two first electrode elements is included in one first-direction detection electrode disposed at one end in the first direction among the plurality of first-direction detection electrodes.

14. The capacitance type input device according to claim 7, wherein part of the link wirings constitutes a multilayer substrate,
wherein the link wirings are connected to one another at the multilayer substrate.

15. The capacitance type input device according to claim 6, further comprising: a light-transmitting layer formed in a gap flanked by adjacent first and second electrode elements; and
a coating layer that covers the plurality of first electrode elements, the plurality of second electrode elements and the light-transmitting layer.

16. The capacitance type: input device according to claim 15, wherein a refractive index of a material that makes up the light-transmitting layer is different from a refractive index of a material that makes up the coating layer.

17. The capacitance type input device according to claim 15, wherein a material that makes up the light-transmitting layer is identical to a material that makes up the first electrode elements or the second electrode elements.

18. The capacitance type input device according to claim 17, wherein the light-transmitting layer comprises a plurality of line elements spaced apart from each other.

19. The capacitance type input device according to claim 15, wherein the light-transmitting layer is made of an insulating resin.

20. The capacitance type input device according to claim 1, wherein each of the first-direction detection electrodes comprises: a first slider electrode that extends toward one side of the second direction in such a manner that the size thereof in the first direction decreases toward the one side of the second direction; and a second slider electrode that extends toward the other side of the second direction in such a manner that the size thereof in the first direction decreases toward the other side of the second direction;
wherein the controller detects an access position of the conductor in the second direction, based on a relationship between capacitance between the conductor and the first slider electrodes and capacitance between the conductor and the second slider electrodes.

21. A capacitance type input device, comprising:
a plurality of strip-like electrodes arranged side by side in a first direction and each extending in a second direction different from the first direction; and a controller;
wherein each of the strip-like electrodes comprises a first detection electrode and a second detection electrode, the first detection electrode extending in the second direction in a manner such that the size thereof in the first direction decreases as proceeding in the second direction, the second detection electrode extending in an opposite direction to the second direction in a manner such that the size thereof in the first direction decreases as proceeding in the opposite direction to the second direction,
wherein the controller is configured to:
specify a first electrode group to which only some of the plurality of strip-like electrodes belong, and to which strip-like electrodes which a first conductor approaches belong; and
detect an access position of the first conductor in the second direction, based on a relationship between capacitance between the first conductor and the first detection electrodes belonging to the first electrode group and capacitance between the first conductor and the second detection electrodes belonging to the first electrode group.

22. The capacitance type input device according to claim 21, wherein only one strip-like electrode of the plurality of strip-like electrodes belongs to the first electrode group.

23. The capacitance type input device according to claim 21, wherein at least two mutually adjacent strip-like electrodes belong to the first electrode group.

24. The capacitance type input device according to claim 21, wherein the controller calculates a weighted average using, as weighting, a change in capacitance between the first conductor and each of at least two mutually adjacent strip-like electrodes, and detects an access position of the first conductor in the first direction.

25. The capacitance type input device according to claim 21,
wherein the controller is configured to:
specify a second electrode group to which only some of the plurality of strip-like electrodes belongs, and to which strip-like electrodes which a second conductor different from the first conductor approaches belong; and
detect an access position of the second conductor in the second direction, based on a relationship between capacitance between the second conductor and the first detection electrodes belonging to the second electrode group and capacitance between the second conductor and the second detection electrodes belonging to the second electrode group.

26. The capacitance type input device according to claim 25, wherein only one strip-like electrode of the plurality of strip-like electrodes belongs to the second electrode group.

27. The capacitance type input device according to claim 25, wherein at least two mutually adjacent strip-like electrodes belong to the second electrode group.

28. The capacitance type input device according to claim 25, wherein the controller calculates a weighted average using, as weighting, a change in capacitance between the second conductor and each of at least two mutually adjacent strip-like electrodes, and detects an access position of the second conductor in the first direction.

29. The capacitance type input device according to claim 21, wherein the plurality of first detection electrodes and the plurality of second detection electrodes are wedge-shaped, each of the first detection electrodes is flanked by two of the plurality of second detection electrodes, and each of the second detection electrodes is flanked by two of the plurality of first detection electrodes.

30. The capacitance type input device according to claim 21, wherein:
each of the first detection electrodes comprises a plurality of first wedge-shaped electrodes;
each of the second detection electrodes comprises a plurality of second wedge-shaped electrodes; and
each of the first wedge-shaped electrodes is flanked by two of the plurality of second wedge-shaped electrodes, and each of the second wedge-shaped electrodes is flanked by two of the plurality of first wedge-shaped electrodes.

31. The capacitance type input device according to claim 30, wherein one of the plurality of strip-like electrodes further comprises:
a first connection electrode disposed on a side opposite to the second direction with respect to the first wedge-shaped electrodes and connected to each of the first wedge-shaped electrodes; and
a second connection electrode disposed on a side of the second direction with respect to the second wedge-shaped electrodes and connected to each of the second wedge-shaped electrodes.

32. The capacitance type input device according to claim 21, further comprising:
a substrate on which the plurality of strip-like electrodes are formed;
a first lead-around wiring formed on the substrate and electrically connected to one of the plurality of first detection electrodes; and
a second lead-around wiring formed on the substrate and electrically connected to one of the plurality of second detection electrodes;
wherein the first and second lead-around wirings are formed on a same side in the second direction with respect to the plurality of strip-like electrodes.

33. The capacitance type input device according to claim 32, wherein the plurality of strip-like electrodes, the first lead-around wiring and the second lead-around wiring are made of a same material.
